(19) United States
(12) Patent Application Publication
(10) Pub. No.: US 2023/0327714 A1
(43) Pub. Date: Oct. 12, 2023

(54) SYSTEMS AND METHODS FOR REFLECTIVE INTELLIGENT SURFACES IN MIMO SYSTEMS

(71) Applicant: HUAWEI TECHNOLOGIES CO., LTD., Shenzhen (CN)

(72) Inventors: MOHAMMADHADI BALIGH, Kanata (CA); JIANGLEI MA, Kanata (CA)

(21) Appl. No.: 18/326,576

(22) Filed: May 31, 2023

Related U.S. Application Data
(63) Continuation of application No. PCT/CN2020/139168, filed on Dec. 24, 2020.

(51) Int. Cl. H04B 7/04; H04W 28/02; H04B 7/0413

(52) U.S. Cl. CPC H04B 7/04013; H04B 7/0413; H04W 28/0215

(57) ABSTRACT

According to the present disclosure, there are provided methods and devices for utilizing controllable metasurface devices capable of redirecting a wavefront transmitted by a transmitter to a receiver in the wireless network to take advantage of the controllable metasurface device capabilities, intelligence, coordination and speed, and thereby enable solutions having different signaling details and capability requirements. Embodiments for the methods and devices described herein provide mechanisms for identification, setup, signaling, control mechanism and communication of a communication network that includes one or more controllable metasurface device, one or more base station and one or more UE.

### CROSS REFERENCE

This application is a continuation of International Application No. PCT/CN2020/139168, filed on Dec. 24, 2020, the disclosure of which is hereby incorporated by reference in its entirety.

### TECHNICAL FIELD

The present disclosure relates generally to wireless communications, and in particular embodiments, use of reflective intelligent surfaces (RIS) in multiple input multiple output (MIMO) communication systems.

### BACKGROUND

In some wireless communication systems, user equipments (UEs) wirelessly communicate with a base station (for example, NodeB, evolved NodeB or gNB) to send data to the base station and/or receive data from the base station. A wireless communication from a UE to a base station is referred to as an uplink (UL) communication. A wireless communication from a base station to a UE is referred to as a downlink (DL) communication. A wireless communication from a first UE to a second UE is referred to as a sidelink (SL) communication or device-to-device (D2D) communication.

Resources are required to perform uplink, downlink and sidelink communications. For example, a base station may wirelessly transmit data, such as a transport block (TB), to a UE in a downlink transmission at a particular frequency and over a particular duration of time. The frequency and time duration used are examples of resources.

Metasurfaces have been investigated in optical systems for some time and recently have attracted interest in wireless communication systems. These metasurfaces are capable of affecting a wavefront that impinges upon them. Some types of these metasurfaces are controllable, meaning through changing the electromagnetic properties of the surface, the properties of the surface can be changed. For example, manipulation of the amplitude and/or phase can be achieved by changing an impedance or relative permittivity (and/or permeability) of the metamaterial.

As a result, a controllable metasurface can affect the environment and effective channel coefficients of a channel of which the metasurface is a part thereof. This results in the channel being represented as the combination of an incoming wireless channel and an outgoing wireless channel and the phase/amplitude response of the configurable metasurface.

Using these metasurfaces in wireless communication systems will necessitate methods for using them in the wireless network from deploying the metasurfaces to enabling them to work with other devices in the network.

### SUMMARY

According to an aspect of the present disclosure, there are provided methods and devices for utilizing controllable metasurface devices capable of redirecting a wavefront transmitted by a transmitter to a receiver in the wireless network to take advantage of the controllable metasurface device capabilities, intelligence, coordination and speed, and thereby enable solutions having different signaling details and capability requirements. Embodiments for the methods and devices described herein provide mechanisms for identification, setup, signaling, control mechanism and communication of a communication network that includes one or more controllable metasurface device, one or more base station and one or more UE.

In some embodiments there is provided a method involving: a user equipment (UE) receiving first configuration information, the first configuration information involving identification of a plurality of beams for transmitting or receiving signals, each beam having an associated direction; and the UE receiving second configuration information, the second configuration information including a message to enable a selected subset of beams of the plurality of beams from the plurality of beams for transmitting or receiving signals.

In some embodiments, a signal transmitted or received on at least one beam of the selected subset of beams is transmitted or received via at least one reflective intelligent surface (RIS).

In some embodiments, each one of a plurality of signals are transmitted or received on a corresponding beam of the selected subset of beams via a respective RIS.

In some embodiments, a signal transmitted or received on at least one beam of the selected subset of beams is transmitted to, or received from, a base station (BS) over a direct link with the BS.

In some embodiments, the second configuration information includes identification of beam direction and at least one of time or frequency resources of a signal on at least one beam of the selected subset of beams.

In some embodiments, the method further involving the UE receiving data and control information within the at least one of time or frequency resources of the at least one beam of the selected subset of beams.

In some embodiments, size of the selected subset of beams is at least one beam.

In some embodiments there is provided a method involving: a base station (BS) transmitting first configuration information to a user equipment (UE), the first configuration information including identification of a plurality of beams for transmitting or receiving signals at the UE, each beam having an associated direction; the BS transmitting second configuration information, the second configuration information including a message to enable a selected subset of beams of the plurality of beams for transmitting or receiving signals at the UE.

In some embodiments, the method further involving : the BS transmitting a signal to be received at the UE on at least one beam of the selected subset of beams at the UE; or the BS receiving a signal transmitted by the UE on at least one beam of the selected subset of beams at the UE.

In some embodiments, the BS transmitting a signal to be received at the UE on at least one beam of the selected subset of beams at the UE involves the BS transmitting at least two signals to be received at the UE on respective beams of the selected subset of beams at the UE, each signal reflected by reflective intelligent surface (RIS); or the BS receiving a signal transmitted by the UE on at least one beam of the selected subset of beams at the UE involves the BS receiving at least two signals from the UE on respective beams of the selected subset of beams, each signal reflected by reflective intelligent surface (RIS).

In some embodiments, the method further involving: the BS transmitting a signal to be received at the UE on at least one beam of the selected subset of beams at the UE over a direct link with the UE; or the BS receiving a signal transmitted by the UE on at least one beam of the selected subset of beams at the UE over a direct link with the UE.

In some embodiments, the second configuration information includes identification of a beam direction and time/frequency resources of a signal on at least one beam of the selected subset of beams.

In some embodiments, the method further involving the BS transmitting within the time/frequency resources so the data and control information is received at the UE on the at least one beam of the selected subset of beams.

In some embodiments, size of the selected subset of beams is at least one beam.

In some embodiments there is provided a method involving: a reflective intelligent surface (RIS) reflecting a signal in the direction of a user equipment (UE) on at least one of a selected subset of beams of a plurality of beams known to the UE; or a RIS reflecting a signal in the direction of a base station (BS) that is received from a UE that transmitted the signal on at least one of a selected subset of beams of a plurality of beams known to the UE.

In some embodiments there is provided a method involving: a base station (BS) identifying a reflective intelligent surface (RIS); the BS setting up a link with a user equipment (UE) via the RIS; and the BS activating the link with the UE.

In some embodiments, the BS setting up the link with the UE via the RIS involves: the BS transmitting first configuration information to the UE to enable the UE to set up channel measurement; the BS transmitting second configuration information to the RIS that is used for configuring a first RIS pattern for channel measurement to redirect a signal from the BS to the UE; the BS transmitting a reference signal to allow channel measurement by the UE for the link that is used between the BS and the UE via the RIS that is redirecting the reference signal; and the BS receiving a channel measurement report from the UE based on the reference signal transmitted by the BS and redirected by the RIS based on the first RIS pattern.

In some embodiments, the BS transmitting the first configuration information to the UE to enable the UE to set up channel measurement involves: the BS transmitting the first configuration information on a direct link to the UE; or the BS transmitting the first configuration information to the UE via the RIS that has been configured to redirect the configuration information to the UE.

In some embodiments, the BS setting up the link with the UE via the RIS involves the BS setting up the link for multiple RIS, including: the BS transmitting first configuration information to the multiple RIS; the BS transmitting a reference signal unique to each RIS via each of the multiple RIS; and the BS receiving the channel measurement report from the UE based on each of the reference signals transmitted by the BS and redirected by each of the multiple RIS.

In some embodiments, the BS receiving the channel measurement report from the UE involves: the BS receiving the channel measurement report on a direct link from the UE; or the BS receiving the channel measurement report via an RIS that has been configured to redirect the channel measurement report to the UE.

In some embodiments, the method further involving the BS selecting one or more of the multiple RIS to form a link to the UE.

In some embodiments, the BS activating the link with the UE involves: the BS transmitting third configuration information to the RIS including: information for configuring a second RIS pattern to redirect a signal from the BS to the UE; and a scheduling notification for the RIS to redirect the signal to the UE; the BS transmitting physical layer control configuration information to the UE to enable the UE to receive data from the BS via the RIS; and the BS transmitting data to the UE that is redirected by the RIS based on the second RIS pattern.

In some embodiments, the scheduling notification for the RIS to redirect a communication to the UE includes one of: an activation notification to activate the RIS on a semi-static basis; an activation notification to activate the RIS on a dynamic basis; a deactivation notification to deactivate the RIS on a semi-static basis; or a deactivation notification to deactivate the RIS on a dynamic basis.

In some embodiments, the BS transmitting the configuration information to the RIS that is used for configuring a first RIS pattern for channel measurement to redirect a waveform from the BS to the UE includes at least one of: information defining the first RIS pattern that the RIS can use to redirect the signal; or channel state information (CSI) that enables the RIS to generate the first RIS pattern to redirect the waveform.

In some embodiments, the physical layer control configuration information includes: information for configuring the UE to receive a waveform from the BS in a direction of the RIS; and scheduling information for the UE to receive a communication from the BS.

In some embodiments, the BS transmitting the physical layer control configuration information to the UE to enable the UE to receive data from the BS via the RIS involves: the BS transmitting the configuration information on a direct link to the UE; or the BS transmitting the configuration information to the UE via an RIS that has been configured to redirect the configuration information to the UE.

In some embodiments, the scheduling information for the UE to receive a communication from the BS includes one of: scheduling information that the UE will be receiving information on a semi-static basis; or scheduling information that the UE will be receiving information on a dynamic basis.

In some embodiments, the method further involving the BS transmitting data that is reflected by one or more RIS towards the UE.

In some embodiments, the method further involving the BS receiving data that is reflected by one or more RIS from the UE.

In some embodiments, the BS transmitting data that is reflected by one or more RIS towards the UE involves the BS transmitting the same data to two different RIS.

In some embodiments, the BS transmitting the same data to at least two different RIS is coordinated to allow the data to arrive at the UE coherently when redirected by the at least two different RIS.

In some embodiments, the BS transmitting data that is reflected by one or more RIS towards the UE involves the BS transmitting different data to two different RIS.

In some embodiments, the BS selecting one or more of the multiple RIS to form a link to the UE involves selecting at least two RIS, wherein the at least two RIS are arranged such that a signal is transmitted by the BS at a first RIS of the at least two RIS, the first RIS redirects the signal to a second RIS of the at least two RIS, and the second RIS redirects the signal to the UE.

In some embodiments there is provided a method involving: a user equipment (UE) being notified by a base station (BS) of a reflective intelligent surfaces (RISs); the UE being configured to set up a link with the BS via the RIS; and the UE receiving physical layer control configuration information for setting up link with the BS.

In some embodiments, the method further involving: the UE receiving first configuration information from the BS to enable the UE to set up channel measurement; the UE receiving a reference signal to allow channel measurement by the UE for the link between the BS and the UE via the RIS that is redirecting the reference signal; the UE measuring the reference signal; and the UE transmitting a channel measurement report from the UE based on the reference signal transmitted by the BS and redirected by the RIS.

In some embodiments, the UE receiving first configuration information from the BS to enable the UE to set up channel measurement involves: the UE receiving the first configuration information on a direct link from the BS; or the UE receiving the first configuration information to the UE via an RIS that has been configured to redirect the configuration information from the BS.

In some embodiments, the UE receiving the reference signal to allow channel measurement by the UE for the channel between the BS and the UE via the RIS involves: the UE receiving the reference signal unique to each RIS to allow channel measurement by the UE from at least two RIS; the UE measuring the reference signal from each of the at least two RIS; and the UE transmitting a channel measurement report based on the reference signal transmitted by the BS and redirected by each of the RIS.

In some embodiments, the UE transmitting the channel measurement report based on the reference signal transmitted by the BS and redirected by each of the RIS involves: the UE transmitting the channel measurement report on a direct link to the BS; or the UE transmitting the channel measurement report via an RIS that has been configured to redirect the channel measurement report to the BS.

In some embodiments, the UE receiving physical layer control configuration information for setting up link with the BS involves: the UE receiving physical layer control configuration information from the UE to enable the UE to receive data from the BS via the RIS; and the UE receiving data to the UE that is redirected by the RIS.

In some embodiments, the physical layer control configuration information from the UE involves: information for configuring the UE to receive a signal from the BS in a direction of the RIS; and scheduling information for the UE to receive the signal from the BS.

In some embodiments, the UE receiving the physical layer control configuration information involves: the UE receiving the physical layer control configuration information on a direct link from the BS; or the UE receiving the physical layer control configuration information via an RIS that has been configured to redirect the configuration information from the BS.

In some embodiments, the scheduling information for the UE to receive a communication from the BS includes one of: scheduling information for the UE to receive information on a semi-static basis; or scheduling information for the UE to receive information on a dynamic basis.

In some embodiments, the method further involving the UE receiving data that is reflected by one or more RIS from a BS.

In some embodiments, the method further involving the UE transmitting data that is reflected by one or more RIS to a BS.

In some embodiments, the UE receiving the data that is reflected by one or more RIS towards the UE involves the UE receiving the same data from two different RIS.

In some embodiments, the UE receiving the same data from at least two different RIS is coordinated to allow the data to arrive at the UE coherently when redirected by the at least two different RIS.

In some embodiments, the UE receiving the data that is reflected by one or more RIS towards the UE involves the UE receiving different data from two different RIS.

In some embodiments, the BS selecting one or more of the multiple RIS to form a link to the UE involves selecting at least two RIS, wherein the at least two RIS are arranged such that a signal is transmitted by the BS at a first RIS of the at least two RIS, the first RIS redirects the signal to a second RIS of the at least two RIS, and the second RIS redirects the signal to the UE.

In some embodiments there is provided a method involving: a reflective intelligent surface (RIS) redirecting an identification of one or more RISs to a user equipment (UE), the identification sent by a base station (BS); the RIS receiving first configuration information to facilitate setting up a link with the UE; and the RIS receiving second configuration information to activate the link with the UE.

In some embodiments, the RIS receiving first configuration information to facilitate setting up a link with the UE involves: the RIS receiving configuration information that is used for configuring a first RIS pattern to be displayed on the RIS for channel measurement to redirect a signal from the BS to the UE; and the RIS redirecting a reference signal to allow channel measurement by the UE for the link that is used between the BS and the UE via the RIS.

In some embodiments, the method further involving the RIS redirecting a channel measurement report from the UE based on the reference signal transmitted by the BS and redirected by the RIS based on the first RIS pattern.

In some embodiments, the method further involving the RIS redirecting physical layer control configuration information to the UE.

In some embodiments, the method further involving: the RIS receiving: information for configuring a second RIS pattern to redirect a signal from the BS to the UE; and a scheduling notification for the RIS to redirect the signal to the UE.

In some embodiments, the scheduling notification for the RIS to redirect a communication to the UE includes one of: an activation notification to activate the RIS on a semi-static basis; an activation notification to activate the RIS on a dynamic basis; a deactivation notification to deactivate the RIS on a semi-static basis; or a deactivation notification to deactivate the RIS on a dynamic basis.

In some embodiments, the information for configuring the second RIS pattern includes at least one of: information defining the second RIS pattern that the RIS can use to redirect the signal; or channel state information (CSI) that enables the RIS to generate the second RIS pattern to redirect the signal.

In some embodiments, the method further involving the RIS redirecting data from the BS towards the UE or from the UE to the BS.

In some embodiments, the RIS redirecting the data from the BS towards the UE or from the UE to the BS is scheduled to allow the data to arrive at the UE coherently with data that has been redirect by another RIS.

In some embodiments, the RIS is one of multiple RIS in a link between the BS and the UE, the RIS redirecting a signal impinging on the RIS to another RIS, the UE or the BS.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a transmission channel between a source and destination in which a planar array of configurable elements is used to redirect signals according to an aspect of the disclosure.

FIG. 2A is a schematic diagram of a communication system in which embodiments of the disclosure may occur.

FIG. 2B is another schematic diagram of a communication system in which embodiments of the disclosure may occur.

FIGS. 3A, 3B and 3C are block diagrams of an example user equipment, base station and RIS, respectively.

FIG. 4A is a schematic diagram of a portion of a network including a base station (BS), two reflecting intelligent surfaces (RIS) and two user equipment (UEs) according to an aspect of the application.

FIG. 4B is a schematic diagram of a portion of a network including a BS, two RIS and one UE according to an aspect of the application.

FIG. 4C is a schematic diagram of a portion of a network including a BS, two reflecting intelligent service (RIS) and one user equipment (UEs) according to an aspect of the application.

FIGS. 5A to 5G are flow diagrams illustrating different example methods for implementing identification of RIS-UE links according to aspects of the application.

FIGS. 6A to 6C are flow diagrams illustrating different example methods for implementing set up of RIS-UE links according to aspects of the application.

FIGS. 7A to 7C are flow diagrams illustrating different example methods for activating RIS-UE links according to aspects of the application.

FIG. 8A is a flow diagram illustrating signaling between a BS, two RIS and a UE for RIS and UE configuration and data transmission between the BS and UE for semi-static scheduling according to an aspect of the application.

FIG. 8B is a flow diagram illustrating signaling between a BS, two RIS and a UE for RIS and UE configuration and data transmission between the BS and UE for dynamic scheduling according to an aspect of the application.

FIG. 9A is a schematic diagram of a portion of a network including a BS, two RIS and one UE that allow time/frequency diversity according to an aspect of the application.

FIG. 9B is a flow diagram illustrating signaling between a BS, two RIS and a UE for RIS and UE configuration and data transmission between the BS and UE for time/frequency diversity according to an aspect of the application.

FIG. 10A is a schematic diagram of a portion of a network including a BS, two RIS and two UE that allow multi-RIS multi-UE MIMO with a single BS according to an aspect of the application.

FIG. 10B is a schematic diagram of a portion of a network including two BS, two RIS and two UE that allow multi-RIS multi-UE MIMO with two BS according to an aspect of the application.

FIG. 11 is a flow diagram illustrating signaling between a BS, two RIS and two UE for RIS and UE configuration and data transmission between the BS and the two UE for multi-RIS multi-UE MIMO with a single BS according to an aspect of the application.

FIG. 12 is a flow diagram illustrating signaling between a BS, two RIS and one UE for RIS and UE configuration and data transmission between the BS and the one UE for a multilayer implementation according to an aspect of the application.

FIG. 13 is a flow diagram illustrating signaling between a BS, two RIS and one UE for RIS and UE configuration and data transmission between the BS and the one UE for a multi-RIS coherent implementation according to an aspect of the application.

FIG. 14 is a schematic diagram of a portion of a network including two BS, two RIS and one UE that allow a user centric and no cell (UCNC) handover according to an aspect of the application.

FIG. 15 is a flow diagram illustrating signaling between two BS, two RIS and one UE for RIS and UE configuration and data transmission between the BS and the UE for a UCNC implementation according to an aspect of the application.

FIG. 16 is a schematic diagram of operations of a framework according to an aspect of the application.

FIG. 17A is a flow diagram for RIS discovery by the network according to an aspect of the application.

FIG. 17B is a flow diagram for RIS discovery by the UE according to an aspect of the application.

FIG. 17C is a flow diagram for UE discovery by the RIS according to an aspect of the application.

FIGS. 18A and 18B are schematic diagrams illustrating how absolute beam direction may be represented for providing beam direction information to a UE.

FIG. 18C is a schematic diagram illustrating how relative beam direction may be represented for providing beam direction information to a UE.

### DETAILED DESCRIPTION OF ILLUSTRATIVE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Controllable metasurfaces are referred to by different names such as reconfigurable intelligent surface (RIS), large intelligent surface (LIS), intelligent reflecting surface (IRS), digital controlled surface (DCS), intelligent passive mirrors, and artificial radio space. While in subsequent portions of this document RIS is used most frequently when referring to these metasurfaces, it is to be understood then this is for simplicity and is not indented to limit the disclosure.

A RIS can realize smart radio environment or “smart radio channel” i.e. the environment radio propagation properties can be controlled to realize personalized channel for desired communication. The RIS may be established among multiple base stations to produce large scale smart radio channels that serve multiple users. With a controllable environment, RISs may first sense environment information and then feeds it back to the system. According to his date, the system may optimize transmission mode and RIS parameters through smart radio channels, at the transmitter, channel and receiver.

Because of the beamforming gains associated with RISs, exploiting smart radio channels can significantly improve link quality, system performance, cell coverage, and cell edge performance in wireless networks. Not all RIS panels use the same structure. Different RIS panels may be designed with various phase adjusting capabilities that range from continuous phase control, to discrete control with a handful of levels.

Another application of RISs is in transmitters that directly modulate incident radio wave properties, such as phase, amplitude polarization and/or frequency without the need for active components as in RF chains in traditional MIMO transmitters. RIS based transmitters have many merits, such as simple hardware architecture, low hardware complexity, low energy consumption and high spectral efficiency. Therefore, RIS provides a new direction for extremely simple transmitter design in future radio systems.

RIS assisted MIMO also may be used to assist fast beamforming with the use of accurate positioning, or to conquer blockage effects through CSI acquisition in mmWave systems. Alternatively, RIS assisted MIMO may be used in non-orthogonal multiple access (NOMA) in order to improve reliability at very low SNR, accommodate more users and enable higher modulation schemes. RIS is also applicable to native physical security transmission, wireless power transfer or simultaneous data and wireless power transfer, and flexible holographic radios.

The ability to control the environment and network topology through strategic deployment of RISs, and other non-terrestrial and controllable nodes is an important paradigm shift in MIMO system, such as 6G MIMO. Such controllability is in contrast to the traditional communication paradigm, where transmitters and receivers adapt their communication methods to achieve the capacity predicted by information theory for the given wireless channel. Instead, by controlling the environment and network topology, MIMO aims to be able to change the wireless channel and adapt the network condition to increase the network capacity.

One way to control the environment is to adapt the topology of the network as the user distribution and traffic pattern changes over time. This involves utilizing HAPs, UAVs and drones when and where it is necessary.

RIS-assisted MIMO utilizes RISs to enhance the MIMO performance by creating a smart radio channels. To extract full potential of RIS-assisted MIMO, a system architecture and more efficient scheme are provided in the present disclosure.

Comparing with beamforming at transmit or receiver sides, spatial beamforming at RIS has more flexibility to realize the beamforming gain as well as to avoid the blockage fading between the transmitter and receiver, which is more favorable for high frequency MIMO communication.

An RIS may include many small reflection elements, often comparable in size with the wavelength (for example, from ⅒ to a couple of wavelengths). Each element may be controlled independently. The control mechanism may be, for example, a bias voltage or a driving current to change the characteristics of the element. The combination of the control voltages for all elements (and hence the effective response) may be referred to as the RIS pattern. This RIS pattern may control the behavior of the RIS including at least one of the width, shape and direction of the beam, which is referred to as the beam pattern.

The controlling mechanism of the RIS often is through controlling the phase of a wavefront incident on the surface and reflected by the surface. Other techniques of controlling the RIS include attenuating reflection of the amplitude to reduce the reflected power and “switching off” the surface. Attenuating the power and switching off the surface can be realized by using only a portion of the RIS, or none of the RIS, for reflection while applying a random pattern to the rest of the panel, or a pattern that reflects the incident wavefront in a direction that is not in a desired direction.

In some portions of this disclosure, RIS may be referred to as a set of configurable elements arranged in a linear array or a planar array. Nevertheless, the analysis and discussions are extendable to other two or three dimensional arrangements (e.g., circular array). A linear array is a vector of N configurable elements and a planar array is a matrix of NxM configurable elements, where M and N are non-zero integers. These configurable elements have the ability to redirect a wave/signal that is incident on the linear or planar array by changing the phase of the wave/signal. The configurable elements are also capable of changing the amplitude, polarization, or even the frequency of the wave/signal. In some planar arrays these changes occur as a result of changing bias voltages that control the individual configurable elements of the array via a control circuit connected to the linear or planar array. The control circuit that enables control of the linear or planar array may be connected to a communications network that base stations and UEs communicating with each other are part of. For example, the network that controls the base station may also provide configuration information to the linear or planar array. Control methods other than bias voltage control include, but are not limited to, mechanical deformation and phase change materials.

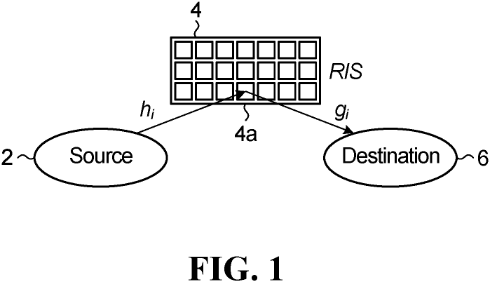

Because of their ability to manipulate the incident wave/signal, the low cost of these types of RIS, and because these types of RIS require small bias voltages, RIS have recently received heightened research interest in the area of wireless communication as a valuable tool for beamforming and/or modulating communication signals. A basic example for RIS utilization in beamforming is shown in FIG. 1 where each RIS configurable element 4a (unit cell) can change the phase of the incident wave from source such that the reflected waves from all of the RIS elements are aligned to the direction of the destination to increase or maximize its received signal strength (e.g. maximize the signal to noise ratio (SNR)). Such a reflection via the RIS may be referred to as reflect-array beamforming. In some embodiments, the planar array of configurable elements, which may be referred to as an RIS panel, can be formed of multiple co-planar RIS sub-panels. In some embodiments, the RIS can be considered as an extension of the BS antennas or a type of distributed antenna. In some embodiments, the RIS can also be considered as a type of passive relay.

Introduction of controllable metasurfaces in a wireless network can increase the flexibility and reliability of the networks. Recently there has been a surge in interest in RIS utilization in wireless networks. However, much of this interest has been focused on measurement and channel state information (CSI) acquisition related to the RIS and how to optimize the RIS pattern for particular circumstances, capabilities and measurement accuracies.

Aspects of the present disclosure provide methods and device for utilizing RIS panels in the wireless network to take advantage of the RIS capabilities, intelligence, coordination and speed, and thereby propose solutions having different signaling details and capability requirements. Embodiments for the methods described herein provide mechanisms for identification, setup, signaling, control mechanism and communication of a communication network that includes one or more BS, one or RIS and one or more UE.

FIG. 1 illustrates an example of a planar array of configurable elements, labelled in the figure as RIS 4, in a channel between a source 2, or transmitter, and a destination 6, or receiver. The channel between the source 2 and destination 6 include a channel between the source 2 and RIS 4 identified as hᵢ and a channel between the RIS 4 and destination 6 identified as gᵢ for the i^{th} RIS configurable element (configurable element 4a) where i ∈ {1,2,3, ..., N ∗ M} assuming the RIS consists of N ∗ M elements or unit cells. A wave that leaves the source 2 and arrives at the RIS 4 can be said to be arriving with a particular angle of arrival (AoA). When the wave is reflected or redirected by the RIS 4, the wave can be considered to be leaving the RIS 4 with a particular angle of departure (AoD).

While FIG. 1 has two dimensional planar array RIS 4 and shows a channel hᵢ and a channel gᵢ, the figure does not explicitly show an elevation angle and azimuth angle of the transmission from the source 2 to RIS 4 and the elevation angle and azimuth angle of the redirected transmission from the RIS 4 to the destination 6. In the case of a linear array, there may be only one angle to be concerned about, i.e. the azimuth angle.

In wireless communications, the RIS 4 can be deployed as 1) a reflector between a transmitter and a receiver, as shown in FIG. 1, or as 2) a transmitter (integrated at the transmitter) to help implement a virtual MIMO system as the RIS helps to direct the signal from a feeding antenna.

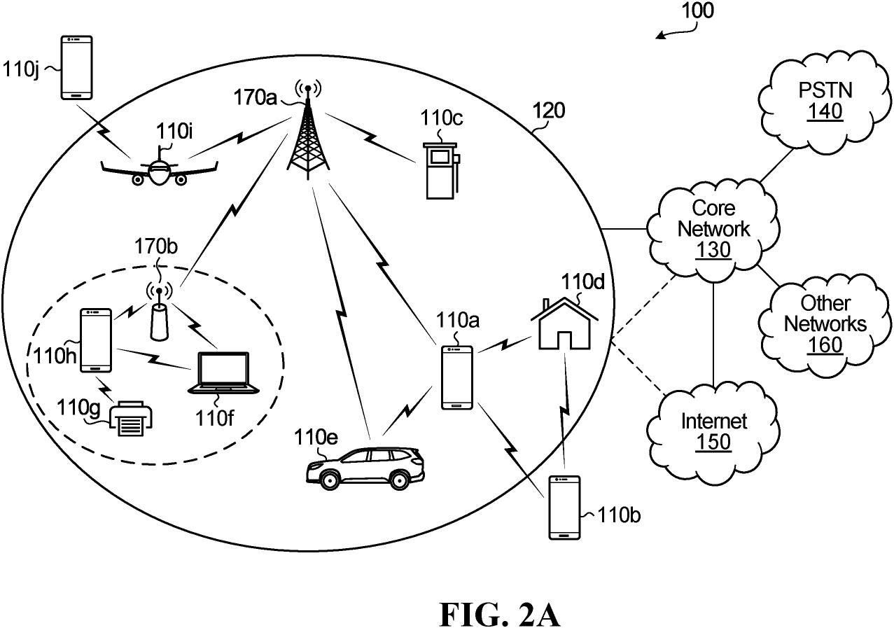

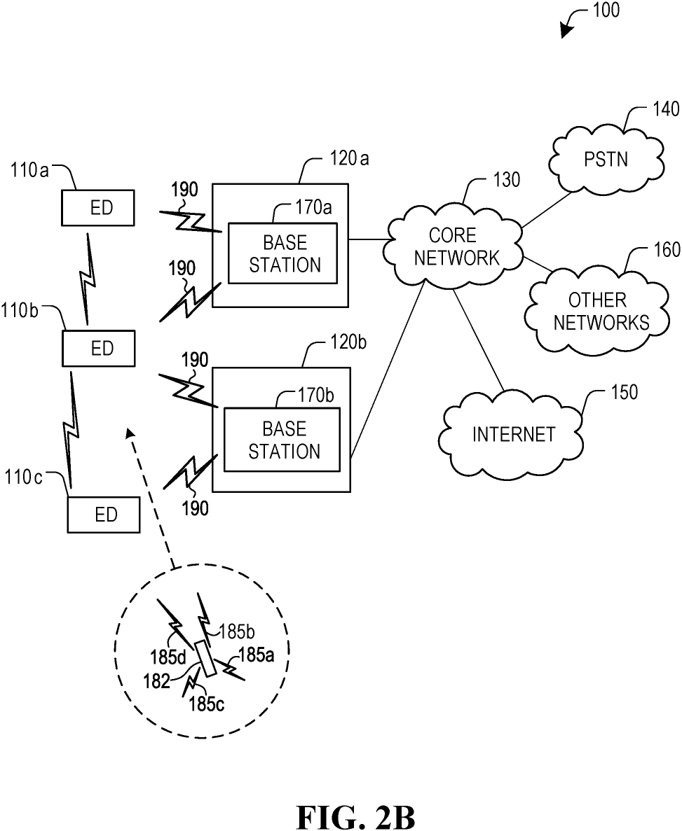

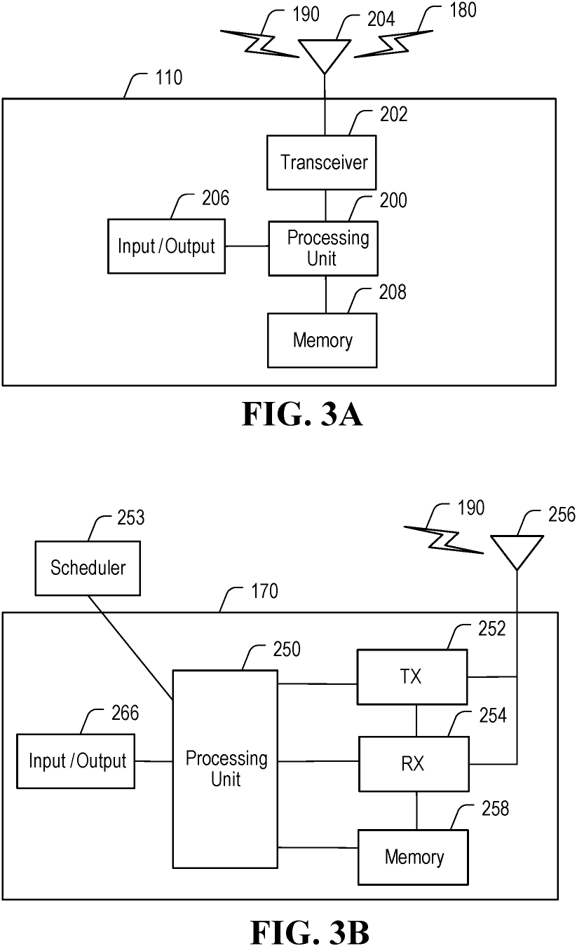

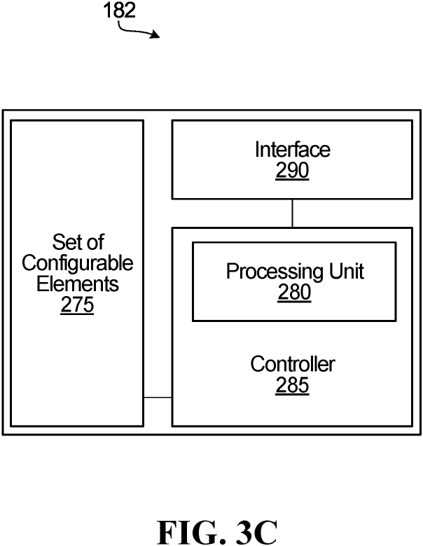

FIGS. 2A, 2B, 3A, 3B and 3C following below provide context for the network and device that may be in the network and that may implement aspects of the present disclosure.

Referring to FIG. 2A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 2B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 2B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 2B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110c, radio access networks (RANs) 120a-120b, a core network 130, a public switched telephone network (PSTN) 140, the internet 150, and other networks 160. Although certain numbers of these components or elements are shown in FIG. 2B, any reasonable number of these components or elements may be included in the communication system 100.

The EDs 110a-110c are configured to operate, communicate, or both, in the communication system 100. For example, the EDs 110a-110c are configured to transmit, receive, or both, via wireless or wired communication channels. Each ED 110a-110c represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 2B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 170a-170b may be a non-terrestrial base station that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110c may be alternatively or additionally configured to interface, access, or communicate with any other base station 170a-170b, the internet 150, the core network 130, the PSTN 140, the other networks 160, or any combination of the preceding.

The EDs 110a-110c and base stations 170a-170b are examples of communication equipment that can be configured to implement some or all of the operation and/or embodiments described herein. In the embodiment shown in FIG. 2B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b communicate with one or more of the EDs 110a-110c over one or more air interfaces 190 using wireless communication links e.g. radio frequency (RF), microwave, infrared (IR), etc. The air interfaces 190 may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190.

A base station 170a-170b may implement Universal Mobile Telecommunication System (UMTS) Terrestrial Radio Access (UTRA) to establish an air interface 190 using wideband CDMA (WCDMA). In doing so, the base station 170a-170b may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b may establish an air interface 190 with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1X, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110c communicate with one another over one or more sidelink (SL) air interfaces 180 using wireless communication links e.g. radio frequency (RF), microwave, infrared (IR), etc. The SL air interfaces 180 may utilize any suitable radio access technology, and may be substantially similar to the air interfaces 190 over which the EDs 110a-110c communication with one or more of the base stations 170a-170c, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 180. In some embodiments, the SL air interfaces 180 may be, at least in part, implemented over unlicensed spectrum.

In addition, some or all of the EDs 110a-110c may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110c may be multimode devices capable of operation according to multiple radio access technologies, and incorporate multiple transceivers necessary to support multiple radio access technologies.

Also shown in FIG. 2B is a RIS 182 located within the serving area of base station 170b. A first signal 185a is shown between the base station 170b and the RIS 182 and a second signal 185b is shown between the RIS 182 and the ED 110b, illustrating how the RIS 182 might be located within the uplink or downlink channel between the base station 170b and the ED 110b. Also shown is a third signal 185c between the ED 110c and the RIS 182 and a fourth signal 185d is shown between the RIS 182 and the ED 110b, illustrating how the RIS 182 might be located within the SL channel between the ED 110c and the ED 110b.

While only one RIS 182 is shown in FIG. 2B, it is to be understood that any number of RIS could be included in a network.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIGS. 3A and 3B illustrate example devices that may implement the methods and teachings according to this disclosure. In particular, FIG. 3A illustrates an example ED 110, and FIG. 3B illustrates an example base station 170. These components could be used in the system 100 or in any other suitable system.

As shown in FIG. 3A, the ED 110 includes at least one processing unit 200. The processing unit 200 implements various processing operations of the ED 110. For example, the processing unit 200 could perform signal coding, data processing, power control, input/output processing, or any other functionality enabling the ED 110 to operate in the communication system 100. The processing unit 200 may also be configured to implement some or all of the functionality and/or embodiments described in more detail herein. Each processing unit 200 includes any suitable processing or computing device configured to perform one or more operations. Each processing unit 200 could, for example, include a microprocessor, microcontroller, digital signal processor, field programmable gate array, or application specific integrated circuit.

The ED 110 also includes at least one transceiver 202. The transceiver 202 is configured to modulate data or other content for transmission by at least one antenna or Network Interface Controller (NIC) 204. The transceiver 202 is also configured to demodulate data or other content received by the at least one antenna 204. Each transceiver 202 includes any suitable structure for generating signals for wireless or wired transmission and/or processing signals received wirelessly or by wire. Each antenna 204 includes any suitable structure for transmitting and/or receiving wireless or wired signals. One or multiple transceivers 202 could be used in the ED 110. One or multiple antennas 204 could be used in the ED 110. Although shown as a single functional unit, a transceiver 202 could also be implemented using at least one transmitter and at least one separate receiver.

The ED 110 further includes one or more input/output devices 206 or interfaces (such as a wired interface to the internet 150). The input/output devices 206 permit interaction with a user or other devices in the network. Each input/output device 206 includes any suitable structure for providing information to or receiving information from a user, such as a speaker, microphone, keypad, keyboard, display, or touch screen, including network interface communications.

In addition, the ED 110 includes at least one memory 208. The memory 208 stores instructions and data used, generated, or collected by the ED 110. For example, the memory 208 could store software instructions or modules configured to implement some or all of the operations and/or embodiments described above and that are executed by the processing unit(s) 200. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 3B, the base station 170 includes at least one processing unit 250, at least one transmitter 252, at least one receiver 254, one or more antennas 256, at least one memory 258, and one or more input/output devices or interfaces 266. A transceiver, not shown, may be used instead of the transmitter 252 and receiver 254. A scheduler 253 may be coupled to the processing unit 250. The scheduler 253 may be included within or operated separately from the base station 170. The processing unit 250 implements various processing operations of the base station 170, such as signal coding, data processing, power control, input/output processing, or any other functionality. The processing unit 250 can also be configured to implement some or all of the operations and/or embodiments described in more detail above. Each processing unit 250 includes any suitable processing or computing device configured to perform one or more operations. Each processing unit 250 could, for example, include a microprocessor, microcontroller, digital signal processor, field programmable gate array, or application specific integrated circuit.

Each transmitter 252 includes any suitable structure for generating signals for wireless or wired transmission to one or more EDs or other devices. Each receiver 254 includes any suitable structure for processing signals received wirelessly or by wire from one or more EDs or other devices. Although shown as separate components, at least one transmitter 252 and at least one receiver 254 could be combined into a transceiver. Each antenna 256 includes any suitable structure for transmitting and/or receiving wireless or wired signals. Although a common antenna 256 is shown here as being coupled to both the transmitter 252 and the receiver 254, one or more antennas 256 could be coupled to the transmitter(s) 252, and one or more separate antennas 256 could be coupled to the receiver(s) 254. Each memory 258 includes any suitable volatile and/or non-volatile storage and retrieval device(s) such as those described above in connection to the ED 110. The memory 258 stores instructions and data used, generated, or collected by the base station 170. For example, the memory 258 could store software instructions or modules configured to implement some or all of the operations and/or embodiments described above and that are executed by the processing unit(s) 250.

Each input/output device 266 permits interaction with a user or other devices in the network. Each input/output device 266 includes any suitable structure for providing information to or receiving/providing information from a user, including network interface communications.

FIG. 3C illustrates an example RIS device that may implement the methods and teachings according to this disclosure. In particular, FIG. 3C illustrates an example RIS device 182. These components could be used in the system 100 or in any other suitable system.

As shown in FIG. 3C, the RIS device 182, which may also be referred to as a RIS panel, includes a controller 285 that includes at least one processing unit 280, an interface 290, and a set of configurable elements 275. The set of configurable elements are arranged in a single row or a grid or more than one row, which collectively form the reflective surface of the RIS panel. The configurable elements can be individually addressed to alter the direction of a wavefront that impinges on each element. RIS reflection properties (such as beam direction, beam width, frequency shift, amplitude, and polarization) are controlled by RF wavefront manipulation that is controllable at the element level, for example via the bias voltage at each element to change the phase of the reflected wave. This control signal forms a pattern at the RIS. To change the RIS reflective behavior, the RIS pattern needs to be changed.

Connections between the RIS and a UE can take several different forms. In some embodiments, the connection between the RIS and the UE is a reflective channel where a signal from the BS is reflected, or redirected, to the UE or a signal from the UE is reflected to the BS. In some embodiments, the connection between the RIS and the UE is a reflective connection with passive backscattering or modulation. In such embodiments a signal from the UE is reflected by the RIS, but the RIS modulates the signal by the use of a particular RIS patter. Likewise, a signal transmitted from the BS may be modulated by the RIS before it reaches the UE. In some embodiments, the connection between the RIS and the UE is a network controlled sidelink connection. This means that that the RIS may be perceived by the UE as another device like a UE, and the RIS forms a link similar to two UEs, which is scheduled by the network. When a link between the RIS and UE is based on SL, the SL and Uu link (the link between the BS and the UE or between the BS and RIS) can occupy different carriers and/or different bandwidth parts. In some embodiments, the connection between the RIS and the UE is an ad hoc in-band/out-of-band connection.

A RIS device or a RIS panel is generally considered to be the RIS and any electronics that may be used to control the configurable elements and hardware and/or software used to communication with other network nodes. However, the expressions RIS, RIS panel and RIS device may be used interchangeably in this disclosure to refer to the RIS device used in a communication system.

The processing unit 280 implements various processing operations of the RIS 182, such as receiving the configuration signal via interface 290 and providing the signal to the controller 285. The processing unit 280 could, for example, include a microprocessor, microcontroller, digital signal processor, field programmable gate array, or application specific integrated circuit.

While this is a particular example of an RIS, it should be understood that the RIS may take different forms and be implemented in different manner than shown in FIG. 3C. The RIS 182 ultimately needs a set of configurable elements that can be configured as described to operate herein.

FIG. 3C includes an interface 290 to receive configuration information from the network. In some embodiments, the interface 290 enables a wired connection to the network. The wired connection may be to a base station or some other network-side device. In some embodiments, the wired connection is a propriety link, i.e. a link that is specific to a particular vendor or supplier of the RIS equipment. In some embodiments, the wired connection is a standardized link, i.e. a link that is standardized such that anyone using the RIS uses the same signaling processes. The wired connection may be an optical fiber connection or metal cable connection.

In some embodiments, the interface 290 enables a wireless connection to the network. In some embodiments, the interface 290 may include a transceiver that enables RF communication with the BS or the UE. In some embodiments, the wireless connection is an in-band propriety link. In some embodiments, the wireless connection is an in-band standardized link. The transceiver may operate out of band or using other types of radio access technology (RAT), such as Wi-Fi or BLUETOOTH. In some embodiments, the transceiver is used for low rate communication and/or control signaling with either the UE or the base station. In some embodiments, the transceiver is an integrated transceiver such as an Long Term Evolution (LTE), 5^{th} Generation (5G), or 6^{th} Generation (6G) transceiver for low rate communication. In some embodiments, the interface could be used to connect a transceiver or sensor to the RIS.

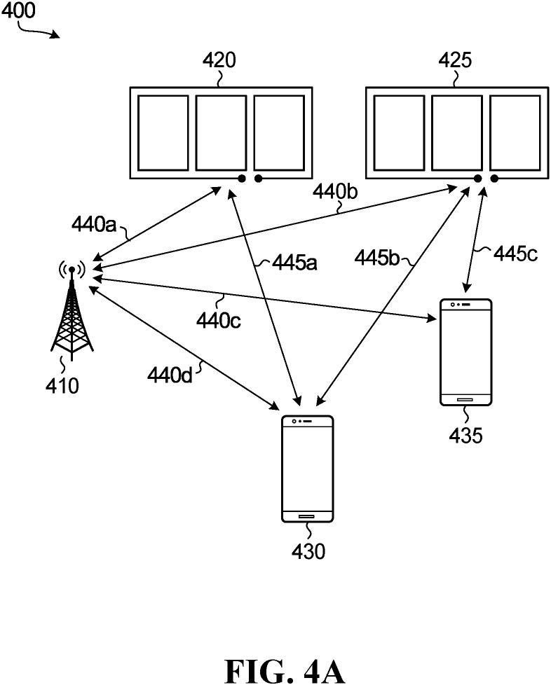

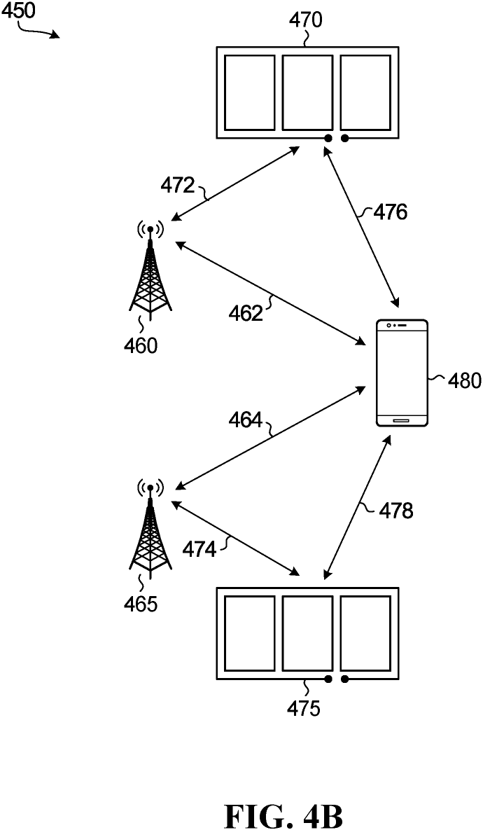

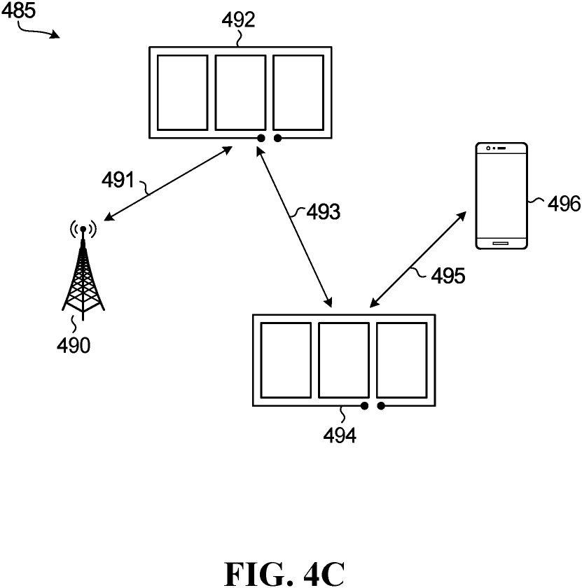

Examples of how the RIS can be discovered in a network, a BS-RIS link set up, a RIS-UE link identified, the RIS-UE link setup, the RIS and the RIS-UE link activated and deactivated will be described in further detail below. FIGS. 4A, 4B and 4C show some examples of how an RIS may be arranged in a telecommunication network to create a RIS assisted link between a BS and one or more UE.

As explained above, the phase shifts that occur due to the configurable elements of the RIS depend on the frequency of the incident wave in addition to the bias voltage used to control the RIS. The following description explains how such phenomena can impact a reflected signal from the RIS between a transmitter and a receiver.

Depending on the type of material used in the RIS, a range of phase shift can be obtained within a particular bias voltage range for a first frequency, but a similar range of phase shift for a second frequency may need a different bias voltage range having different start and end voltages. For example, in a particular type of RIS material, at a frequency of 121.5 GHz, almost the full range of the phase shift is obtained with the voltage range between 1.6 volt and 2.7 volt while other applied voltages cause almost a constant phase shift. However, at a frequency of 126 GHz, almost the full range of the phase shift is obtained with the voltage range between 1 volt and 1.6 volt. Hence, for this type of RIS, a different and separate range of bias voltages need to be applied at different frequencies in order to obtain the required phase shift. This is more evident when the difference between the frequencies is a large difference. Based on the differences between different types of RISs, it may be beneficial that the RIS is able to generate its own RS patterns that are used to redirect wavefronts from a transmitter to a receiver, with additional input of relevant information from the network, transmitter, and/or receiver.

FIG. 4A shows a first example of a portion of a communications network 400 that includes a base station (BS) 410, two RIS (RIS#1 420 and RIS#2 425) and two user equipments (UE#1 430 and UE#2 435). Each of RIS#1 420 and RIS#2 425 are capable of operating as an extension of antennas of the BS 410 for the purposes of transmission or reception, or both. The RIS are capable of reflecting and focusing a transmission wavefront propagating between the BS 410 and the UEs. The BS 410 is capable of communicating with the UEs via RIS. A first link 440a, for example, radio frequency RF link, is shown between RIS#1 420 and BS 410. A second link 440b is shown between RIS#2 425 and BS 410. The BS and the RIS can communicate in band, out of band or through a wired connection when communicating information about the RIS pattern that the RIS should use to reflect information, as well as other configuration information or control information, or both, that may need to be communicated between the RIS and BS.

A third link 445a is shown between RIS#1 420 and UE#1 430. A fourth link 445b is shown between RIS#2 425 and UE#1 430. A fifth link 445c is shown between RIS#2 425 and UE#2 435. The RIS and the UE can communicate in band, out of band, or using other radio access technology (RAT) that is available to the devices when communicating information about the RIS pattern that the RIS should use to reflect information, as well as other configuration information or control information, or both, that may need to be communicated between the RIS and UE.

The links between BS and RIS and the links between RIS and UE can share the same frequency band or occupy different frequency bands (for example different carriers or different bandwidth parts).

There is also a direct link 440d shown between the BS 410 and UE#1 430 and a direct link 435 between the BS 410 and UE#2 435. The direct link between the BS and the UEs can be in a different frequency band than the link between the BS and UEs that occurs via the RIS.

As can be seen, the RIS#1 420 has formed a physical channel between BS 410 and UE#1 430 and RIS#2 425 has formed a physical channel between BS 410 and UE#1 430 and between BS 410 and UE#2 435. It is to be understood that an RIS can have a link with multiple UEs and with multiple BSs, even though not shown in FIG. 4A. Furthermore, while only 1 BS, 2 RIS and 2 UEs are shown in FIG. 4A, it is to be understood that this is merely an illustrative example and that there can be a single BS, RIS and UE or multiple (i.e. more than just 2) of each component could be in a communications network.

FIG. 4B shows a second example of a portion of a communications network 450 that includes a first BS 460, a second BS 465, two RIS (RIS#1 470 and RIS#2 475) and a single user equipment (UE 480). RIS#1 470 is capable of operating as an extension of antennas of the BS 460 for the purposes of transmission or reception and RIS#2 475 is capable of operating as an extension of antennas of the BS 465 for the purposes of transmission or reception. RIS#1 470 is capable of reflecting and focusing a transmission wavefront propagating between the first BS 460 and the UE 480 and RIS#2 475 is capable of reflecting and focusing a transmission wavefront propagating between the second BS 465 and the UE 480. The first BS 460 is capable of communicating with the UE 480 via RIS 470 and the second BS 475 is capable of communicating with the UE 480 via RIS 475. A first F link 472 is shown between RIS#1 470 and the first BS 460. A second link 474 is shown between RIS#2 475 and the second BS 465. The BSs and the RISs can communicate in band, out of band or through a wired connection when communicating information about the RIS pattern that the RIS should use to reflect information, as well as other configuration information or control information, or both, that may need to be communicated between the RIS and BS.

A third link 476 is shown between RIS#1 470 and the UE 480. A fourth link 478 is shown between RIS#2 475 and the UE 480. The RISs and the UEs can communicate in band, out of band or using other radio access technology (RAT) that is available to the devices when communicating information about the RIS pattern that the RIS should use to reflect information, as well as other configuration information or control information, or both, that may need to be communicated between the RIS and UE.

There are also direct links 462 and 464 shown between the first BS 460 and UE 480 and between the second BS 465 and UE 480. The direct link between the BSs and the UEs can be in a different frequency band than the link between the BS and UEs that occurs via the RIS.

As can be seen, the RIS#1 470 has formed a physical channel between the first BS 460 and UE 480 and the RIS#2 475 has formed a physical channel between the second BS 465 and the UE 480. It is to be understood that an RIS can have a link with multiple UEs and with multiple BSs, even though not shown in FIG. 4B. Furthermore, while only 2 BS, 2 RIS and UE are shown in FIG. 4B, it is to be understood that this is merely an illustrative example and that multiple of each component could be in a communications network.

In some embodiments, the RIS may have a transceiver that can be used for low rate (an example of which is a microwave band below 6 GHz) communication and control signaling with either the UE or the BS.

The RIS panels may have coverage overlap with one another such that a group of users may be covered by multiple RIS. This includes coverage overlap with a coverage area of a donor BS or other BSs. A donor BS is considered a BS that transmits and receives signaling with a UE. The donor BS for the one or more RIS panels can be the same BS or multiple different BSs.

In some embodiments, a RIS panel can form of multiple co-planar RIS sub-panels.

In some embodiments, RIS panels can be positioned such that they reflect signals to each other in the case of a multi-hop reflection. For example, the BS can transmit to a first RIS, which reflects to a second BS, that reflects to a UE. FIG. 4C illustrates a portion of a network including a BS 490, two RIS 492 and 494 and a single UE. A first link 491 is shown between the BS 490 and RIS#1 492. A second link 493 is shown between RIS#1 492 and RIS#2 494. A third link 495 is shown between RIS#2 494 and UE 496. The BSs and the RISs can communicate in band, out of band or through a wired connection when communicating information about the RIS pattern that the RIS should use to reflect information, as well as other configuration information or control information, or both, that may need to be communicated between the RIS and BS.

Referring to FIG. 4C, multiple RISs can be used between a transmitter and receiver (whether that is BS to UE in DL, UE to BS in UL or UE to UE in SL) in which the signal is reflected from one RIS panel to the next until the receiver is reached. The number of the channel hops increases with the number of RIS. FIG. 4C in particular shows two RIS, RIS#1 492 and RIS#2 494. In FIG. 4C, at RIS#1 492, the beam is optimized to reflect between BS#1 490 and RIS#2 494. At RIS#2 494, the beam is optimized to reflect between RIS#2 494 and the UE 496.

In some embodiments, the fact that there could be multiple hops between the UE and the BS may not be known by the UE. For example, as long as the UE is provided information to know the direction that the signal on the last hop is coming from, the UE is capable of receiving the signaling without knowing what type of device the signal is coming from. Due to the additional signaling involved between devices, there may need to be additional control and configuration signaling and channel estimation for the RIS reflection between the RIS devices.

Using one or more RIS to reflect signaling between one or more BSs and one or more UEs can provide multiple benefits. In some embodiments, the use of an RIS can provide diversity enhancement by creating multiple independent communication paths for increased link reliability. In some embodiments, the use of an RIS can be operated on a semi-static manner allowing a longer-term association of the RIS to a UE. In some embodiments, the use of an RIS can be operated on a dynamic basis allowing dynamic RIS selection.

In some embodiments, the use of an RIS can provide joint diversity allowing simultaneous reflection for increased reliability, for example using space time codes or cyclic delay diversity.

In some embodiments, the use of the RIS can provide coverage enhancement. The use of more than one RIS panel located in different locations and with different orientations may allow improved coverage of UEs in an area with being served by the BSs, but that has various forms of blockage, diffraction and shadowing on the signal such as, but not limited to, by furniture, body, and palm blockages.

In some embodiments, the use of the RIS can provide a mechanism for link failure avoidance and fast recovery. For example, the RIS-UE could be in a standby mode, and can be resumed when the direct link or the link to other RIS panels fails.

In some embodiments, the use of the RIS can provide increased throughput and higher rank. In some embodiments, the use of multiple RIS may allow an increased signal to interference plus noise ratio (SINR). The use of multiple RIS enables an increased total number of links in the network that can also enable a greater scheduling flexibility. The use of multiple RIS may also provide multiple routes to the UEs that can be used simultaneously. Such multiple routes may allow increased rank by reducing the inter-route interference. The use of such simultaneous multiple routes may be applicable to low rank links, e.g. line-of-sight (LoS) and high frequency (HF).

In some embodiments, the use of the RIS can enable interference avoidance and multiple user MIMO (MU-MIMO). In some embodiments, the RIS can be used to schedule multiple UEs by reducing interference to other links through opportunistic route selection. In some embodiments, the RIS can be used to enable multi-BS multi-RIS interference avoidance by proper RIS selection and beamforming to reduce the mutual interference caused by different users being served by different BS.

In some embodiments, the use of the RIS can enable multi-hop data transmission, for example a signal can be reflected over multiple hops as shown in FIG. 4C. In some embodiments, this can be combined with diversity enhancements as described above, so that the UE can be served by any subset of the existing RIS in proximity to the UE. The expression “RIS in proximity to the UE” may be considered to mean any RIS that are located near to the UE such that the RIS can reflect an adequate quality signal from another device, such as a base station or another UE, to the UE. From the UE perspective, it may be transparent how many hops the signal experience on route to the UE.

In some embodiments, the use of the RIS can enable coherent reflection. The signal can be reflected to coherently superpose at a target receiver. In some embodiments that may include a superposition with a direct link between the BS and UE. However, coherent reflection involves the devices having a detailed CSI knowledge, which, for example might, be more than just beam direction.

In some embodiments, the use of the RIS can enable multiple BS to multiple RIS links. Such a scenario can enhance the flexibility of a multiple BS system with regard to scheduling. In some embodiments, the use of the RIS can enable RIS assisted user centric no cell (UCNC). In such scenario, the RIS beam is updated when the UE moves from being served by one BS to being served by another BS. However, the UE does not need to change its beam settings and continues to communicate through the reflection of the same RIS or set of RIS. As a result, communication efficiency is improved, and the UE endures lower overhead for signaling and measurement overhead and also may reduce its power consumption.

To enable the use of RIS in a communication system, there are various control and signaling mechanisms that are proposed for operation.

One mechanism pertains to identifying candidate RIS that could be used by the system. In some embodiments, identifying the candidate RIS may involve RIS discovery based on sensing or reference signal (RS) based measurements. In some embodiments, identifying the candidate RIS may involve identification of candidate BS-RIS links and RIS-UE links, wherein a BS-RIS link refers to a link between the BS and the RIS and a RIS-UE link refers to a link between the RIS and the UE. In some embodiments, identifying the candidate RIS may involve network node, such as BS, oriented RIS discovery. In some embodiments, identifying the candidate RIS may involve using sensing or localization, or be based on UL RS measurement, for example a sounding reference signal (SRS). In some embodiments, identifying the candidate RIS may involve UE oriented RIS discovery. In some embodiments, identifying the candidate RIS may involve UE assisted RIS panel identification with UE measurement feedback. The RIS-UE link discovery involves the use of a RS for identifying that a RIS-UE link can be created between the RIS and the UE. This will be followed by the setup of the identified RIS-UE link that involves a subsequent channel measurement between the UE and BS or the UE and RIS. The RS used for identifying the RIS-UE link is less frequent and only for discovery of the RIS-UE link. The subsequent channel measurement used in the link setup may be performed more frequently.

When considering the identification of candidate RIS mechanism, there could be multiple manners in which this could be implemented and assisted. In a network assisted approach, the network aids in RIS-UE link identification. In some embodiments, such a network assisted approach may involve a BS informing the RISs or the UEs, or both, of a possible link based on localization information, such as position information of the RISs and the UEs. In some embodiments, such a network assisted approach may involve a BS providing a list of RIS panels in the proximity of the UEs to the UEs. In some embodiments, such a network assisted approach may involve a BS providing a list of UEs to RISs that are in proximity to the UEs.

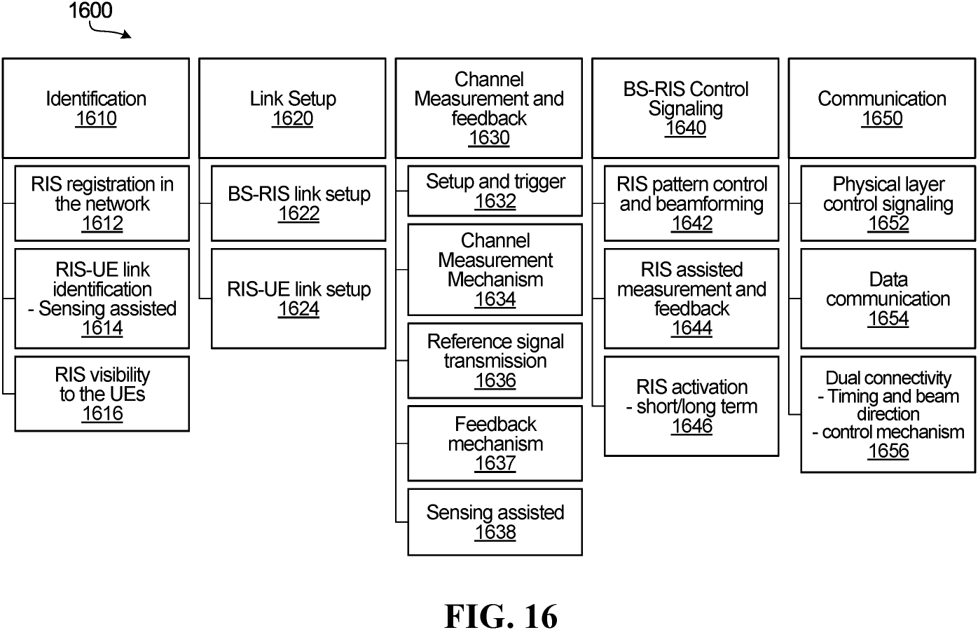

FIG. 16 illustrates multiple operation of the RIS in a wireless communication network of an embodiment provided in the present disclosure. The operations include at least one of 1) identification 1610 of the RIS within the network, 2) link setup 1620 between a BS and a RIS and between the RIS and a UE, 3) Channel measurement and feedback 1630 that allows channel estimation to be performed, 4) RIS control signaling 1640 to configure a RIS pattern on the RIS to redirect a signal between the BS and UE and activate the RIS when the RIS is to be used and 5) communication 1650 that involves physical layer control signaling for configuring the UE when the link is activated and for transmission of data communication between the BS and UE via the RIS. Each of these operations have associated methods that can be performed by the base station, by the RIS and/or by the UE. Examples of such methods will be described in further detail below. In some embodiments, all of the method may be used to implement the discovery of an RIS and setting up and activating a link between the BS and UE for use as desired. However, the various methods can be used independently for an intended use whenever necessary. In some embodiments, the link between the BS and the RIS and the link between RIS and UE may share the same frequency band or occupy different frequency bands (for example different carriers or different bandwidth parts). In some embodiments, the link between the BS and the RIS may be considered and treated as a backhaul link.

Within the scope of the identification operation 1610 are different types of identification that are performed in deployment of the RIS. One feature of the identification operation 1610 pertains to RIS registration 1612 in the network. RIS registration may also be referred to as RIS discovery, RIS identification or RIS recognition and involves the RIS being identified by the network. Another feature of the identification operation 1610 pertains to identification 1614 of a RIS-UE link in the network for any UEs that may be in proximity to the RIS. Another feature of the identification operation 1610 pertains to RIS visibility with regard to the UEs 1616 in the network. Depending on whether the UE knows whether the RIS is in the link redirecting signals from the BS, or not, can affect how the RIS-UE link is identified. Example methods of the various features related to the identification operation 1610, as performed by the base station, by the RIS and by the UE, will be described in detail below.

Each of these operations and features thereof are described in detail below.

The present disclosure provides the identification operation 510 below in some embodiments.

When the RIS is deployed in the network, the RIS has to be discovered, identified or recognized by the network in order to enable an RIS pattern on the RIS surface to be controlled and redirect a signal from the BS to one or more UE. When the RIS is operator deployed, for example when the operator is initially setting up a network and including the RIS in that setup, no signaling may be needed. Anytime RISs are added to the network subsequent to initial network setup has occurred, some level of control signaling may be needed to initialize the RIS within the network. Examples of the signaling will be described below. The initialization of the RIS may involve signaling to determine UE capabilities such as RIS size, RIS technology, reconfiguration speed and communication capabilities. Other signaling includes determining the type (wired, wireless, shared or private), speed, delay, jitter and reliability of the link between the RIS and the network. After the capability establishment, the network may configure the RIS with necessary configurations for communication to the network and the UEs and setup the RIS pattern. These may also be a function of the RIS capabilities. For example, signaling to configure the mechanism for RIS pattern settings is affected by the RIS capabilities, or configuration of the RIS-UE link discovery signal is impacted by the RIS transceiver capabilities.

From the UE perspective, the RIS may be considered in a number of different ways. For example, in some embodiments, the UE may not be aware that the UE is receiving signals that have been redirected by the RIS and as such the RIS may be “invisible” to the UE. In some embodiments, the RIS may be considered to be another UE and the UE can communicate with the RIS substantially using a sidelink type of capability. In some embodiments, the UE interacts with the RIS as it would interact with a BS. In some embodiments, the UE interacts with the RIS as it would interact with a hybrid relay. In some embodiments, the UE interacts with the RIS as a separate entity, such that the RIS is considered to be “visible” to the UE, and interacting with the entity involves using signaling that is based on agreed upon telecommunication standards.

From the BS perspective, the RIS may also be seen in a number of different ways. For example, the RIS may be considered to be part of the BS and may not be considered an independent entity. In some embodiments, the BS may interact with the RIS as the BS would interact with a UE that has a reflection capability. In some embodiments, the BS may interact with the RIS as the BS would interact with a remote radio head (RRH). In some embodiments, the BS may interact with the RIS as the BS would interact with a hybrid relay. In some embodiments, the BS may interact with the RIS by interacting with the RIS considered as a separate entity using signaling that is based on agreed upon telecommunication standards.

The identification operation 510 in some embodiments comprises an operation 512 of RIS Registration by the network.

An initial step in deployment of the RIS may be identification of the RIS by the network. Part of the identification of the RIS involves is forming a link between the BS and the RIS. The RIS link between the network and the RIS may be selected from a number of different types of communication media and as a result may use any of a number of different signaling mechanisms. A list of examples of the variety of communication media between the network and the RIS that is not intended to limit the disclosure, includes:
1) a wired connection such as Ethernet cable and optical fiber;
2) wireless in-band communication (that may include using the same frequency band or using different frequency bands, for example, a different carrier or bandwidth parts);
3) wireless out-of-band communication including use of unlicensed spectrum and other RAT such as Wi-Fi and Bluetooth; and
4) for signaling in a direction from the RIS to the BS, a passive communication mode such as backscattering and passive modulation. Backscattering may involve a wavefront impinging on the RIS being “modulated” to include information about the RIS. The modulation may constitute amplitude/phase/frequency manipulation of the signal by the configurable elements of the RIS, i.e. using an appropriate RIS set of patterns.

Discovery of the RIS includes signaling or messages exchanged between the RIS and the network, which may occur via one or more BS, may be performed using any of a variety of signaling methods. In some embodiments, a method for discovery of the RIS includes a proprietary type of signaling that is an agreed upon type of signaling between the BS and the RIS that does not use any existing standards.

In some embodiments, the RIS registration may include the network obtaining RIS capability information (such as, but not limited to, RIS material type or which RIS parameters can be controlled, response time, RIS control function/capability).

In some embodiments, the RIS identification may also include RIS localization. For example, the network can obtain RIS positioning information through sensing or positioning, meaning the position of the RIS can be determined based on signaling by the network and RIS to find one another. RIS positioning information can also help to determine possible BS-RIS links and RIS-US links.

Cellular networks were originally designed for wireless communication, and the rapidly increasing demand for location-based applications has drawn a considerable amount of attention to positioning research in cellular networks. Some of the more intriguing 6G applications involve sensing environments through high-precision positioning, mapping and reconstruction, and gesture/activity recognition. Sensing will be a new 6G service, and it can be described as the act of obtaining information about a surrounding environment. It can be realized through a variety of activities and operations, and classified into the categories of RF sensing and non-RF sensing. RF sensing involves sending a RF signal and learning the environment by receiving as well as processing the reflected signals. Non-RF sensing involves exploiting pictures and videos obtained from a surrounding environment (for example via a camera).

By sending an electromagnetic wave and receiving echoes, RF sensing is able to extract information of the objects in an environment, such as existence, texture, distance, speed, shape, and orientation. In current systems, RF sensing is limited to radar, which is used to localize, detect, and track passive objects, i.e., objects that are not registered to the network. Existing RF sensing systems have various limitations. They are stand-alone and application-driven, meaning they do not interact with other RF systems. Furthermore, they only target passive objects and cannot exploit the distinct features of active objects, i.e., objects registered to the network.

In some embodiments, the signaling and messages exchanged between the RIS and the network may be new signaling types that are specific to communications for the RIS.

In some embodiments, a method for discovery of the RIS includes an existing signaling mechanism, such as Xn, radio resource control (RRC) and physical downlink shared channel (PDSCH). In some embodiments, the link between the RIS and the network may be a backhaul link and be treated as such for the case of signaling on the link. In such embodiment, this may include augmenting the existing mechanisms to specifically include RRC messages to enable signaling between the BS and the RIS.

In some embodiments, RIS discovery involves the RIS sending a signal over-the-air to be discovered by network. In some embodiments, the signal is random access channel (RACH) based if the RIS has a transceiver to send an uplink RACH signal. In some embodiment, the RIS uses a same type of RACH mechanism as a UE. The RIS is identified as a RIS as part of the RRC setup. In some embodiments, the RACH mechanism is specifically for the RIS.

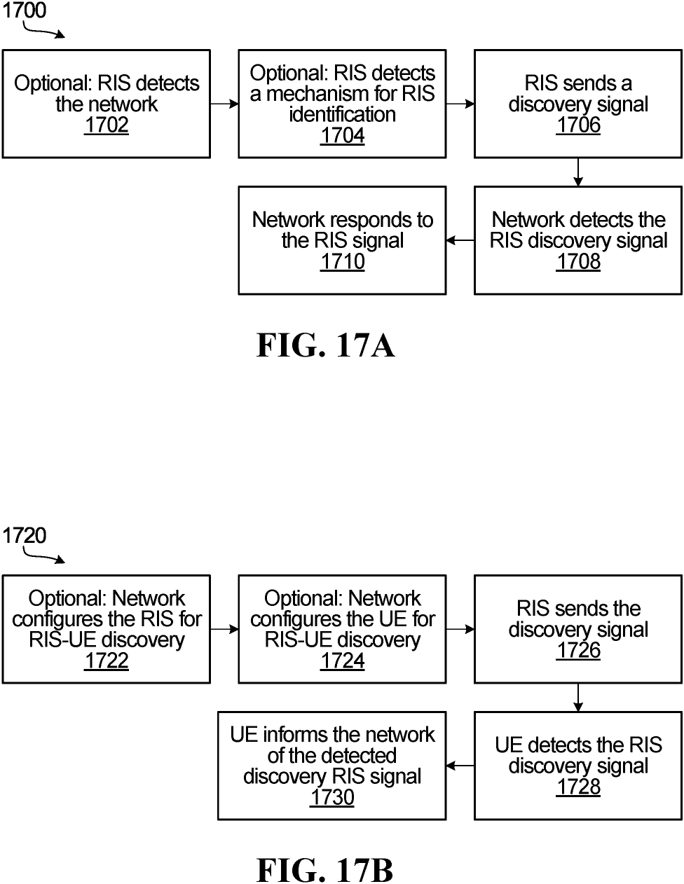

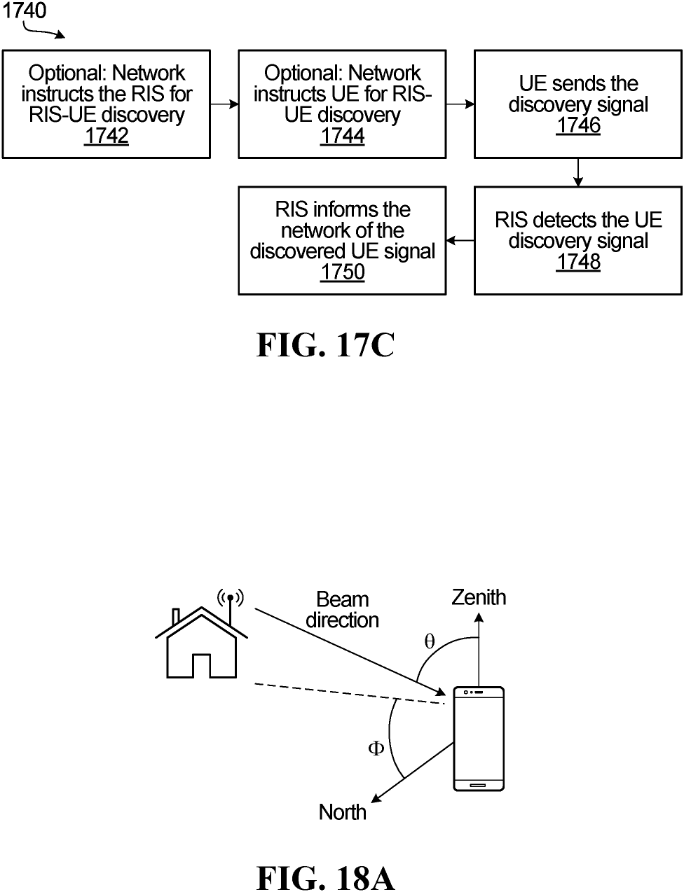

FIG. 17A is a flow chart that illustrates an example of steps that may be involved in over-the-air RIS discovery 1700 by the network. Step 1702 is an optional step, that involves the RIS detecting the network. Step 1704 involves the RIS determining the mechanism for RIS identification. Step 1706 involves the RIS sending a discovery signal such as synchronization signal. Step 1708 involves the network detecting the discovery signal sent by the RIS in step 1706. Step 1710 involves the network responding to the discovery signal.

In some embodiments, RIS discovery may be backscattering based. The RIS reflects the original signal and modulates the reflection with an RIS identifier (RIS ID). The original signal may be sent by the BS as part of RIS discovery.

In some embodiments, RIS discovery may be backhaul based discovery. For example, the RIS is connected to a wired backhaul connection and announces the relevant RIS information.

In some embodiments, RIS discovery may be manually programmed such that the RIS discovery information is manually shared with the TRP.

In some embodiments, the RIS may send a signal to be discovered by the UE. Such a signaling mechanism may be specified by a telecommunications standard and does not require configuration initiated by the BS at the RIS and/or the UE. In some embodiments, the network may configure the RIS and/or the UE for discovery.

In some embodiments, if the RIS has a transceiver, the RIS can discover the RIS-UE link by directly communicating with the UE as described with regard to FIG. 17B.

In some embodiments, the RIS discovery may be a regular device-to-device (D2D) discovery. For example, the RIS uses the same UE discovery mechanism as for D2D.

In some embodiments, the RIS discovery may use a discovery mechanism that is specific to UE and RIS discovery. The mechanism that is specific to UE and RIS discovery may be enhanced by sensing tools and/or network assistance such as RIS and UE list sharing, coordination sharing or ID sharing.

In some embodiments, the RIS-UE discovery may be backscattering based. The RIS reflects a signal to the UE and modulates the reflection with the RIS ID. The original signal may be sent by the BS as part of RIS-UE discovery and reflected by the RIS. Alternatively, the signal is sent by the UE and reflected by RIS. The network detects the reflected signal and informs the RIS and/or the UE about the detected signal.

FIG. 17B is a flow chart that illustrates an example of steps that may be involved in RIS discovery by the UE 1720. Step 1722 is an optional step that involves the network configuring the RIS for RIS-UE discovery. This may involve the BS sending configuration information to the RIS that includes information identifying UEs that might be in the proximity of the RIS, RIS pattern information that might be needed by the RIS, scheduling information, etc. Step 1724 is an optional step that involves the network configuring the UE for RIS-UE discovery. This may involve the BS sending configuration information to the UE that includes information identifying RISs that might be in the proximity of the RIS and information about a discovery signal, e.g. the type of signal, scheduling information, etc. Step 1726 involves the RIS sending a discovery signal. Step 1728 involves the UE detecting the discovery signal sent by the RIS in step 1726. Step 1730 involves the UE informing the network of the detected discovery RIS signal.

FIG. 17C is a flow chart that illustrates an example of steps that may be involved in UE discovery by the RIS 1740. Step 1742 is an optional step that involves the network configuring the RIS for RIS-UE discovery. This may involve the BS sending configuration information to the RIS that includes information identifying UEs that might be in the proximity of the RIS, RIS pattern information that might be needed by the RIS, scheduling information, etc. Step 1744 is an optional step that involves the network configuring the UE for RIS-UE discovery. This may involve the BS sending configuration information to the UE that includes information identifying RISs that might be in the proximity of the RIS and information about a discovery signal, i.e. the type of signal, scheduling information, etc. Step 1746 involves the UE sending a discovery signal. Step 1748 involves the RIS detecting the discovery signal sent by the UE in step 1746. Step 1750 involves the RIS informing the network of the detected discovery RIS signal.

Once the RIS is deployed into the network, the network may be notified of the entry of the RIS into the network using initial access signaling. In some embodiments, this may be part of a “plug and play” functionality of the RIS, that allows the RIS to be deployed such that the setup is substantially automatic from the perspective of the user deploying the RIS. The initial access signaling may be an existing mechanism or an initial access mechanism specific to the RIS. An example of an initial access mechanism specific to the RIS may be RIS specific RACH sequences and RIS specific RACH channel resource allocation. In some embodiments, network nodes may be programmed with the necessary information to work with the RIS and thus skip the registration step.

After the RIS is identified, or discovered, by the network, the RIS has to be registered and fully configured by identifying links between the RIS and UE before the RIS can be used to communicate with one or more UEs. This may involve identifying links between the RIS and one or more UEs, i.e. identifying RIS-UE links

The identification operation 510 in some embodiments comprises a RIS-UE link identification operation 1614.

After the RIS is integrated into the network, for proper operation of the RIS to redirect signaling between the BS and the UE, a RIS-UE link needs to be discovered. The link between RIS and UE can share the same frequency band or occupy different frequency bands (carrier or bandwidth part). RIS-UE link discovery may also be referred to as RIS-UE link determination or RIS-UE link identification. Furthermore, discovery of the RIS-UE link may be a precursor to performing RIS-UE link setup.

In a communication system that does not necessarily use a RIS, BS-UE link identification by the network and UE sidelink identification between UEs is supported by existing standards. This RIS-UE link identification operation can identify a possible RIS and UE association, which can be used for a transmission link determination during scheduling. RIS-UE link identification can be done by sensing and localization technologies or through the detection of a reference signal by the UE by using a DL reference signal (such as SSB or CSI-RS) or by the BS using an UL reference signal (such as RACH or SRS). In such scenarios, network identification of the UE is performed through synchronization and occurs following broadcast signaling. For cell discovery, a reference signal may be transmitted to the UE to identify the cell, for example, a channel state information reference signal (CSI-RS). UE identification by the network may use an initial access mechanism and physical random access channel (PRACH). The underlying communications standard (such as 6G or New Radio (NR) standard) also provides a signaling mechanism for sidelink discovery. In some embodiments a mechanism like the sidelink discovery could be used when the RIS is to be treated as a discrete network element.

The identification operation 510 in some embodiments comprises an operation 1616 of RIS visibility to the UE.

Depending on the how the UE perceives the RIS, RIS-UE link identification can occur utilizing any of a number of different methods. In some embodiments, the RIS may be considered to be invisible to the UE, i.e. the UE simply considered the RIS as part of the network, not necessarily as a discrete node. When the RIS-UE link is for DL signaling, the RIS reflects the synchronization signal (SSB/PBCH). In an example, the RIS substantially performs like a remote radio head (RRH) from the network. The UE does not realize that the synchronization signal is reflected by the RIS. Reference signal measurement performed using particular ports or configurations, which may include CSI-RS measurement, can be used to determine whether the UE receives the original signal directly from the BS or its reflected version by the RIS. For example, if a signal is coming directly from a BS in a different direction than the reflected signal from the RIS, and particular configurations allow for receiving signals from different directions, then one direction can be associated with a signal coming directly from a BS and another direction can be associated with a signal reflected signal from the RIS. Another example, is to receive two copies of the RS in every direction. For a first copy the RIS is enabled for reflection and for the second copy, the RIS is disabled. A successful reception of on both copies of the RS indicates reception of the direct transmission from the transmitter to the receiver, while a successful reception of only the first copy in one direction would indicate the reception of the reflected copy. When an uplink reference signal, such as a sounding reference signal (SRS), is used, the UE sends the SRS and the RIS detects the SRS or the RIS reflects the SRS and the BS detects the reflected signal to detect the possible link. Similar mechanisms such as those in the above examples are applicable.

In some embodiments, the RIS may be considered to be visible to the UE, i.e. the UE is made aware of the RIS and considers the RIS as a discrete node. Various methodologies will now be described where the RIS is treated in this manner by the UE.

In some embodiments, the RIS may be treated by the UE as a discrete network component, similar to another UE, such that the RIS-UE link could substantially be treated as a link between two devices where sidelink transmission could be used. When treating the RIS-UE link as sidelink, a device to device (D2D) discovery mechanism, or an enhanced mechanism, with or without the assistance of the BS, sensory information and/or other communication mechanisms or frequency bands may be used to discover the RIS. In such scenarios the RIS could be equipped with a transceiver to be able to perform D2D discovery and link setup. When a link between the RIS and UE is based on SL, the SL and Uu link (the link between the BS and the UE or between the BS and RIS) can occupy different carriers and/or different bandwidth parts.

In some embodiments, the RIS may be treated like a small BS by the UE. When treated as a small BS, the RIS may send or reflect a synchronization and/or measurement signal to the UE coverage area, such as SSB/PBCH and/or CSI-RS, which the UE can detect and measure. This may be done using an incorporated transceiver in the RIS or through the beam reflection capabilities of the RIS reflecting the original signal transmitted by a neighboring transmitter.

In some embodiments, the RIS-UE link may be determined using RIS specific discovery, i.e. a discovery mechanism that would be used specifically for discovering the RIS in a communication system, as opposed to discovery a UE, or a relay, etc. RIS specific discovery may use specific signaling that is specified in a telecommunications standard to enable UE-RIS link discovery. Such signaling mechanism may be originated at any of the BS, UE and RIS and be detected by any other of the BS, UE and RIS, depending on the underlying RIS capability, the telecommunications standard support for the devices and signaling mechanism and the configuration signaling for the devices and signaling mechanism. As an example, the RIS may reflect a set of signals in different directions while the original signal is transmitted by a BS toward the RIS and the UE detects and measures the original signal to find the RIS and the corresponding direction. In another example, the UE sends the identifying signal as configured by the BS and the RIS detects it to identify the UE and the corresponding direction.

In some embodiments, the RIS-UE link determination may be network assisted. In some embodiments with network assistance, the UE is notified with information about the RIS, such as a signal that will be transmitted by the BS and reflected by the RIS to allow the UE to identify the RIS based on receiving the signal and/or the location of the RIS. In some embodiments with network assistance, the RIS is informed by the network regarding UEs that may be in proximity of the RIS to which the RIS can form a link. When informing the RIS, the network may also inform the UE about the RIS in the proximity of the UE.

In some embodiments the RIS-UE link determination may be sensing assisted. In some embodiments with sensing assistance, the RIS and the UE can use RF based sensors or non-RF based sensors to detect each other. The integrated sensing mechanism can be used to directly or indirectly identify the link. An example for direct determination includes detecting RF sensing signals (within the same band and/or RAT or other bands or other RATs) emitted by the other node (RIS emission and UE detection or UE emission and RIS detection). Another example for direct determination includes detection of a RF sensing signal emitted by one node, reflected by the other node and detected by the original emitting node. A further example for direct determination includes using a camera to detect the presence of the other node. An example for indirect sensing is detecting the presence of the other node using a camera. For example, the UE camera may capture an image that includes the RIS and use pattern recognition to identify the RIS or detect a quick response (QR) code embedded in the RIS. Alternatively, the RIS may emit an infrared beam which can be detected by the UE for RIS identification and direction setting. In some embodiments, when sensing assistance is being used for RIS-UE link determination, additional information may be provided by the network, such as network knowledge of where the UE is currently located, UE orientation, RIS location and orientation, a map of the area to identify possible link blockage, UE and RIS capabilities, such as sensing capabilities that can include one or more of a camera, a gyroscope, a compass, and lidar. This additional information may be useful to the RIS in helping to determining where UEs are and therefore aid in the RIS-UE link determination. For example, if the RIS knows at least generally where the UE is, the UE knows where to start reflecting a signal from the BS, by using a particular RIS pattern.

In some embodiments the RIS-UE link determination may be performed using other mechanisms. Other mechanisms that could be used to identify the link include the UE and RIS detecting each other using other RATs such as a BLUETOOTH identifier (ID) or Wi-Fi beacons. If other RATs are used, then the UE and RIS need to be configured with radios capable of operating in the appropriate manner, i.e. Bluetooth radios, Wi-Fi radios, etc. These other RATs may be used in a substantially normal operating manner for establishing a link between two devices communicating via the respective RAT. In some embodiments, the RIS periodically sends a Wi-Fi beacon, and the BS informs the UEs about the service set ID (SSID) carried by the beacon. The UE then identifies the RIS within the vicinity of the UE by detecting the beacon and associated SSID. The UE and RIS may use the underlying Wi-Fi connection to establish the link. Alternatively, the UE informs the BS about the detection of the SSID and the link between RIS and UE is then established by the BS. The UE may not need to know the SSID is associated with a RIS and UE just detects the SSID and informs the BS about its detection.

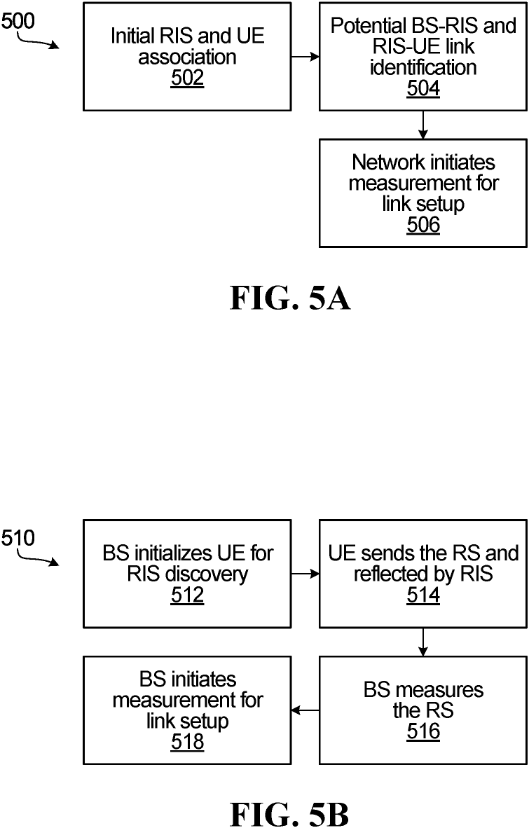

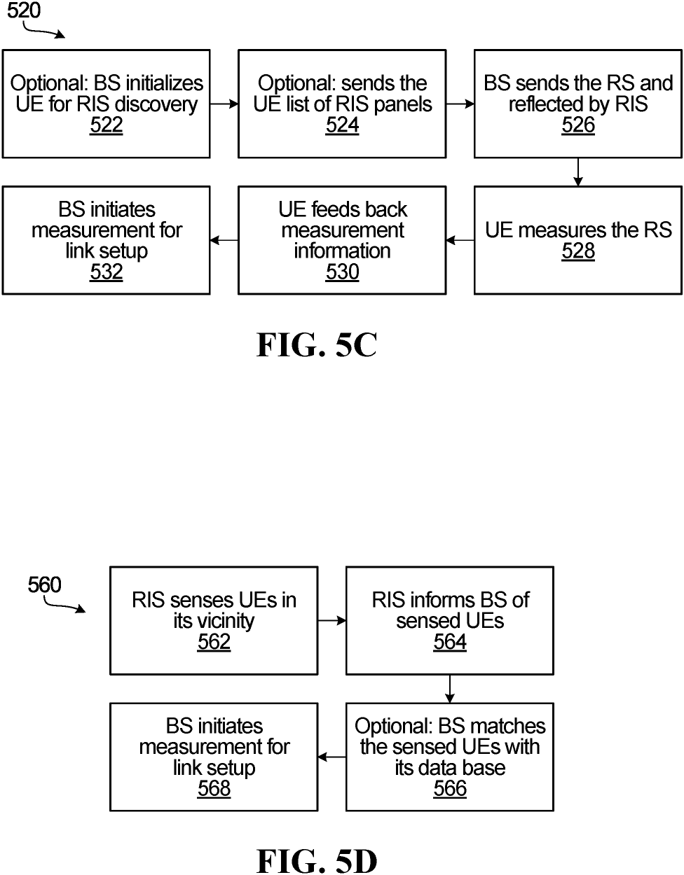

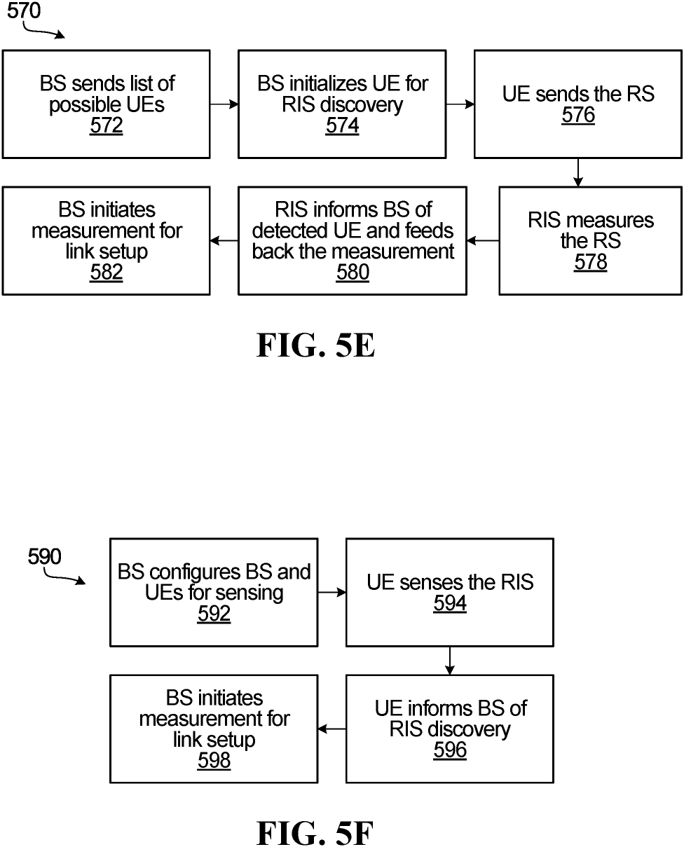

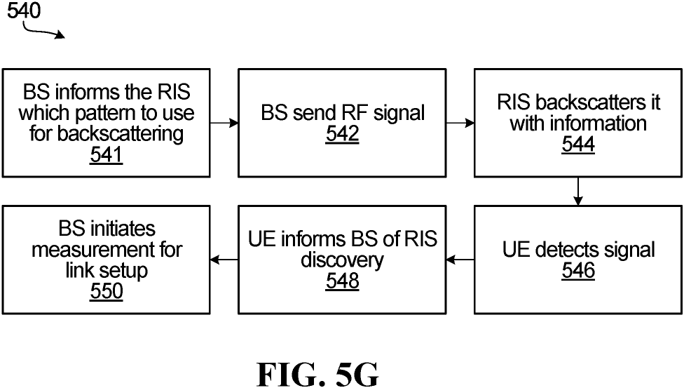

FIGS. 5A to 5G provide example flow charts for different methods that may be used for RIS-UE link identification described above.

FIG. 5A is a flow chart that illustrates an example of steps that may be involved in RIS-UE link identification 500 that involves BS oriented discovery. Step 502 involves performing an initial RIS and UE association. This may involve the BS performing a comparison of information stored locally, such as in the BS memory. For example, a list of UEs and their positions may be compared with a list of RISs and their positions to determine which RISs are in proximity to which UEs. Step 504 involves the BS identifying a potential BS-RIS link and a potential RIS-UE link based on the comparison performed in step 502. Step 506 involves the network a channel measurement, for example that may be used for channel estimation to determine channel quality, as part of link setup . This channel measurement will be described below.

In a measurement-based approach to identification of candidate RIS, a BS, UE or RIS performs measurement to determine RIS-UE link quality. In some embodiments, RIS measurement may be performed for per hop link quality. In some embodiments, a BS or UE performs an end-to-end channel measurement. In some embodiments, a UE can feedback measurement results to the BS. When the UE feeds back measurement results to the BS, a RIS may receive the feedback information, if the RIS has a receiver capable of doing so, and the RIS can use this feedback information in determining a RIS pattern that should be used to reflect a signal to the UE or BS, depending on the direction of the signal. The RIS may need to receive configuration information from BS to be able to receive the feedback information.

In a measurement-based approach to identification of candidate RIS, the identification may be assisted by sensing information. In some embodiments, a RIS is able to sense a UE or a UE is able to sense a RIS using communication based sensing or other types of sensors. In some embodiments, when a RIS senses the UE, if the RIS does not have access to the UE identity, the network can match the sensed UE with an active UE list, and notifies the RIS and/or UEs about the potential link.

FIG. 5B is a flow chart that illustrates an example of steps that may be involved in RIS-UE link identification 510 that involves the BS performing channel measurement of a reference signal transmitted by the UE. Step 512 involves the BS configuring the UE for RIS discovery. This step may involve the BS sending configuration information identifying a type of RS the UE should send that will be redirected by RIS. In this step, the BS may also send scheduling information of when the UE should send the RS. Therefore, when the UE sends the RS the BS can identify that the RS was reflected by the RIS. Step 514 involves the UE sending the RS, which the RIS reflects to the BS. Step 516 involves the BS measuring the RS. Step 518 involves the BS initiating a channel measurement that may be used for channel estimation, as part of link setup. Examples of channel measurement methods will be described below.

FIG. 5C is a flow chart that illustrates an example of steps that may be involved in RIS-UE link identification 520 that involves the UE performing channel measurement of a reference signal transmitted by the BS. Step 522 is an optional step that involves the BS configuring the UE for RIS discovery. This step may involve the BS sending configuration information identifying a type of RS the BS will send that will be redirected by the RIS and scheduling information of when the BS will send the RS. Therefore, when the BS sends the RS the UE can identify that the RS was reflected by the RIS. Step 524 is another optional step that involves the BS sending the UE a list of RIS panels in the proximity of the UE so that the UE will know which RIS it may be receiving a reflected signal from. Step 526 involves the BS sending a RS, which the RIS redirects to the UE. Step 528 involves the UE measuring the RS. Step 530 involves the UE feeding back measurement information to the BS. Step 530 involves the UE feeding back measurement information to the BS. Step 532 involves the BS initiating a channel measurement that may be used for channel estimation, as part of link setup. Examples of channel measurement methods will be described below.

FIG. 5D is a flow chart that illustrates an example of steps that may be involved in RIS-UE link identification RIS 560 that involves RIS assisted UE discovery based on sensing. Step 562 involves the RIS sensing of any UEs in the vicinity of the RIS. This sensing can be RF based or non-RF based. RF based sensing may use in band measurement by one node (BS, UE or RIS) and detection with or without the involvement of the other node (BS, UE or RIS). Examples are when the sensing uses one node sending a sensing signal and the other node detecting the sensing signal, when a node sends the sensing signal and the same node or a different node measures a reflection of the sensing signal or when the node measures a reflection of the sensing signal sent from a non-cooperating node. Sensing may use other RF based mechanisms such as backscattering, Bluetooth or Wi-Fi. It may also use other sensors such as global positioning system (GPS), a camera, and Lidar. Step 564 involves the RIS informing the BS of the sensed UEs. Step 566 is an optional step that involves the BS matching the sensed UEs with a list of UEs stored in the BS. Step 568 involves the BS initiating a channel measurement that may be used for channel estimation, as part of link setup. Examples of channel measurement methods will be described below.

FIG. 5E is a flow chart that illustrates an example of steps that may be involved in RIS-UE link identification 570 that involves UE assisted RIS discovery. Step 572 involves the BS sending the RIS a list of UEs in the proximity of the RIS that are possible UEs the RIS could form a link. Step 574 involves the BS configuring the UE for RIS discovery. This step may involve the BS sending configuration information identifying a type of RS the UE should send that will be detected by RIS and scheduling information of when the UE should send the RS. Therefore, when the UE sends the RS, the RIS can identify which UE sent the RS. Step 576 involves the UE sending a RS. Step 578 involves the RIS measuring the RS sent by the UE. Step 580 involves the RIS informing the BS of detected UEs and feeding back the measurement based on the measured RS. Step 582 involves the BS initiating a measurement that may be used for channel estimation, as part of link setup. Examples of channel measurement methods will be described below.

FIG. 5F is a flow chart that illustrates an example of steps that may be involved in RIS-UE link identification 590 that involves RIS assisted UE discovery based on sensing. Step 592 involves the BS configuring BS and the UE for sensing . This step may involve the BS sending configuration information identifying a type of sensing signal the UE should use to sense the RIS and scheduling information of when the UE should attempt to sense the RS. Step 594 involves the UE sensing the RIS. Step 596 involves the UE feeding back notification of the RIS detection by the UE based on the UE sensing. Step 598 involves the BS initiating a measurement that may be used for channel estimation, as part of link setup. Examples of channel measurement methods will be described below.

In a measurement-based approach to identification of candidate RIS, a RIS may backscatter a signal transmitted by BS or the UE by including some modulation identification information to the signal.

FIG. 5G is a flow chart that illustrates an example of steps that may be involved in RIS-UE link identification 540 that involves RIS backscattering. Before the BS sends an RF signal that will be backscattered or modulated by the RIS, the RIS needs to configure the elements of the RIS panel with an appropriate RIS pattern at step 741. There are several ways this can be achieved. In some embodiments, the BS sends configuration information to the RIS for configuring the RIS pattern. In some embodiments, the RIS pattern is selected by the RIS, for example from a list of possible patterns that may be specified by a communications standard. In some embodiments, the pattern is associated with at least one of a RIS manufacturer, a RIS serial ID, or a RIS model number. Step 542 involves the BS sending an RF signal. Step 544 involves the RIS backscattering the RF signal by modulating the RF signal with information as the RF signal is reflected by the RIS. Step 546 involves the UE detecting the RF signal. Step 548 involves the UE feeding back notification to the BS of RIS discovery by the UE based on the detected backscattered signal. Step 550 involves the BS initiating a measurement that may be used for channel estimation, as part of link setup. Examples of channel measurement methods will be described below.

Another mechanism pertains to setting up a cooperative RIS link. A cooperative RIS link includes using multiple links between the transmitter and receiver, at least one of which uses a RIS to reflect a signal from the transmitter to the receiver. Therefore, this could include a direct link plus one or more other links, each of the one or more links with a RIS used to reflect or a respective signal from the transmitter to the receiver or two or more other links, each of the two or more links with a RIS used to reflect or a respective signal from the transmitter to the receiver. In some embodiments this mechanism sets up signaling to maintain the link between the RIS and UE. In some embodiments, setting up the cooperative RIS link is controlled by the network. This may involve the network identifying the cooperative RIS link and configuring both the RIS and the UE. In some embodiments, the network sending configuration may include radio resource control (RRC) messaging that includes settings for CSI measurement and configuration information for implementing feedback. In some embodiments, the network shares raw or processed CSI information for RIS pattern control. This may include providing the RIS a RIS pattern or information to allow the RIS to generate the RIS pattern.

Referring back to FIG. 16, within the scope of the link setup operation 1620, there are two features shown. One feature of the link setup operation 1620 pertains to BS-RIS link setup 1622. Another aspect of the link setup operation 1620 pertains to RIS-UE link setup 1624. Example methods related to the link setup operation 1620, as performed by the base station, by the RIS and by the UE, will be described in detail below.

After the RIS is deployed in the network, the RIS can set up the BS-RIS link and the RIS-UE link. Setting up the BS-RIS link involves the network configuring the RIS to establish a link capable of exchanging control information in order to enable the network to allow the BS to send signaling for configurating the RIS to interact with the UE, and optionally to exchange other information that may be relevant to setting up the UE-RIS link. For example, if the RIS is using the initial access mechanism to access the network, the BS may follow up with some signaling, possibly using RRC signaling, to setup the link. Alternatively, the BS may use backhaul, Xn or Integrated Access Backhaul (IAB) signaling, or other mechanisms, to establish this BS-RIS link.

The link setup operation 520 in some embodiments comprises a BS-RIS link setup operation 522.

Unless the BS is pre-programmed with all the necessary mechanisms to work with the RIS using a channel and signaling mechanism that is vendor specific, the RIS and the BS need to setup the link between one another. In some embodiments, when the RIS is using the initial access mechanism to access the network, the RIS may follow up the initial access to the network with signaling to setup the link with the BS. In some embodiments, the signaling may use RRC signaling. In some embodiments, the RIS may use backhaul Xn or IAB signaling or other mechanisms to establish this link. Examples of methods for setting up the BS-RS link will be described below. Several different types of configuration and control signaling messages that are used between the BS and the RIS are described below.

In some embodiments, the signaling may be used for performing a capability information exchange. The RIS and BS may exchange information about at least one of the capabilities of the RIS (including the RIS reconfiguration speed), a required working bandwidth, location information pertaining to the RIS, data capacity and delay of the BS-RIS control link, and sensing capabilities. The data capacity and delay of BS-RIS control link may refer to the speed at which control information can be received and processed at the RIS and the overall delay for the transmission and processing those control messages, for example, if LF or HF or other links are used for the control information signaling between BS and RIS Examples of capabilities of the RIS include, but are not limited to, frequency band, working bandwidth, phase control range, reconfiguration speed, size, linearity or reciprocity properties of the RIS.

Part of the BS-RIS set up involves the configuration of the RIS pattern used by the RIS to redirect a signal from either the BS or the UE. In some embodiments, control signaling includes a RIS pattern control mechanism. The BS and RIS agree on the RIS pattern control scheme. The RIS pattern is controlled under the direction of the network and is based on factors such as the underlying channel condition, the RIS-UE pairing, scheduling decision or serving BS, if more than one BS serves the UEs through the same RIS panel. The RIS pattern being controlled under the direction of the network means, for example, that the network provides configuration information for the RIS to generate the RIS pattern that is used to redirect a signal from the BS or from the UE to the UE or to the BS. The RIS may or may not have access to all the configuration information and as such different modes for controlling the RIS pattern may be used.

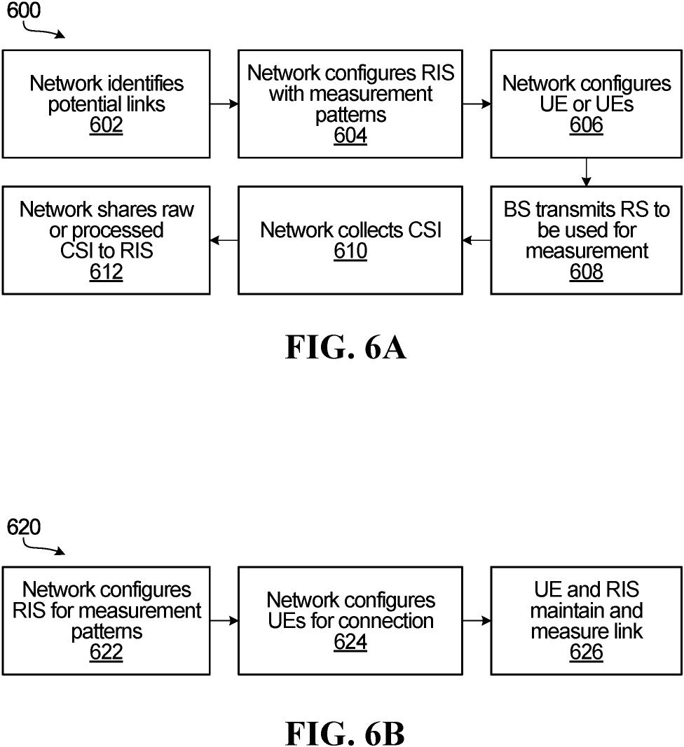

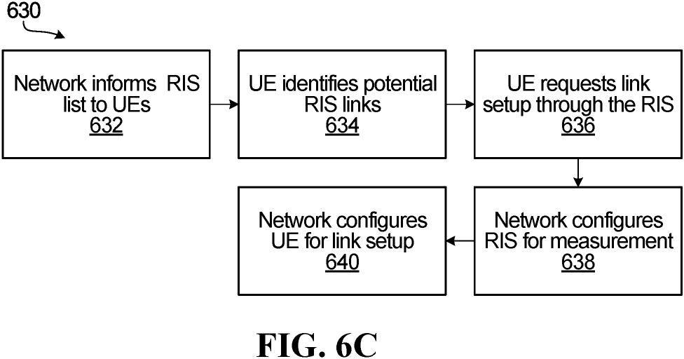

In some embodiments, the RIS pattern is fully controlled meaning that the RIS pattern is fully determined by the network. This may involve expressing RIS pattern information such as bias voltage for each element of the RIS panel or a phase shift (absolute or differential) for each element of the RIS panel to generate the RIS pattern. The RIS pattern information may be absolute RIS pattern information, e.g. the bias voltage or phase shift information for each configurable element of the RIS panel or be an alternative version of the information, maybe an index to a predefine RIS pattern known to the RIS that could be used to reduce overhead as compared to the absolute RIS pattern information. As the network is providing the RIS pattern information to the RIS, the RIS does not need to know any information about the channel, such as for example the CSI, and the UE that the BS is serving. The RIS receives the RIS pattern information, biases the configuration elements of the RIS panel based on the RIS pattern and any signal sent by the BS will be redirected by the RIS panel based on the configured RIS pattern. As the network is providing the RIS pattern information, the network controlled BS that is communicating with the RIS should be aware of detailed CSI (with the resolution up to element or element group) and also have knowledge of the control mechanism of the RIS panel. The detailed CSI can be determined by channel measurement that will be described in examples below as referenced in FIGS. 6A to 6C. Knowledge of the control mechanism of the RIS panel may be provided, for example, by the RIS as RIS capability information.

In some embodiments, the RIS pattern is partially controlled by the network. The BS provides the RIS configuration information that may include one or more of beam shape, beam direction and/or beam width of the impinging and/or reflecting beams at the RIS and the RIS can then determine a phase shift for each configurable element to achieve a desired RIS pattern. The direction may be expressed in absolute or relative terms with respect to other beam directions or previous RIS patterns, for example a few degrees of update in a particular direction. The RIS does not need to know CSI other than the particular beam direction signaled to it. The BS in such a case, does not need to know exactly how to implement the RIS pattern on the RIS panel. This mode allows a unified signaling between the BS and the RIS for different RIS panels. Also, this mode allows for self-calibration of the RIS without involving the BS.

In some embodiments, the RIS pattern is controlled by the RIS using RIS self-pattern optimization. This control mode is for RIS panels having a higher complexity, where the RIS has access to the CSI for both the BS-RIS link and the RIS-UE link (or alternatively the end to end BS-UE channel) and the RIS-UE link setup information. In some embodiments, the CSI knowledge may be acquired by the RIS itself through measurement or sensing, or both. In some embodiments, the CSI knowledge may be shared to the RIS by the UE, or the BS, or both. The active RIS-UE link is configured by the BS and the RIS optimizes the RIS pattern for serving the UE. For measurement purposes, the RIS may determine its own beam sweeping patterns as instructed by the BS.

In some embodiments, the RIS pattern is controlled using a hybrid mode. The RIS uses self-pattern optimization for the measurement functionality. However, for data communication, partial control is adopted where the RIS is instructed to use the RIS pattern with respect to the RIS patterns selected for measurement. As an example, the BS instructs the RIS to select N (an integer) different RIS patterns for N different instances of CSI-RS reflection. The RIS optimizes the N patterns in part based on the instructed number and/or based on the sensed information of the location of UEs or walls. Only the RIS needs to know the actual patterns. The RIS then uses the selected N different RIS patterns to redirect N copies of a CSI-RS from the BS on the BS-RIS link. The UE measures all or some of the CSI-RS that are redirected by the RIS in the direction of the UE and reports measurement results back to the BS. The BS then selects one of the RIS patterns and informs the RIS to use the selected pattern from the N measurement patterns, or a combination of several of the RIS patterns. In some embodiments, the RIS can perform initial beam forming or beam detection as an initial part of RIS-UE beamforming setup. Further beam turning can be performed by BS control. For example, the RIS may have some basic sensing capability and can determine beam directions for the UE that are close to the RIS. The RIS can share the determined beam direction information with the BS to help beamforming for further communication from the BS to the UE via reflection off the RIS.

After the BS-RIS link has been set up, a link may also be set up between the RIS and the UE. Setting up the RIS-UE link involves measurement of the link between the RIS and the UE, for example to perform channel estimation of the link.

The link setup operation 520 in some embodiments comprises a UE-RIS link setup operation 524.

In some embodiments, the RIS may be considered to be “invisible” to the UE, i.e. the UE does not necessarily know the RIS is in the link, so that the UE assumes the signal is received directly from the BS. In some embodiments, when the RIS is “invisible” to the UE, the UE-RIS link setup may involve channel measurement of the RS-UE link. In some embodiments, after the UE has determined a channel measurement, the UE sends feedback information regarding the channel measurement from the UE to the RIS, from the UE directly to the BS or from the UE to the BS via reflection off of the RIS. Since the RIS is invisible to the UE, the UE does not know which node receives its feedback and may use the beam direction as instructed by the BS or to the same direction it receives the measurement RS. Examples of channel measurement are described below with reference to FIGS. 6A to 6C.

The UE-RIS link setup can be uplink based or downlink based depending on whether the UE sends the RS or the UE receives the RS. The setup can be independent of whichever device, the BS or the UE, is on the other end of the measurement link from the transmitting device. In downlink based measurement, the UE can feedback the measurement to the UE.

When the RIS is visible to the UE, i.e. the UE knows that the RIS is in the vicinity and reflecting a signal from the BS, the UE may receive information about the RIS from the BS. For example, the UE may receive information including the RIS ID, where the RIS is located, so that the UE can determine a direction that it will receive a reflected signal from the RIS and an identification of a type of signal that the UE should expect to receive redirected from the RIS to properly identify the receive signal as being reflect by the RIS. Information about the location of the RIS may be absolute location information such as longitude/latitude/altitude/orientation or relative location information in respect to some other location that is known by the UE. In some embodiments, the RIS may use at least one of RIS specific SSB, RIS specific scrambling sequences for control channel, data channel or reference channel, RIS frequency band and bandwidth. and RIS specific reference signal structure (such as RIS specific patterns or RIS specific reference signal sequences). In some embodiments, the UE may optionally be able to make a direct link to the RIS using in-band or out-of-band communication. In some embodiments, the UE may use sidelink to communicate with RIS, or even use other RATs, such as Wi-Fi or BLUETOOTH.

In some embodiments, the RIS panel may be divided into sub-panels based on configuration information from the BS, where each sub-panel may serve a different UE or set of UEs. The sub-panels may be physically or logically differentiated. In some embodiments, the RIS may be comprised of multiple smaller panels that are each controllable separately. In some embodiments, the RIS comprises of one panel and the BS instructs the RIS to apply independent patterns to different subsets of RIS elements. If the RIS pattern is fully controlled by the network, this phenomenon is transparent to the RIS. However, for partially controlled or autonomous RIS panels, the RIS is aware of the fact that different sub-panels use independent RIS patterns. Therefore, multiple RIS-UE links can be set up for a single RIS for which the RIS is divided into multiple sub-panels. In the following description, the RIS pattern for each sub-panel is referred to individually as the RIS may change the pattern of one sub-panel without changing the rest. In such a case, the RIS panel is effectively divided into multiple smaller co-planar panels.

The link setup involves having to perform channel measurement to establish the links. Referring back to FIG. 16, within the scope of the channel measurement and feedback operation 1630, which comprises at least one of the five operations shown. A first feature pertains to setting up and triggering 1632 of channel measurements. The second feature pertains to a channel measurement mechanism 1634, for example on a per hop basis or on an end-to-end basis. The third feature pertains to reference signal transmission 1636. The fourth feature pertains to a feedback operation 1637. The fifth feature pertains to a sensing assisted operation 1638. Example methods related to the channel measurement and feedback 1630 functionality, as performed by the base station, by the RIS and by the UE, will be described in detail below.

In order to effectively perform communication between the UE and the BS via the RIS, the BS, the UE and/or the RIS, need knowledge of the channel, for example the CSI, to establish and maintain a link. In some embodiment, the BS, the UE and/or the RIS have access to partial CSI, for example the UE is only aware of a particular beam that should be used to best communicate with the BS. A measurement of a channel measurement RS, which is sent by either the BS or the UE, can be performed on a per hop basis or an end-to-end basis when determining the CSI. For end-to-end channel measurement, the BS sends the RS to the UE, or the UE sends the RS to the BS, and in each situation the RIS reflects the RS. In some embodiments, the RIS can measure the RS, as well as reflecting the RS to either the UE or BS.

The channel measurement and feedback operation 1630 in some embodiments comprises a setup and trigger operation 1632.

In some embodiments, sensing can be used to trigger a measurement. The RIS link may help the UE when there is an adequate quality channel between the RIS and the UE. This may assume that an adequate quality RIS link to the BS already exists. The measurement process may be suspended if an adequate quality channel is not expected. For example, RF sensing of certain sensing signals or synchronization signals may be used to trigger channel measurement and feedback for the RIS-UE link. Alternatively, non-RF based sensing using a camera or an infrared detector can be used to trigger the measurement. Alternatively, having access to the exact location and/or orientation of the UE and the RIS (based on GPS, a gyroscope, a compass and/or other RF-based, or non-RF based sensing), measurement may only be triggered if the UE is within a certain region and/or certain orientation range of the RIS.

The channel measurement and feedback operation 1630 in some embodiments comprises a channel measurement mechanism 1634.

In some embodiments, the RIS uses multiple different RIS patterns to enable channel measurement of a RIS-UE link. The use of multiple different RIS patterns allows multiple channel measurements to be made in different directions, at least one measurement based on each RIS pattern. For example, the RIS may not know exactly where the UE is located, so the RIS may have RIS patterns that can redirect a signal from the BS in several different directions in the area the UE is expected to be. By determining a channel measurement for each RIS pattern, a best RS measurement result at the UE, that is fed back to the BS, may indicate the proper direction of the UE and thus the proper RIS pattern to use for the RIS-UE link. In some embodiments, the measurement method involves beam sweeping. For a single RIS reflection between the BS and UE in which there are two hops, BS to RIS and RIS to UE, two beams and a reflection pattern are used to perform each channel measurement. A first beam is used at the BS, for either transmitting or receiving a RS, a second beam is used at the UE, for either receiving or transmitting a RS, and the RIS pattern used at the RIS which redirects the impinging beams. When the BS and the RIS are at fixed locations, the BS-RIS link is fixed and can be common for UEs in a certain proximity to the RIS. In such a scenario, beam sweeping can then be used between the UE and the RIS. Performing beam sweeping at the RIS for end-to-end transmission uses transmission of multiple RS from the transmitter (when either the BS or the UE is considered the transmitter depending on DL or UL transmission direction) to the RIS and reflection by the RIS in different directions using different RIS patterns. The receiver (again either the BS or the UE depending on DL or UL transmission direction) then measures the RS and finds a preferred beam-pattern pair between the UE and the RIS. The beam-pattern pair combined with a beam direction at the BS forms an information set that can be referred to as a beam-pattern triplet.

The channel measurement and feedback operation 1630 in some embodiments comprises a reference signal transmission operation 1636.

In some embodiments, when the RIS is capable of receiving or transmitting RS the channel can be measured on a per hop basis. As an example, to measure the channel between the UE and the RIS, the UE sends a reference signal, such as SRS, configured by the network, and the RIS receives and measures the RS. In such a scenario, the RIS may have receive elements that are part of the configurable elements of the RIS and can detect the RS sent by the UE. In some embodiments, the RIS is capable of synchronizing reception at the RIS with the UE transmission by receiving and detecting synchronization signals in terms of SSB or RS. The resulting measurement may be passed to the network to allow the BS to perform RIS pattern optimization, or be kept at the RIS so the RIS can perform RIS pattern optimization.

The channel measurement and feedback operation 1630 in some embodiments comprises a feedback mechanism 1637

The process of measurement and feedback may rely on sensing data to determine when such information is worthwhile gathering. The sensing information may include localization of the UE such as information that indicates where the UE is located in relation to the RIS or the BS, or both.

FIGS. 6A to 6C provide example flow charts for different methods that may be used for RIS-UE link setup described above.

FIG. 6A is a flow chart that illustrates an example of steps that may be involved in setting up a RIS-UE link 600 wherein the setting up is controlled by the network. Step 602 involves the network identifying potential RIS-UE links. This may involve the BS referring to a list of RIS-UE links that were previously identified, for example as in the flow chart of FIGS. 5A to 5G. Step 604 involves the network configuring the RIS with RIS patterns that the RIS can use as part of measuring the channel between the RIS and UE for example to perform channel estimation to determine channel quality. Step 606 involves the network configuring one or more UEs with information relevant to channel measurement, such as the type of RS being used by the network for the measurement, time/frequency resources that are used, the sequence for the RS, and/or the beam direction the RS may be transmitted. Step 608 involves a BS controlled by the network transmitting the RS that is to be reflected by the RIS and used for channel measurement. Step 610 involves the network collecting channel state information (CSI). In some embodiments, this may be CSI measurement information directly fed back by the UE, or reflected by the RIS, or fed back to the RIS from the UE and then the RIS feeds back the information to the network. Step 612 involves the network sharing CSI information with the RIS that can be used by the RIS for RIS pattern control, for example as described above being full control, partial control, or a hybrid. In some embodiments, the BS and the RIS are aware of the existence of the RIS-UE link and the RIS pattern for reflection of the beam to and from the UE. Therefore, the result of performing RIS-UE link setup may be for the RIS being provided a proper RIS pattern for reflection from the BS or generating a proper RIS pattern for reflection based on information provided by the BS. From the UE perspective, configuring the UE to receive a signal that has been reflected by the RIS may be performed with the same mechanism that is used for setting up the direct link between the UE the BS.

In some embodiments, being controlled by the network means the cooperative RIS link is determined by network. This may involve the network notifying the RIS and one or more UEs about a possible connection via RRC, group cast or broadcast messaging. The one or more UEs and RIS can then use their link, under network instruction, to maintain and measure the channel. In some embodiments, the UE is aware of the RIS within the link. In some embodiments, the UE does not know the RIS is in the link and only sends/receives signaling towards a beam direction that has been configured by the network. In some embodiments, the network provides a UE specific beam direction to one or more of the UEs. In some embodiments, the network provides a group specific beam direction based on CSI-RS that may be used by all the UEs that the group specific beam direction is provided to.

FIG. 6B is a flow chart that illustrates an example of steps that may be involved in setting up a RIS-UE link 620 wherein the set up is determined by the network. Step 622 involves the network configuring the RIS with RIS patterns that the RIS can use as part of measuring the channel between the RIS and UE. Step 624 involves the network configuring one or more UEs with information relevant to channel measurement, such as the type of RS being used by the network for the measurement, time/frequency resources that are used, the sequence for the RS, and/or the beam direction the RS may be transmitted. Step 626 involves the UE and the RIS maintaining a link with the network, i.e. the RIS having the proper RIS pattern to reflect a signal from the BS to the RIS and performing channel measurement of the link.

In some embodiments, while being controlled by the network, RIS control is assisted by UE. For example, the UE can send a request to the network for a link to be setup. When setting up a cooperative RIS link, signaling amongst the network, RIS, and UE may use one or more of RRC configuration, group signaling, or broadcast signaling. The network may then send a list of RIS in proximity to the UE. After the UE receives the list of RIS, the UE can identify potential RIS links for communication and sends a request for setting up a link between the UE and one or multiple RIS panels. In some embodiments, the UE request may be provided to the network through reflection by the RIS or sent by the UE to the RIS through a side link and the RIS then relays it to the network.

FIG. 6C is a flow chart that illustrates an example of steps that may be involved in setting up a RIS-UE link 630 wherein the set up is assisted by UE. Step 632 involves the network informing the UE of one or more RIS in proximity to the RIS. Step 634 involves the UE identifying potential RIS-UE links based on the information provided in step 632, i.e. if there is a RIS near the UE, a RIS-UE link may be possible. Step 636 involves the UE sending the BS a request for setting up a link via the RIS, either through RIS reflection or through digital relay by the RIS. The digital relay indicated here refers to low rate control signaling relayed by the RIS using a transceiver that is part of the RIS panel, as opposed to being reflected by configurable elements of the RIS. Step 638 involves the network configuring the RIS for channel measurement with RIS patterns that the RIS can use as part of measuring the channel between the RIS and UE. Step 640 involves the network configuring one or more UEs with information relevant to channel measurement, such as the type of RS being used by the network for the channel measurement and when the RS may be transmitted.

The channel measurement and feedback operation 1630 in some embodiments comprises a sensing assistance operation 1638.

In some embodiments, sensing can improve measurement performance and aid in reducing overhead. In some embodiments, the RIS-UE link has a strong line-of-sight (LOS) component, meaning that the RIS and the UE are substantially in view of each other without significant obstruction. With sensing, the beam direction may be available and have a desired accuracy, which eliminates a need for CSI measurement or can reduce overhead related to CSI measurement. For example, an infrared beam may be used to detect the RIS-UE link and set the beam direction. In some embodiments, sensing information such as orientation and location information of the UE and the RIS, or infrared detection information, a CSI-RS beam sweeping range may be reduced and more targeted toward the direction identified by a sensing mechanism when a more accurate beam direction is desired, as compared to the beam direction achieved by sensing without use of the CSI-RS, or if there is a calibration mismatch between the sensing information and beamforming capabilities of the RIS.

Referring back to FIG. 16, within the scope of the RIS control signaling operation 1640, there are three features shown. The first feature pertains to RIS pattern control 1642. The second feature pertains to RIS assisted measurement operation 1644. The third feature pertains to RIS activation 1646. Example methods related to the RIS control signaling operation 1640, as performed by the base station, by the RIS and by the UE, will be described in detail below.

Embodiments of this disclosure propose reconfigurable and controllable RIS panels where the network is capable of configuring the RIS and hence effectively expanding network antennas in the form of the RIS panel. To enable configuring and controlling of the RIS panels control signaling is exchanged between the BS and the RIS. In some embodiments, the control mechanism and signaling utilize a vendor specific signaling method, i.e. control signaling that is not standardized or required to be used by more than the vendor or those using the vendor’s equipment. In some embodiments, the control signaling utilizes a standardized mechanism to enable deployment of different types of RIS panels that have different levels of capabilities and designs, for example RISs with or without RF transceivers, RIS with or without other RAT radios, RIS that can generate their own RIS patterns and RIS that are manufactured from different types of materials.

The RIS control signaling operation 1640 in some embodiments comprises a RIS pattern control and beamforming operation 1642.

In some embodiments, RIS panels are capable of controlling their own RIS patterns and hence a resulting beam direction, shape and width of a wavefront that is reflected by the RIS. Signaling that may aid in configuring the RIS pattern, or generating the RIS pattern, or both, may use different levels of BS and RIS involvement, for example the BS may generate the RIS pattern and provide that RIS pattern to configure the elements of the RIS panel. In some embodiments, the BS may provide the RIS with channel measurement information and other information used to generate the RIS, and the RIS can generate the RIS pattern to be used by the RIS. In some embodiments, signaling mechanisms are agreed upon during the BS-RIS link setup. In some embodiments, the signaling mechanisms may be based upon how the RIS pattern is controlled. In some embodiments, how the RIS pattern is controlled may be dependent upon the RIS capabilities and can therefore be determined, at least in part, on the RIS reporting the RIS capability to the BS. In some embodiments, the signaling mechanisms are used to determine the UE, BS and RIS behaviors during UE-RIS link discovery, measurement and data reflection periods or control reflection periods, or both.

The RIS control signaling operation 1640 in some embodiments comprises a RIS assisted measurement and feedback operation 1644.

Depending on whether the channel measurement is performed end-to-end or on a per hop basis, the involvement of the RIS, and as a result the control signaling, may be different.

In some embodiments, the RIS performs end-to-end channel measurements. The RIS may have a list of stored RIS patterns that can be used for redirecting a signal impinging on the RIS when performing channel measurement. The list of patterns may be added to the RIS at the time of manufacture, when being deployed in the network, or provided by the network during initial access or periodically updated. Each RIS pattern may be associated with a different reflection pattern and is used at the same time that the corresponding RS is transmitted by a BS or a UE. In some embodiments, the BS may provide the RIS an identification of particular RIS patterns that the RIS stored in memory and the timing associated with performing the measurement. The timing associated with performing the measurement may include scheduling information of when the BS will transmit a RS that the RIS needs to redirect to the UE. In some embodiments, the BS may provide the RIS with RIS patterns that the RIS should configure the elements of the RIS panel and the timing associated with performing the measurement.

In some embodiments, the RIS performs per-hop channel measurements, i.e. RIS-UE channel measurements or BS-RIS channel measurement, when the RIS is configured with the capability to be able to measure a reference signal transmitted by the BS or UE at the RIS. The RIS is notified of channel measurement timing and the sequence of the RS sent towards the RIS. The measurement process may involve beam sweeping at the transmitter side, which means the RIS will measure different instances of RS of the UE transmitting on different beams. Beam sweeping may involve the RIS using different beams to receive the different instances of the RS sent in the RIS direction, i.e. sweeping beams across the range of directions. In some embodiments, the RIS reports results of the channel measurement made by the RIS back to the network, or to the UE, or both. The results of the channel measurement may be used by the UE and BS for determining beam forming information to be used at those devices. The results of the channel measurement may be used for generating RIS patterns to provide a best signal to the UE or BS when redirected by the RIS.

In some embodiments, the RIS performs RIS pilot transmission, which includes the RIS having a transmission capability to be able to transmit a RS, for use in the channel measurement process. The RIS knows the timing and sequence of the RS that the RIS will be transmitting. In some embodiments, the RIS may use beam sweeping when transmitting the RS to provide multiple RS in the direction of the UE. In some embodiments, at the receiving side, the BS or the UE may use beam sweeping to detect the RS signal transmitted by the RIS.

The RIS control signaling operation 1640 in some embodiments comprises a RIS activation operation 1646.

Once the BS-RIS links and the RIS-UE links are step up, the RIS can be used in the BS-UE link to redirect transmission of signals from the BS to the UE or from the UE to the BS. In order to redirect signaling, the RIS is configured with at least scheduling information pertaining to when a signal from a transmitter is being sent to the receiver and which receiver the signal is being sent to, so that the RIS knows which RIS pattern to use to redirect the signal in the correct direction. The RIS, the BS-RIS link and the UE-RIS link may each be activated or deactivated based on instructions from the network. Such instructions may take the form of higher layer signaling or messaging such as downlink control information (DCI) or uplink control information (UCI) or media access control (MAC) control element (CE). Activating and deactivating the RIS can be used for power saving and reduction of signaling overhead.

The activation and deactivation of the RIS, the BS-RIS link and the UE-RIS link can be performed on a dynamic basis, which may be considered a short-term basis. Performing activation or deactivation on a dynamic basis refers to activation or deactivation on a scheduling time interval and is based on short term channel and traffic conditions. As a part of RIS-UE link set-up the potential RIS-UE links are identified. The BS can further determine which RIS-UE links need further channel acquisition, sounding and measurements. This determination may minimize unnecessary measurement efforts for RIS and UE. This can be done based on UE specific RIS selection.

The activation and deactivation of the RIS, the BS-RIS link and the UE-RIS link can be performed on a semi-static basis, which may be considered a long-term basis that is of the duration of multiple TTls (much slower than scheduling decision frequency determined by TTI) and the activation/deactivation decision is made based on the statistical properties of the wireless channel, UE distribution and/or traffic.

Another mechanism pertains to cooperative RIS activation and cooperative RIS deactivation. In some embodiments, cooperative RIS activation/deactivation involves activation and deactivation signaling for the RIS and the UE. In some embodiments, cooperative RIS activation/deactivation involves an individual BS-RIS link or RIS-UE link being activated or deactivated. In some embodiments, cooperative RIS activation/deactivation involves a combined BS-RIS link and RIS-UE link being activated or deactivated. In some embodiments, cooperative RIS activation and cooperative RIS deactivation uses signaling for activating or deactivating an individual BS-RIS link or RIS-UE or a combined BS-RIS and RIS-UE link. In some embodiments, cooperative RIS activation and cooperative RIS deactivation enables being able to turn on and turn off the entire link. In some embodiments, cooperative RIS activation and cooperative RIS deactivation enables being able to add or remove UE specific links. In some embodiments, cooperative RIS activation and cooperative RIS deactivation enable reduction of interference and reduction of power consumption. In some embodiments, using cooperative RIS activation and cooperative RIS deactivation may reduce CSI-RS measurement overhead and feedback overhead.

In some embodiments, decisions regarding when to activate or deactivate a link may depend on factors such as, but not limited to, current channel quality, UE distribution, data traffic, UE data and delay requirements, interference experienced on the link or scheduling decisions.

From the UE perspective, signaling to activate or deactivate a link may involve using a higher layer signaling to activate one or more RIS-UE links. While there might be multiple active links to different RIS panels, an actual reflecting RIS link may be dynamically selected among activated links. Part of the activation mechanism involves performing channel measurement of the RIS-UE link. CSI-RS for only active links is measured and fed back to the BS.

In some embodiments, the BS and the RIS are aware of the existence of the RIS-UE link and the RIS pattern for reflection of the beam to and from the UE. Therefore, the result of performing RIS-UE link setup may be for the RIS being provided a proper RIS pattern for reflection from the BS or generating a proper RIS pattern for reflection based on information provided by the BS. From the UE perspective, configuring the UE to receive a signal that has been reflected by the RIS may be performed with the same mechanism that is used for setting up the direct link between the UE the BS.

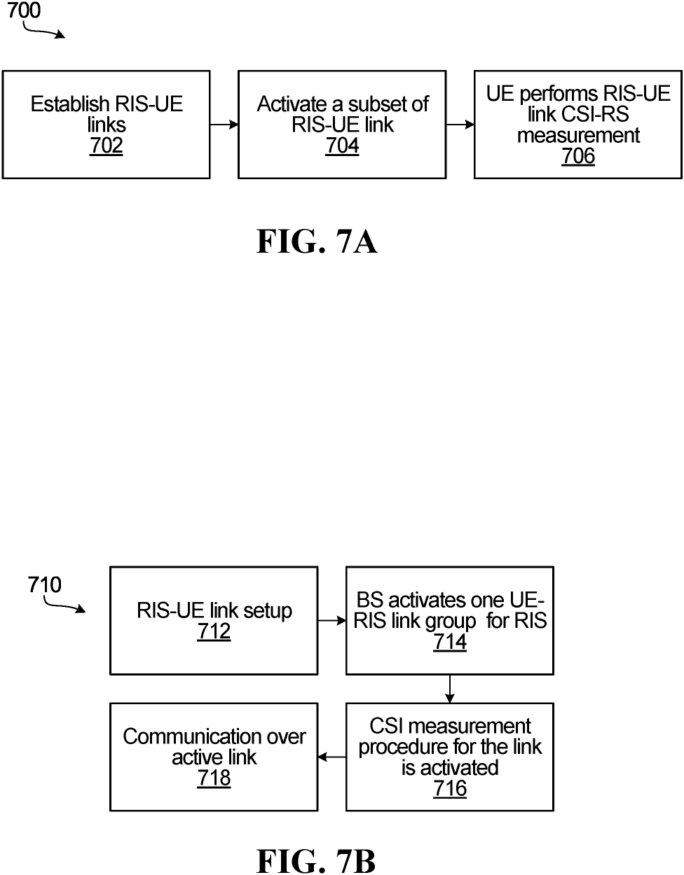

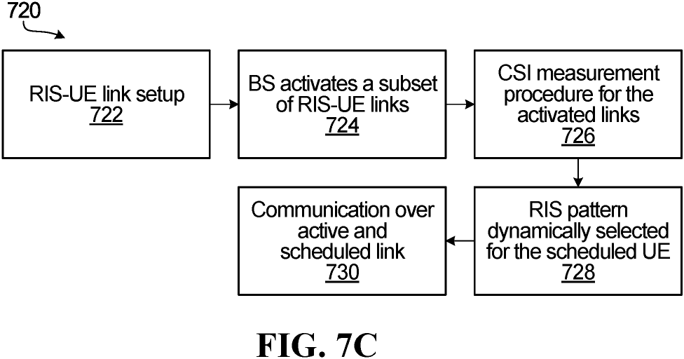

FIG. 7A is a flow chart that illustrates an example of steps that may be involved in setting up and activating a RIS-UE link 700. Step 702 involves establishing one or more RIS-UE links. This may be performed by methods such as those described in FIGS. 5A to 5G. Step 704 involves the BS sending a message to activate a subset of existing RIS-UE links associated with the RIS. Step 706 involves the UE performing CSI measurement for the activated RIS-UE link determining the CSI may be performed for either DL (i.e. using CSI-RS transmitted from the BS) or UL (i.e. using SRS transmitted from the UE) scenarios. This may be performed by methods such as those described in FIGS. 6A to 6C.

The RIS can be a fast RIS or a slow RIS, in terms of how fast the RIS pattern can be updated. Slow RIS panels cannot easily change the RIS pattern in a dynamic manner, i.e. updating the RIS pattern in a fast enough manner compared to the transmission time intervals, and therefore are better for use for a long-term link activation or deactivation. A long-term link is a link that may be maintained for multiple scheduling durations. The slow RIS panels enable a UE-RIS link to only one UE or one group of UEs that have similar beam patterns, i.e. they are generally along a same beam path. In some embodiments, the BS notifies the RIS regarding the active UE-RIS link. In some embodiments, the BS configures the RIS with a RIS pattern to reflect a signal in the direction of the target UE. Fast RIS panels can change the RIS pattern in a dynamic manner, i.e. updating the RIS pattern fast enough to allow the pattern to effectively be received by the desired receiver, and therefore the RIS panels can support multiple active links with UEs that are not collocated or along the same directional path. The RIS may retain CSI and/or RIS patterns for multiple active links. The RIS patterns can then be dynamically changed to reflect a desire signal in the direction of the scheduled UE as instructed by the BS based on its scheduling decision.

FIG. 7B is a flow chart that illustrates an example of steps that may be involved in setting up and activating a RIS-UE link 710. Step 712 involves setting up a RIS-UE link. This may be performed by methods such as those described in FIGS. 5A to 5G Step 714 involves the BS sending a message to activate one RIS-UE link group associated with the RIS. Step 716 involves performing CSI measurement for the activated RIS-UE link. This may be performed by methods such as those described in FIGS. 6A to 6C. Step 718 involves communications occurring over the BS-RIS and RIS-UE links at a scheduled time.

FIG. 7C is a flow chart that illustrates an example of steps that may be involved in setting up and activating a RIS-UE link 720. When the RIS has multiple RIS-UE links that are activated, the RIS can dynamically change the RIS pattern to redirect signaling from a first UE to a second UE based upon receiving the appropriate control signaling from the BS. Step 722 involves setting up a RIS-UE link. This may be performed by methods such as described in FIGS. 5A to 5G. Step 724 involves the BS sending a message to the RIS and/or to the impacted UEs to activate a subset of existing RIS-UE links associated with the RIS. Step 726 involves performing CSI measurement for the activated subset of RIS-UE links. This may be performed by methods such as those described in FIGS. 6A to 6C. Step 728 involves the appropriate RIS pattern being dynamically selected for a scheduled UE. The RIS pattern may be selected by the RIS or the BS. Step 730 involves signaling occurring over the BS-RIS and RIS-UE links for the schedule UE. The RIS pattern can be dynamically selected for a different scheduled UE subsequently.

In some embodiments, when there are no active RIS-UE links for a particular RIS, the RIS may be deactivated to same power or avoid undue interference. In some embodiments, this may result in deactivation of the BS-RIS link as well. Depending on the mechanism and reconfiguration speed used by the RIS panels to perform beamforming and measurement, the RIS may be synchronized with the network at different levels of precision. Synchronization for RS reception by the RS, which is used for example when performing channel measurement, may need more accurate timing as compared to long term beamforming, which is used for example when the RIS is configured for data reflection. Therefore, RIS panels that can be updated fast (meaning the RIS panels are able to reconfigure the RIS pattern at a fraction of a scheduling internal and/or a transmission time interval (TTI)) and that can be accurately synchronized are capable of beam switching and activation at an appropriate scheduling level and for measurement. RIS panels that can be updated more slowly, (meaning the RIS panels are not able to reconfigure RIS patterns on the order of a scheduling time interval), but that can be accurately synchronized, are capable of measurement and long term beam switching and activation. RIS panels that cannot be accurately synchronized are generally capable of long term beam switching and activation.

In some embodiments, the RIS may use an internal transceiver or a global positioning signal (GPS) for over-the-air synchronization. In some embodiments, the RIS may use a clock signal at the backhaul link for maintaining synchronization with the network.

Referring back to FIG. 16, within the scope of the communication operation 1650, there are three features shown. The first feature pertains to physical layer control signaling 1652. The second feature pertains to data communications 1654. The third feature pertains to dual connectivity 1656. Example methods related to the communication operation 1650, as performed by the base station, by the RIS and by the UE, will be described in detail below.

A goal of utilizing RIS is to improve communication throughput and reliability in the network by enhancing the signal-to-interference + noise-ratio (SINR) of the wireless channel, increasing the channel rank or channel diversity, or combinations thereof. The RIS may be utilized to reflect the data signal only or may be utilized to reflect both control and data.

The communication operation 1650 in some embodiments comprises a physical layer control mechanism 1652.

Once the BS-RIS links and the RIS-UE links are step up and the RIS is to be used in the BS-UE link to redirect transmission of signals from the BS to the UE or from the UE to the BS, the UE also needs to be configured for either transmitting to the BS or receiving from the BS. In some embodiments, scheduling information is determined by the BS, for example, by a scheduler in the BS or associated with the BS.

In some embodiments, the scheduling information for the UE is sent by the BS and reflected by the RIS to the UE. In some embodiments, the RIS is used to reflect downlink control signaling from one or more BS to a single UE or to multiple UEs. In some embodiments, the RIS is used to reflect the uplink control signaling from a single UE or from multiple UEs to one or more BS. For RIS panels that are capable of updating their RIS patterns more slowly than a scheduling time interval and TTI, the RIS may only serve UEs within the same general beam direction with data and control signaling. RIS panels that are capable of updating their RIS patterns more frequently, as compared to the TTI, can be used to serve multiple UEs that are located in different directions from one another. In some embodiments, physical layer control signaling and direct link signaling for control signaling is used between the BS and UEs.

In some embodiments, the scheduling information is sent directly by the BS to the UE through other channels, for example at low frequency (LF), an example of which is a microwave band below 6 GHz.

In some embodiments, the scheduling information can be sent to the RIS, which detects the scheduling formation and then the RIS and communicates with the UE by a RIS-UE sidelink. In some embodiments, the RIS may arrange a sidelink communication channel with the UE. The RIS may include a transceiver that allows the RIS to use in-band or out-of-band signaling or using other types of radio access technology (RAT), such as Wi-Fi or Bluetooth.

The communication operation 1650 in some embodiments comprises a data communication operation 1654.

Once the RIS and UE are configured for signaling that uses the RIS to redirect a signal, the link is ready for data signaling to occur on the BS to UE link via the activated RIS panel. In some embodiments, the RIS when properly configured and when capable of support appropriate timing accuracy can reflect the data between the BS and the UE. This is performed by the RIS using a proper RIS pattern and proper beamforming at the TRP or the UE, or both.

In some embodiments, the data may be accompanied by a demodulating RS, such as, for example, a demodulating reference signal (DMRS).

The communication operation 1650 in some embodiments comprises a dual connectivity operation 1656.

In some embodiments, the UE is connected to the BS through multiple links, for example a direct link between the BS and UE or a secondary link reflected by at least one other RIS, or both.

When more than two links are used, synchronization between the signaling on the two or more links can become an important issue. For example, in a DL scenario, the UE can perceive multiple links using different beam direction and timing within a difference of the propagation time of two or more signals. In some embodiments, the propagation time difference can be compensated by the BS. For example, the BS may delay a direct link transmission to arrive at a time close to when a reflect link transmission may arrive at the UE.

A multi-link communication mechanism may include a diversity mechanism such as dynamic beam switching. A diversity scheme is a mechanism to improve the reliability of the communication message whereby more than one communication channels are used. In wireless systems, these channels can be separated by the physical or logical transmit ports (transmit diversity), multiple receiver antennas (receive diversity), or different frequencies. A beam switching diversity may be similar to a dynamic point switching (DPS) transmit diversity scheme.

When there is joint reflection transmission in any of DL, UL and SL, the transmissions may be coherent or non-coherent. When the transmissions are coherent, two or more RISs can reflect signals to positively reinforce one another and to increase SINR. When the transmissions are non-coherent, two or more RISs provide simultaneous links between transmitter and receiver.

In some embodiments, UE behavior may include maintaining beams to multiple RISs and the UE may transmit to, or receive from, or both, the active subset of RISs.

In some embodiments, the activation signaling or deactivation is UE specific such that individual RIS-UE links of a set of RIS-UE links can be activated or deactivated. In some embodiments, the activation signaling or deactivation is broadcast such that all UE-RIS links involving one RIS panel can be activated or deactivated. Broadcast signaling can be particularly useful when RIS is to be activated or deactivated.

Embodiments of another mechanism pertain to cooperative RIS based data transmission are provided. In some embodiments, cooperative RIS based data transmission involves dynamic RIS selection for higher capability functions than just activation and deactivation. In some embodiments, cooperative RIS based data transmission involves non-coherent multi-beam communication using different streams from different links. In some embodiments, cooperative RIS based data transmission involves coherent multi-beam communication with signals on different paths, one or more which include a RIS to reflect a signal from BS to UE, the signal on the multiple beams adding constructively over-the-air at the UE. However, coherent multi-beam communication needs highly accurate CSI knowledge to ensure the resulting coherence. In some embodiments, cooperative RIS based data transmission involves interference avoidance and MU-MIMO.

Part of cooperative RIS based data transmission involves being able to select a RIS and a resource of when the RIS may be used. In some embodiments, selecting an RIS involves providing configuration information that includes information for the RIS such as a UE that will be communicated with, a RIS pattern that the RIS will use to reflect a signal to the UE, beam direction information that indicates a beam that the RIS may use to reflect to the UE, which may allow the RIS to use an appropriate RIS pattern.

In some embodiments, the configuration information may be signaled in DCI. In some embodiments, the beam direction information can be provided implicitly, for example in the form of quasi-colocation (QCL) information. In some embodiments, the beam direction information can be provided explicitly, for example by providing an RIS index that identifies a particular beam to use. By being provided the beam direction information, the RIS does not need to perform measurements to determine an appropriate beam direction, which can reduce the signaling overhead. In some embodiments, signaling between one or more BS and one or more UEs that uses at least two RIS can result in 1) non-coherent multi-beam communication such that signals arriving at a receiver from multiple directions do not add coherently, or 2) coherent multi-beam communication such that signals arriving at a receiver from multiple directions add coherently.

Some examples of non-coherent multi-beam communication include, but are not limited to: block code diversity that involves using a block code on different links, such as Alamouti-code; a multi-layer communication with dual connectivity; the use of single DCI for configuring multiple links in one DCI message or multiple separate DCI messages for configuring multiple links; and RIS assisted UCNC. Examples of these types of signaling will be described below with reference to signal flow diagrams.

In some embodiments, the signaling for cooperative RIS communication may use RRC messages for configuration and DCI signaling for configuring layer settings.

In some embodiments of non-coherent multi-beam communication, the receiver, whether that is the BS or the UE, may have multiple RF chains for multi-link signal reception. The transmitter, for DL, may have multiple RF chains/panels at BS or multiple BSs. The transmitter, for UL SU-MIMO, may have multi-panels at the UE.

The transmitter, for UL UE cooperation, may have multiple UEs cooperating to send the signal to the network. A benefit of a multi-RIS, or cooperative RIS communication, deployment is that it allows for better intra-BS (e.g. MU-MIMO) and inter-BS interference avoidance. Interference avoidance can occur when beam directions or beamformers are used to reduce the mutual interference between links for scenarios of massive MIMO BS-RIS links at both LF and HF.

Detailed examples of various embodiments are provided below, including signal flow diagrams for some of the embodiments.

The present disclosure provides some embodiments of Multi-RIS diversity. When multiple RIS panels are used to form links from one BS to one UE, for example as shown in the case in FIG. 4A with BS 420 using RIS 420 to form link (via 440a and 440b) with UE 430 and RIS 425 to form a link (via 445a and 445b) with UE 430 to provide multiple RIS panel diversity, the selection of the panel has to be made as part of the link set up.

The panel selection of multi-panel diversity may be made on a dynamic basis or a semi-static basis. Making the selection on a dynamic basis means a panel is selected on a per scheduling time (e.g. TTI) basis. In addition to selecting the panel on a dynamic basis, the RIS may need to be provided with RIS pattern information for the link to the UE and the UE may need to be provided configuration to know when the signal from the BS is schedule to be transmitted and information about which RIS is redirecting the signal so the UE knows which direction to receive the signal. Making the selection on a semi-static basis means a panel is selected that will serve the UE for a longer duration than a single scheduling time period.

In some embodiments, the signaling to one or more of the selected panels may involve deactivating the RIS or the RIS-UE link, on a dynamic or semi-static basis, for example to control interference or reduce power usage, when not needed.

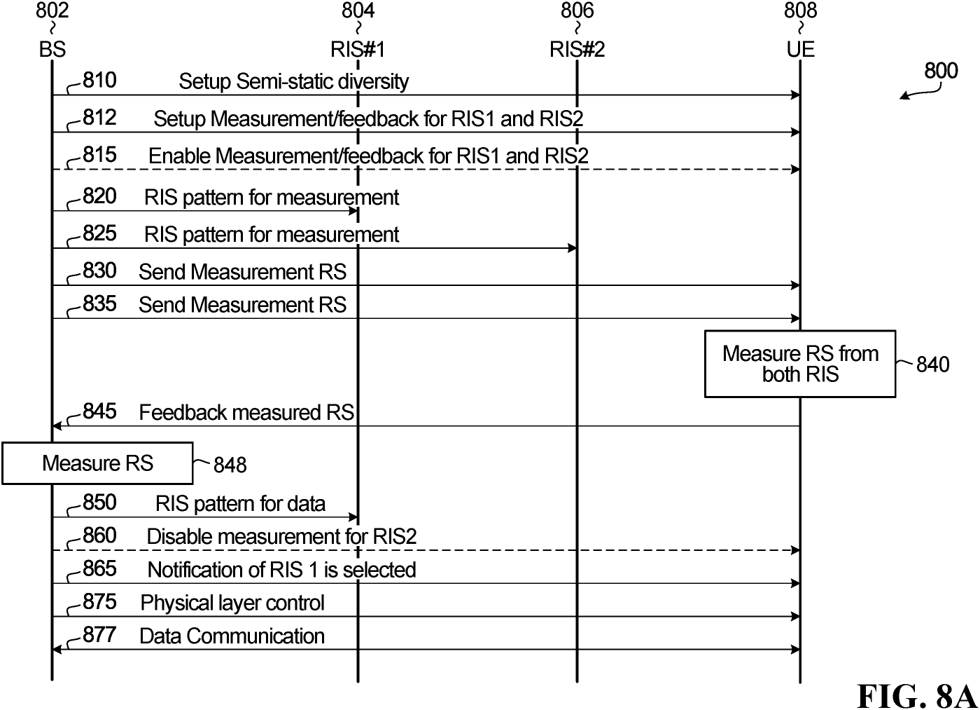

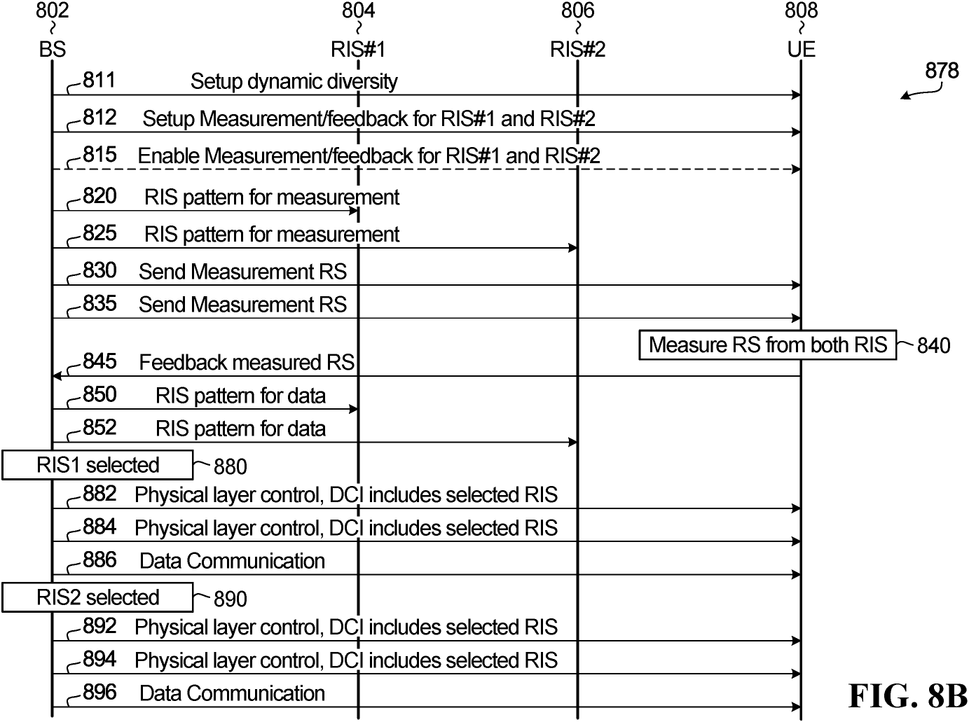

The signaling may include various configuration information relevant to configuring the RIS and the UE. For example, in some embodiments, the BS may send information about the RIS panels to the UEs so the UE may know which RIS panels it may be receiving redirected signal from. In some embodiments, the BS may send the UE channel measurement parameters such as for CSI-RS that may be transmitted by the BS and/or SRS that may be transmitted by the UE. In some embodiments, the BS may send the UE configuration information pertaining to how the UE should feedback CSI-RS information to the US. In some embodiments, the BS may send configuration information to the RIS panel such as RIS pattern control information. This RIS pattern control information may be explicit, which defines the RIS pattern for the RIS, or implicit that some information is provided to the RIS panel, such as UE location information and/or CSI information that allows the RIS to determine the RIS pattern on its own or the beam pattern and direction, or in relation to a previously used pattern for data or RS, or a modification of a previously used pattern or a combination of two or more previously used or previously identified patterns. In some embodiments, the BS may send a RIS panel activation message to the RIS panel. The RIS panel activation message may include scheduling information to indicate when the RIS panel is to be activated and an indication of the RIS panel to use of the UE is redirecting to, so that the RIS panel can determine the RIS pattern it needs to use. Examples of these various types of signaling will be shown in FIGS. 8A and 8B.

In some embodiments, the BS may send a notification to the UE of the selected RIS panel that will be used to redirect a signal to the UE. The notification to the UE may be a DCI message for dynamic configuration and an RRC message for semi-static configuration. In some embodiments, when the UE is aware of the RIS, the selected RIS is explicitly signaled to the UE. In some embodiments, when the UE may not be aware of the RIS, the UE is implicitly notified of the signal direction using beam direction signaling (for example QCL).

In some embodiments, the BS may send messages to the UE to enable or disable, as appropriate, the UE for channel measurement of the RIS panel when arranging semi-static diversity transmission.

In some embodiments, the RIS may have a direct link to the network. This direct link may be in band or out of band. The direct link may be through a designated RIS link that can be used for any RIS. In some embodiments, the RIS can use a wide beam for wider coverage to have the direct link with multiple UEs.

In some embodiments, for semi-static panel selection, the physical downlink control channel (PDCCH) can be redirected by the same panel as the data. An example of this will be shown in FIG. 8A and described below.

In some embodiments, for dynamic panel selection, one or more RIS that have been setup to be able to redirect to the UE can reflect the PDCCH to the UE. An example of this will be shown in FIG. 8B and described below.

FIG. 8A is a signal flow diagram 800 of a semi-static diversity that shows an example signaling diagram for signaling between a BS 802, a first RIS (RIS#1) 804, a second RIS (RIS#2) 806 and a UE 808 where the two RIS 804 and 806 are controlled by the BS 802 for diversity that is setup on a semi-static basis. The signal flow diagram 800 incorporates many of the above discussed embodiments. The signal flow diagram 800 shows signaling that occurs subsequent to RIS discovery and BS-RIS links being identified and set up.

Signaling lines 810, 811, 812, 815, 860 and 865 indicate higher layer configuration information sent from BS 802 to the UE 808 that may be sent by a direct link, not reflected by RIS or reflected through a RIS.

Signaling lines 820, 825, 850 and 852 indicate signaling commands from the BS 802 to the two RISs 804 and 806. These commands can be transmitted over the air or through a wired connection. If they occur over the air then the RISs 804 and 806 are assumed to have a transceiver or sensor for receiving from the BS 802 and reflecting on the configurable elements for transmitting to the BS 802. In some embodiments, the commands may use a standardized mechanism designed for RIS control. In some embodiments, the commands may use new or existing mechanisms such as backhaul, RRC or Xn.

Signaling lines 830, 875, 877, 882, 886 and 892 show the signals that are reflected by RIS#1 804 from the BS 802 to the UE 808 or from the UE 808 to the BS 802.

Signaling lines 835, 884, 894 and 896 show the signals that are reflected by RIS#2 806 from the BS 802 to the UE 808. The signaling lines show RRC messaging from the BS 802 to the UE 808 to provide the UE 808 with configuration information. This may be a direct link between the devices, as shown in FIGS. 8A or 8B, or reflected by the RISs 804 and 806, which is not shown in FIGS. 8A or 8B. In some embodiments, the RRC messaging uses the same path as data communication configuration for a duration of time that the data communication is performed. In some embodiments, the RRC messaging uses a separate link in the same frequency band. In some embodiments, the RRC messaging uses a separate link in a different frequency band.

Signaling line 845 shows feedback information that is direct link uplink physical layer control signaling that is not reflected by the RISs 804 and 806. However, in some embodiments, the uplink physical layer control signaling could be reflected by the RIS 804 and 806.

Signaling 810, 812, 815, 820, 825, 830 and 835 in combination are an optional functionality that corresponds to RIS-UE link identification and setting up the RIS-assisted connections.

The BS 802 sends a notification message 810 to the UE 808 so that the UE 808 knows that there is going to be semi-static diversity being used.

The BS 802 sends a configuration information message 812 to the UE 808 to provide the UE 808 with information to configure the UE 808 to receive a RS for channel measurement enable feedback to the BS 802. This configuration information message may include configuration information about the RS sequence, time frequency resources, beam direction and/or which RIS could be redirecting the RS sent by the BS such as directionality information about the RIS so that the UE, when provided scheduling information that the RS will be sent, will know he directionality of the RS. From the UE perspective, the RIS reflection may be transparent and the UE may only know the direction of the UE-RIS link beams. The message 812 may include only the measurement and feedback setup. However, optionally, the measurement and feedback mechanism may still not start until activated. Message 812 to setup measurement for multiple RIS panels may use separate messages and they do not necessarily happen at the same time.

The BS 802 sends a notification message 815 to the UE 808 so that the UE 808 is made aware that the BS will be sending the RS to be redirected by the RISs 804 and 806. This notification message may include enabling the measurement and feedback if not already enabled and may be accompanied by some other details about the scheduling information about when and a transmission resource that will be used when the RS is sent. Effectively, before enabling the measurement and feedback, the links are not active. In some embodiments, activating a link may use a different signaling not shown in FIGS. 8A or 8B. The activation may be based on some triggering event such as detection through sensing not shown in FIGS. 8A or 8B. The message 815 may be reflected by one or both of the RISs 804 and 806 or may be sent directly to the UE 808.

In some embodiments, messages 812 and 815 may only be sent to the UE 808 if the UE 808 is going to be made aware of the one or both of the RISs 804 and 806.

Messages 820 and 825 are used by the BS 802 to further aid the UE 808 in identifying the RISs 804 and 806. Message 820 is sent by the BS 802 to RIS#1 804 that provides RIS pattern information to RIS#1 804 to be able to reflect to the UE 808. Message 825 is sent by the BS 802 to RIS#2 806 that provides RIS pattern information to RIS#2 806 to be able to reflect to the UE 808. These messages may be information specific to the one or both of the RISs 804 and 806 to set the pattern without having to generate the pattern or it may be general information that identifies location information for the UE 808 to allow one or both of the RISs 804 and 806 to generate the RIS pattern themselves. While messages 820 and 825 are shown as separate messages, it should be understood that these two messages can be combined into one signaling set.

Message 830 is sent by the BS 802 to the UE 808, which is reflected by RIS#1 804 that is using a RIS pattern based on the pattern information provided by the BS 802 in message 820. Message 835 is sent by the BS 802 to the UE 808, which is reflected by RIS#2 806 that is using a RIS pattern based on the pattern information provided by the BS in message 825. At the 840, the UE 808 measures RS redirected from each of the RIS 804 and 806.

Message 845 is a report from the UE 808 for the BS 802 to acknowledge that the UE 808 has detected one or both of the RISs 804 and 806. While two RISs 804 and 806 are shown, it is to be understood that there could be more than two RIS being discovered by the UE 808 and reported back to the BS 802.

In some embodiments, one or both of the RISs 804 and 806 can detect the UE 808 and can establish a link to the UE 808. In some embodiments, one or both of the RISs 804 and 806 can detect the UE 808 as a result of the report 845. In some embodiments, one or both of the RISs 804 and 806 can detect the UE 808 as a result of detecting other UE signals such as the physical random access channel (PRACH) or UL data or control signaling. In some embodiments, one or both of the RIS 804 and 806 can detect the UE 808 using a sensing mechanism.

At 848, the BS 802 selected RIS#1 804 as the RIS panel that will be used to redirect signals to the UE 808 for a scheduled duration. The decision may be based on any factor such as channel condition, UE requirements, scheduling decision, and UE distribution.

Signaling 850, 860, and 865 in combination are a functionality that corresponds to measurement and feedback setup for RIS #1 804 and disabling measurement for RIS#2 806. Message 850 is sent by the BS 802 to RIS#1 804 that includes configuration information regarding one or more RIS patterns to be used by RIS#1 804 to reflect reference signals. In some embodiments, this information is specific to RIS#1 804 to set the pattern without RIS#1 804 having to generate the RIS pattern. In some embodiments, the information provided allows the RIS#1 804 to generate the RIS pattern. Message 860, indicated as an optional step by the dashed line, is sent by the BS 802 to the UE 808 that provides a notification that no channel measurement will be performed for the RIS#2 806 to UE 808 link. This message effectively deactivates the UE-RIS link to RIS#2 806 until the UE-RIS link is reactivated. In some embodiments, the message may not be sent, and if it is not, the UE 808 may assume that only channel measurements will be made for RIS-UE links that scheduling information is received for, as in message 865. Message 865 is sent by the BS 802 to the UE 808 that provides measurement and feedback configuration information to be used by the UE 808 to perform the channel measurement from a RS redirected by RIS#1 804. This message may include information that enables the UE to know what type of RS may be received and when, that the RS is associate with which RIS, in this case RS#1 804, the RS sequence, RS time/frequency patterns, RS timing and corresponding port and beam direction, such as quasi-colocation (QCL) information.

Additional channel measurements could be performed as desired for activated RIS#1 804, but not for deactivated RIS#2 806.

In some embodiments, the channel measurement may be performed by RIS#1 804 sending a RS for the UE 808 to measure and the UE 808 feeds back measurement information to RS#1 804. In such a case, the CSI is available at RIS#1 804 and RIS#1 804 can forward the measured CSI to the BS 802.

Messages 875 and 877 in combination are a functionality that corresponds to activate the RIS-assisted connection and UE configuration. Message 875 is sent by the BS 802 to the UE 808 that includes physical layer control information. Message 875 may be reflected by RIS#1 804 using a RIS pattern based on the pattern information provided by the BS in message 850 or it may be a direct link between the BS 802 and the UE 808. Data 877 is data that occurs between the UE 808 and the BS 802 in either UL or DL directions that is reflected off RIS#1 804. The measurement, control signaling, and data communication steps in messages 867, 868, 875 and 877 will continue as long as the link between UE 808 and RIS#1 804 remains active. Later, link 808 to RIS#1 8-4 may be deactivated and the link to RIS#2 806 activated based on a triggering event such as channel condition change, sensing information, traffic change, or a scheduling decision. The ensuing messages to activate and deactivate a given link, measurement and feedback, control and data communication through RIS#2 are not shown in FIG. 8A. Alternatively, the UE may be switched to be served by the BS 802, or another BS not shown in FIG. 8A.

The steps shown in FIG. 8A allow the RIS-UE links to be detected, setup, activated and data sent over the RIS assisted connection. While the flow signaling diagram 800 shows a complete series of steps that may be used for the RIS-UE link to be detected, setup, and activated, data sent over the RIS assisted connection and the RIS assisted connection to be disconnected, it should be understood that individual steps, or combinations of steps, may be considered independently from the entire method.

FIG. 8B is a signal flow diagram 878 of the dynamic diversity that shows an example signaling diagram for signaling between BS 802, RIS#1 804, RIS#2 806 and UE 808 where the two RIS 804 and 806 are controlled by the BS 802 for diversity that is setup on a semi-static basis. The signal flow diagram 800 incorporates many of the above discussed framework functionalities. The signal flow diagram 878 shows signaling that occurs subsequent to RIS discovery and BS-RIS links being identified and set up.

The BS 802 sends a notification message 811 to the UE 808 so that the UE 808 knows that there is going to be a dynamic diversity being used.

The signaling 812, 815, 820, 825, 830, 835, and 845 and the UE 808 measuring 840 the RS from both RIS 804 and 806 in FIG. 8B is substantially the same as the signaling in 812, 815, 820, 825, 830, 835, and 845 the UE 808 measuring 840 the RS from both RIS in FIG. 8A.

After the BS 802 receives the feedback information in message 845, the BS 802 sends message 850 to RIS#1 804 that includes configuration information regarding one or more RIS patterns to be used by the RIS to reflect reference signals. Message 850 is sent by the BS 802 to RIS#1 804 that provides pattern information to RIS#1 804 to be able to reflect to the UE 808. This information may be general information that identifies location information for the UE 808 and CSI information to allow the RIS to generate the RIS pattern itself. The pattern information can be in part derived based on the measurement report 850 received from the UE 808. The BS 802 also sends message 852 to RIS#2 806 that includes configuration information regarding one or more RIS patterns to be used by RIS#2 806 to reflect reference signals. In some embodiments, these message include information that is specific to RIS#2 806 to set the pattern without RIS#2 806 having to generate the pattern. In some embodiments, the information provided allows RIS#2 806 to generate the pattern. While messages 850 and 852 are shown as separate messages, it should be understood that these two messages can be combined into one signaling set.

One or more RIS can be selected per scheduling decision and included in DCI message as described below. In FIG. 8B, RIS#1 804 is selected as a first scheduling decision and RIS#2 806 is selected as a second subsequent scheduling decision. However, it should be understood that more than one RIS could be select in a respective scheduling decision.

At step 880 the BS 802 selects RIS#1 804 to be used to redirect data to the UE 808. The BS 802 may also send a message (not shown) to each of the RIS 802 and 804 confirming this, that also notifies the RIS pattern information for the respective RISs to enable both RISs to be able to redirect physical layer control information to the UE 808.

In FIG. 8B the physical layer control channel is reflected by RIS#1 804 and RIS#2 806.

Message 882 is sent by the BS 802 to the UE 808 that includes physical layer control information for the UE 808. Message 882 is reflected by the first RIS 804 using a RIS pattern generated by RIS#1 804 based in part on message 850. Message 884 is sent by the BS 802 to the UE 808 that includes physical layer control information for the UE 808. Message 884 is reflected by RIS#2 806 using a RIS pattern generated by RIS#2 806 based in part on message 852.

Data 886 is a data transmission that occurs between the BS 802 and the UE 808 in either UL or DL directions that is reflected off RIS#2 804.

At a subsequent point in time, at step 890 the BS 802 selects RIS#2 806 to be used to redirect data to the UE 808. The BS 802 may send a message (not shown) to each of the RIS 802 and 804 confirming this, that also notifies the RIS pattern information for the respective RISs to enable both RISs to be able to redirect physical layer control information to the UE 808.

Message 892 is sent by the BS 802 to the UE 808 that includes physical layer control information for the UE. Message 892 is reflected by RIS#1 804 using a RIS pattern generated by RIS#1 804 based in part on message 850. Message 894 is sent by the BS 802 to the UE 808 that includes physical layer control information for the UE. Message 894 is reflected by RIS#2 806 using a RIS pattern generated by RIS#2 806 based in part on message 852.

Data 896 is a data transmission that occurs between the BS 802 and the UE 808 in either UL or DL directions that is reflected off RIS#2 806.

In some embodiments, channel measurements may be performed by either of RIS#1 804 or RIS#2 806 sending a RS for the UE 808 to measure and then the UE 808 feeds back measurement information to the respective RISs. In such a case, the CSI is available at the respective RISs and the respective RISs can forward the measured CSI to the BS 802.

The examples of FIGS. 8A and 8B allow for the utilization of more advanced RIS panels which can share some computation burden and reduce BS-RIS command overhead.

While FIGS. 8A and 8B illustrate setting up multiple RIS-assisted links between a BS and a UE using two RIS, it should be understood that multiple BSs could have multiple RIS-assisted links with one or multiple UEs via one or multiple RIS. Furthermore, the concepts described in this document could be extended to the concept of setting up an RIS-assisted link between multiple UEs using a SL connection.

FIGS. 8A and 8B show channel measurement in a downlink direction, however the channel measurement could be performed in an uplink direction by the UE being configured by the BS to send a reference signal, such as a SRS, to the BS via the RIS.

While the examples of FIGS. 8A and 8B are performed where the UE knows the RISs are part of the link, in other embodiments, the UE may not know that RIS is reflecting the signal and the RIS selection notification is QCL based, meaning that the UE is provided information about the direction the signal may be coming from in order to be able to detect the signal without having to know the RIS is being used.

While FIGS. 8A and 8B show separate dynamic and semi-static scheduling, it should be understood that these methods may be used simultaneously for activating different RIS being served by the same BS.

In some embodiments, FIGS. 8A and 8B may be considered to show a method in which a UE receives first configuration information that includes identification of a plurality of beams for transmitting or receiving signals, in which each beam has an associated direction. This may be configuration information in steps 812 and 815 in FIGS. 8A and 8B. The method may also include the UE receiving second configuration information, which includes a message to enable a selected subset of beams of the plurality of beams from the set of beams for transmitting or receiving signals. Basically, these two steps involve the UE being configured with multiple beams that the UE could possibly receive a signal on, and then receiving configuration information that defines a subset of one more of the multiple beans that the UE is scheduled to receive a signal on. An example of this second configuration information may be configuration in steps 882, 884, 892 and 894 in FIG. 8B. While steps 882 and 884 provide configuration that only RIS#1 is being used for a first scheduling interval and steps 892 and 894 provide configuration that only RIS#1 is being used for a second scheduling interval, it is to be understood that more generally, the configuration information could include physical layer information for the UE that would enable receipt of multiple signals from respective RIS.

In some embodiments, a signal that is transmitted or received on a beam of the selected subset of beams is transmitted or received via one RIS. In some embodiments, each one of a plurality of signals that are transmitted or received by the UE on each of a corresponding beam of the selected subset of beams is reflected of a respective RIS. In some embodiments, in addition to transmitting or receiving one or more signals respective beams of the selected subset of beams that are reflected by RIS, the UE may have a link with the BS over a direct link that is one of the selected subsets of beams. In some embodiments, the second configuration information includes identification of beam direction information and the time/frequency resource information of a signal on at least one beam of the selected subset of beams. The UE may receive data and control information within the time/frequency resources of the at least one beam of the selected subset of beams.

The present disclose also provides some embodiments, of more than one RIS participate in communication of a same data stream. In these embodiments, time and/or frequency diversity can be implemented by using more than one RIS panel for redirecting communication signals of a single data stream. The signal reflected by each RIS panel that is utilized can be considered a different representation of the same data stream.

The use of multiple RIS panels can be used for UL, DL and SL communications. A transmitter, whether that is the BS or a UE, should be able to transmit different streams simultaneously to more than one RIS. The receiver, whether that is the BS or a UE, should be able to receive and detect beams from different directions simultaneously.

Different transmission schemes may be used by the transmitted when transmitting communication signals.

In some embodiments, the same stream is transmitted in the directions of the various RIS panels that may be used and after being reflected by the RIS panels, the signals superpose over-the-air upon arriving at the receiver.

In some embodiments, a delay may be used to generate an “emulated” frequency diversity at the receiver. Delay diversity and its orthogonal frequency division multiplexing (OFDM) version, called cyclic delay diversity, use multiple paths from the transmitter to the receiver and by intentionally applying delay into some paths, the overall channel at the receiver looks like a multi-path channel, which offers frequency diversity into the communication system.

In some embodiments, diversity block codes can be used when transmitting the signal to the various RIS panels. Example of diversity block codes that could be used include space time transmit diversity (STTD) block codes such as Alamouti code. Space time block codes (and their OFDM counter parts, space frequency block codes) provide transmit diversity using multiple antennas at the transmitter each transmit a different versions of the data symbol stream. Here, each version of the data stream is reflected via a different RIS panel, thus providing different copies of data at the receiver.

In some embodiments, incremental redundancy can be used in which different redundancy versions of the data stream is sent to the receiver. Similar to the space time codes, incremental redundancy utilizes different versions of data to be sent to the receiver through different paths. However, unlike space time codes where different versions of the same modulation streams is used, incremental redundancy uses different data symbol streams created from different subsets of the coded bits of the same transport block produced by a forward error correcting (FEC) code.

In some embodiments, RIS panels may be deactivated to control interference of signals when the RIS is not being used.

The signaling used when implementing time and/or frequency diversity may include various configuration information relevant to configuring the RIS and the UE. For example, in some embodiments, the BS sends information about the RIS panels to the UEs so the UE will know which RIS it may be receiving redirected signal from. In some embodiments, the BS may send the UE channel measurement parameters such as for CSI-RS that may be transmitted by the BS and/or SRS that may be transmitted by the UE. In some embodiments, the BS may send the UE configuration information pertaining to how the UE should feedback CSI-RS information to the US. In some embodiments, the BS may send configuration information to the RIS such as RIS pattern control information. This RIS pattern control information may be explicit, which defines the RIS pattern for the RIS, or implicit that some information is provided to the RIS, such as UE location information and/or CSI information that allows the RIS to determine the RIS pattern on its own or the beam pattern and direction, or in relation to a previously used pattern for data or RS, or a modification of a previously used pattern or a combination of two or more previously used or previously identified patterns. In some embodiments, the BS may send a RIS panel activation message to the RIS. The RIS panel activation message may include scheduling information to indicate when the RIS panel is to be activated and an indication of the RIS panel to use of the UE is redirecting to, so that the RIS can determine the RIS pattern it needs to use.

In some embodiments, the RIS may have a direct link to the network. This direct link may be in band or out of band. The direct link may be a designated RIS link that can be used for any RIS. In some embodiments, the RIS can use a wide beam for wider coverage to have the direct link with multiple UEs.

In some embodiments, the diversity method used on the direct link can be the same diversity type as used for the data communication.

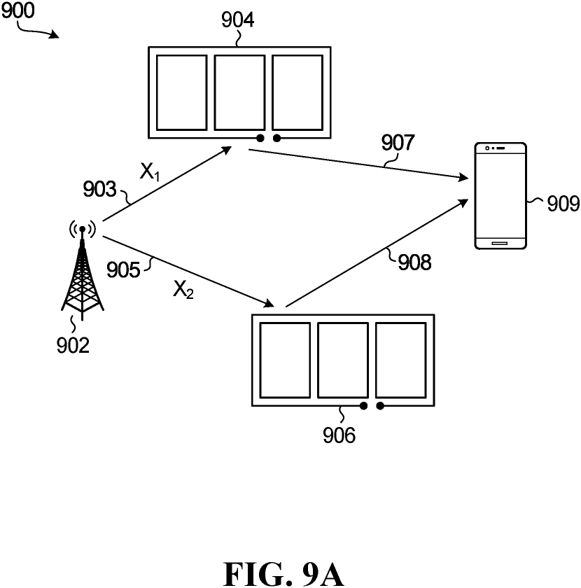

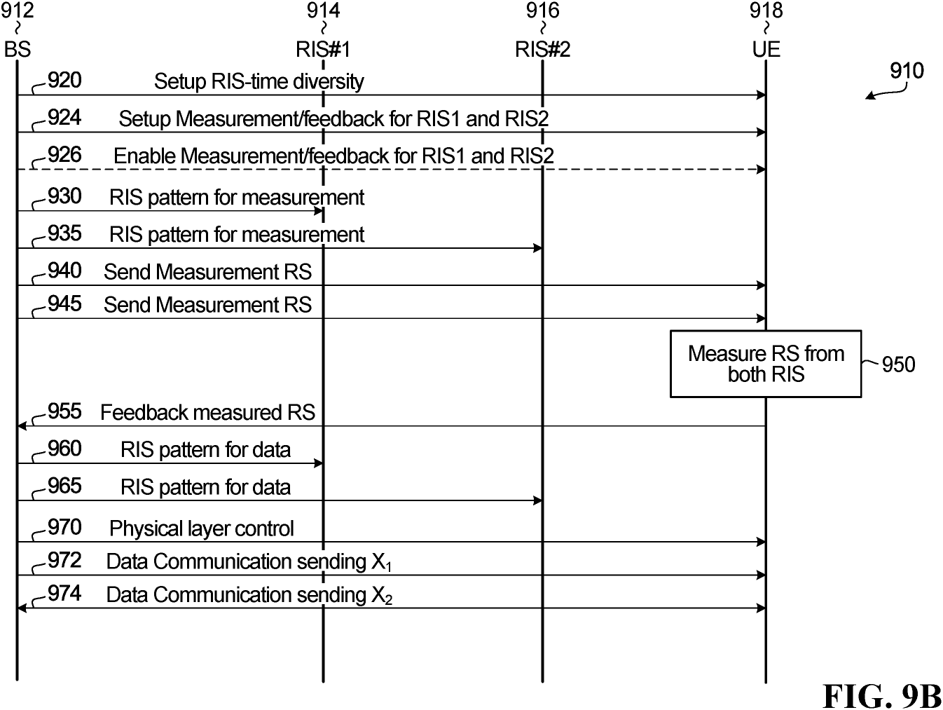

An example of time and/or frequency diversity will be described referring to FIG. 9A. FIG. 9A shows an example of a portion of a communications network 900 that includes a base station (BS) 902, two RIS (RIS#1 904 and RIS#2 906) and one user equipment (UE) 909. Each of RIS#1 904 and RIS#2 906 are capable of operating as an extension of antennas of the BS 902 for the purposes of transmission or reception, or both. The RISs are capable of reflecting and focusing a transmission wavefront propagating between the BS 902 and the UE 909. A first radio frequency RF link 903 is shown between RIS#1 904 and the BS 902 is used to transmit a signal component X₁. A second RF link 905 is shown between RIS#2 906 and BS 902 is used to transmit a signal component X₂. The BS and the RIS can communicate in band, out of band or through a wired connection when communicating information about the RIS pattern that the RIS should use to reflect information, as well as other configuration information or control information, or both, that may need to be communicated between the RIS and BS.

A third RF link 907 is shown between RIS#1 904 and UE 909. A fourth RF link 908 is shown between RIS#2 906 and the UE 909. The RISs and the UE can communicate in band, out of band or using other RAT that is available to the devices when communicating information about the RIS pattern that the RIS should use to reflect information, as well as other configuration information or control information, or both, that may need to be communicated between the RIS and UE.

In FIG. 9A, only DL communication between the BS 902 and UE 909 is illustrated, but it is to be understood that UL between the BS 902 and the UE 909 would be similar, but in the opposite direction. Using this type of diversity for sidelink is also considered to be within the scope of the proposed methods.

At the BS 902, a zero forcing (ZF) function, or other technique, can be used to separate the signal into the X₁ and X₂ signal components transmitted to RIS#1 904 and RIS#2 906, respectively. When the signal is separated into the two signal components, the CSI should be determined for each of the two BS-RIS links.

In some embodiments, the data X₁ sent on the first radio frequency RF link 903 and the data X₂ sent on the second RF link 905 are equal to one another.

In some embodiments, when there is a delay between the signals, the delay can be compensated for, for example X₂(t)=X₁(t-Δt mode T), where Δt is the intentionally applied delay between the two signals.

In some embodiments, when an Alamouti diversity block code is used, the two signals may be represented as X₁ = [a₁ a₂] and X₂=[-a₂* a₁*], where a₁ and a₂ are two modulated symbols, for example QAM symbols, of a data stream and * denotes a complex conjugate function. X₁ and X₂ are the vectors of a transmit signal over two channel time/frequency resources each reflected by one RIS panel. In some embodiments, X₁ and X₂ signals are generated from different subsets of the FEC coded data from the same transport block to make incremental redundancy diversity.

FIG. 9B is a signal flow diagram 910 that shows an example signaling diagram for signaling between a BS 912, a first RIS (RIS#1) 914, a second RIS (RIS#2) 916 and a UE 918, where the two RIS 914 and 916 are controlled by the BS 912 for a time diversity implementation. The signal flow diagram 910 shows signaling that occurs subsequent to RIS discovery and BS-RIS links being identified and set up.

Signaling lines 920, 924, and 926 indicate higher layer configuration information sent from BS 912 to the UE 918 that may be sent be direct link, not reflected by the RISs. The signaling lines show RRC messaging from the BS 9122 to the UE 918 to provide the UE 918 with configuration information. This may be a direct link between the devices, as shown in FIG. 9B, or reflected by the RISs 914 and 916, which is not shown in FIG. 9B. In some embodiments, the RRC messaging uses the same path as data communication configuration for a duration of time that the data communication is performed. In some embodiments, the RRC messaging uses a separate link in the same frequency band. In some embodiments, the RRC messaging uses a separate link in a different frequency band.

Signaling lines 930, 935, 960 and 965 indicate signaling commands from the BS 912 to the two RISs 914 and 916. These commands can be transmitted over the air or through a wired connection. If they occur over the air then the RISs 914 and 916 are assumed to have a transceiver or sensor for receiving from the BS 912 and reflecting on the configurable elements for transmitting to the BS 912. In some embodiments, the commands may use a standardized mechanism designed for RIS control. In some embodiments, the commands may use new or existing mechanisms such as backhaul, RRC or Xn.

Signaling lines 940, 970 and 972 show the signals that are reflected by RIS#1 914 from the BS 912 to the UE 918 or from the UE 918 to the BS 912.

Signaling lines 945 and 974 show the signals that are reflected by RIS#2 916 from the BS 912 to the UE 918 or from the UE 918 to the BS 912.

Signaling line 955 shows feedback information that is uplink physical layer control signaling not reflected by the RISs 914 and 916. However, in some embodiments, the uplink physical layer control signaling could be reflected by one or both of the RIS 914 and 916.

The BS 912 sends a notification message 920 to the UE 918 so that UE 918 knows that there is going to be a time diversity implementation being used.

The signaling 924, 926, 930, 935, 940, 945, and 955 and the UE 918 measuring 950 the RS from both RIS 914 and 916 in FIG. 9B is substantially the same as the signaling in 812, 815, 820, 825, 830, 835, and 845 and the UE 808 measuring 840 the RS from both RIS 804 and 806 in FIG. 8A.

After the BS 912 receives the feedback information in message 955, the BS 912 sends message 960 to RIS#1 914 that includes configuration information regarding one or more RIS patterns to be used by RIS#1 914 to reflect reference signals. The BS 912 also sends message 965 to RIS#2 916 that includes configuration information regarding one or more RIS patterns to be used by RIS#2 916 to reflect reference signals. In some embodiments, these messages include information that is specific to the respective RIS to set the pattern without the respective RIS having to generate the pattern. In some embodiments, the information provided allows the respective RIS to generate the pattern. This information may be general information that identifies location information for the UE 918 and CSI information to allow the respective RIS to generate the RIS pattern itself. The pattern information can be in part derived based on the measurement report 955 received from the UE 918. While messages 960 and 965 are shown as separate messages, it should be understood that these two messages can be combined into one signaling set.

At least two RIS can be selected per scheduling decision and notification included in DCI messages. In FIG. 9B, the physical layer control channel for configuring the UE 918 is reflected by only the RIS#1 914. However, in other embodiments, the physical layer control channel could be reflected by only the RIS#2 916, or a combination of the two RISs.

Data 972 is a data transmission that includes X₁ and occurs between the BS 912 and the UE 918 in the DL or UL direction via RIS#1 914. Data 974 is a data transmission that includes X₂ and occurs between the BS 912 and the UE 918 in the DL direction via the RIS#2 916. In a conventional delay diversity or space time coded diversity deployment, messages 972 and 974 are transmitted and received at the same time (synchronous within the propagation time difference of the two paths from transmitter and receiver). However, the messages may use different time/frequency resources, especially for incremental redundancy diversity version.

Channel measurement may be performed by either of RIS#1 914 or RIS#2 916 sending a RS for the UE 918 to measure and the UE 918 feeds back measurement information to the respective RISs. In such a case, the CSI is available at the respective RISs and the respective RISs can forward the measured CSI to the BS 912.

The example of FIG. 9B allows for the utilization of more advanced RIS panels which can share some computation burden and reduce BS-RIS command overhead.

While FIG. 9B illustrates setting up multiple RIS-assisted links between a BS and a UE using two RIS, it should be understood that multiple BSs could have multiple RIS-assisted links with one or multiple UEs via one or multiple RIS. Furthermore, the concepts described in this document could be extended to the concept of setting up an RIS-assisted link between multiple UEs using a SL connection.

FIG. 9B show channel measurement in a downlink direction, however the channel measurement could be performed in an uplink direction by the UE being configured by the BS to send a reference signal, such as a SRS, to the BS via the RIS.

While the examples of FIG. 9B is performed where the UE knows the RISs are part of the link, in other embodiments, the UE may not know that RIS is reflecting the signal and the RIS selection notification is QCL based, meaning that the UE is provided information about the direction the signal may be coming from in order to be able to detect the signal without having to know the RIS is being used.

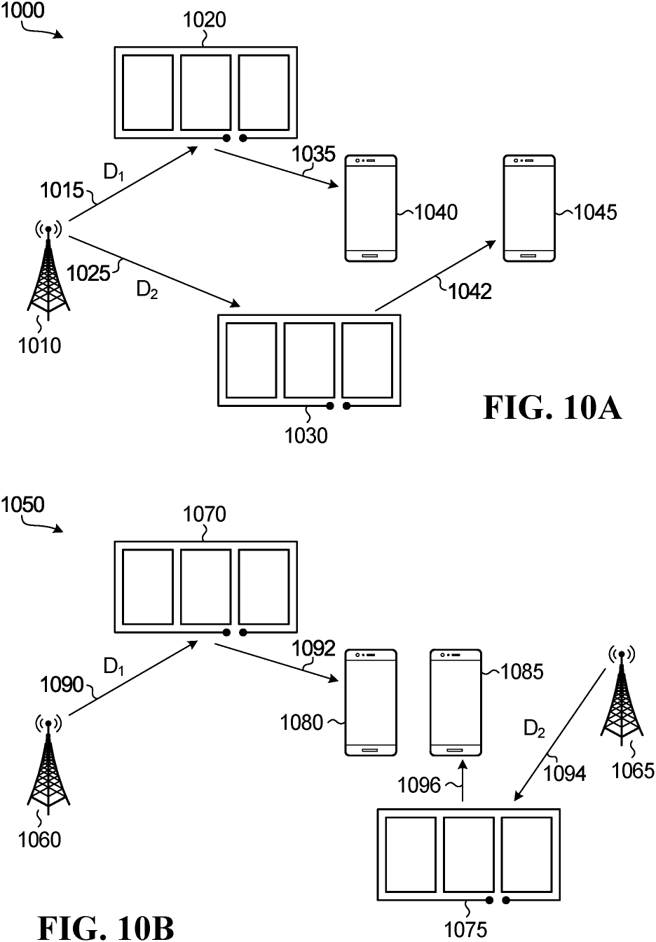

An example of multi-user MIMO system, with multiple RIS and a single BS diversity will be described referring to FIG. 10A. FIG. 10A shows an example of a portion of a communications network 1000 that includes a BS 1010, two RIS (RIS#1 1020 and RIS#2 1030) and two user equipment (UE#1 1040 and UE#2 1045). Each of RIS#1 1020 and RIS#2 1030 are capable of operating as an extension of antennas of the BS 1010 for the purposes of transmission or reception, or both. The RISs are capable of reflecting and focusing a transmission wavefront propagating between the BS 1010 and UE#1 1040 and between the BS 1010 and UE#2 1045. A first radio frequency RF link 1015 is shown between RIS#1 1020 and BS 1010 and is used to transmit a signal component D₁ intended for UE 1040. A second RF link 1025 is shown between RIS#2 1030 and BS 1010 and is used to transmit a signal component D₂ intended for UE 1045. The BS and the RISs can communicate in band, out of band or through a wired connection when communicating information about the RIS pattern that the RIS should use to reflect information, as well as other configuration information or control information, or both, that may need to be communicated between the RIS and BS.

A third RF link 1035 is shown between RIS#1 1020 and UE#1 1040. A fourth RF link 1042 is shown between RIS#2 1030 and UE#2 1045. The RISs and the UE can communicate in band, out of band or using other RAT that is available to the devices when communicating information about the RIS pattern that the RIS should use to reflect information, as well as other configuration information or control information, or both, that may need to be communicated between the RISs and UE.

In FIG. 10A, only DL communication between the BS 1010 and UE#1 1040 and between BS 1010 and UE#2 1045 is illustrated, but it is to be understood that UL between the BS 1010 and UE#1 1040 and between BS 1010 and UE#2 1045 would be similar, but in the opposite direction. Using this type of diversity for sidelink is also considered to be within the scope of the proposed methods.

An example of multi-user MIMO system, with multiple RIS and multiple BS diversity will be described referring to FIG. 10B. FIG. 10B shows an example of a portion of a communications network 1050 that includes two BS (BS#1 1060 and BS#2 1065), two RIS (RIS#1 1070 and RIS#2 1070) and two user equipment (UE#1 1080 and UE#2 1085). Each of RIS#1 1070 and RIS#2 1075 are capable of operating as an extension of antennas of the BS#1 1060 and BS#2 1065, respectively, for the purposes of transmission or reception, or both. The RISs are capable of reflecting and focusing a transmission wavefront propagating between BS#1 1060 and UE#1 1080 and between BS#2 1065 and UE#2 1085. A first radio frequency RF link 1090 is shown between RIS#1 1070 and BS#1 1060 and is used to transmit a signal component D₁. A second RF link 1094 is shown between RIS#2 1075 and BS#2 1065 and is used to transmit a signal component D₂. The BSs and the RISs can communicate in band, out of band or through a wired connection when communicating information about the RIS pattern that the RIS should use to reflect information, as well as other configuration information or control information, or both, that may need to be communicated between the RISs and BSs.

A third RF link 1092 is shown between RIS#1 1070 and UE#1 1080. A fourth RF link 1096 is shown between RIS#2 1075 and UE#2 1085. The RISs and the UEs can communicate in band, out of band or using other RAT that is available to the devices when communicating information about the RIS pattern that the RIS should use to reflect information, as well as other configuration information or control information, or both, that may need to be communicated between the RISs and UEs.

In FIG. 10B, only DL communication between BS#1 1060 and UE#1 1080 and between BS#2 1065 and UE#2 1085 is illustrated, but it is to be understood that UL between BS#1 1060 and UE#1 1080 and between BS#2 1065 and UE#2 1085 would be similar, but in the opposite direction. Using this type of diversity for sidelink is also considered to be within the scope of the proposed methods.

The single or multi-user MIMO system with one or multiple RIS can serve users with highly correlated channel matrices.

The single or multi-user MIMO system can utilize low cross correlation of the RIS-UE and RIS-TRP links to enable an effective communication system with diversity.

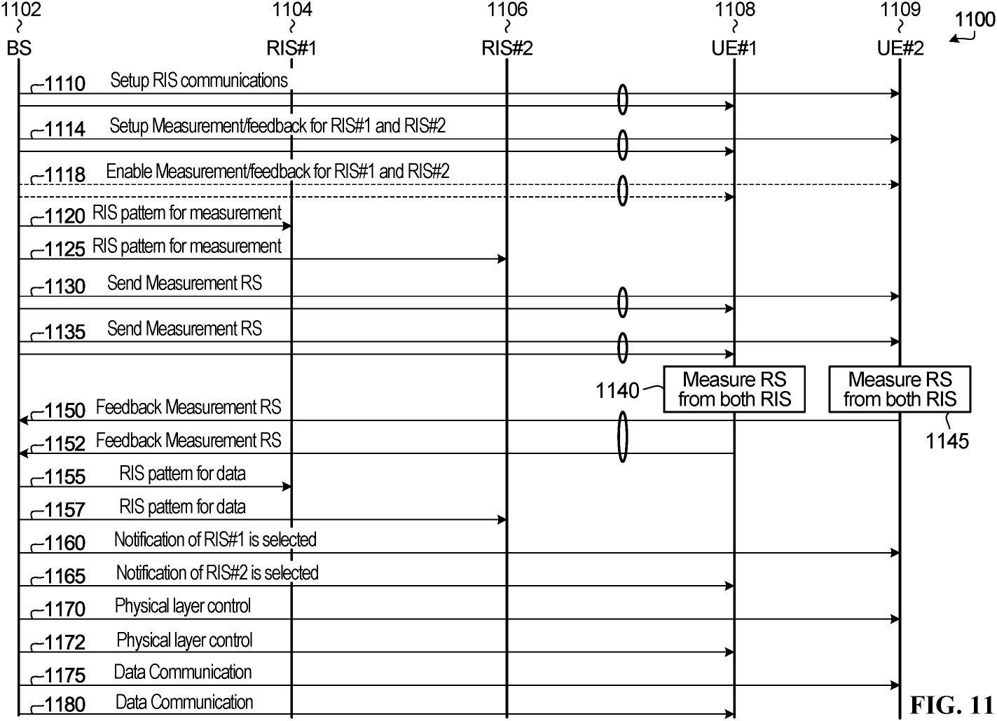

FIG. 11 is a signal flow diagram 1100 of an embodiment of a MU-MIMO communication that shows an example signaling diagram for signaling between a BS 1102, a first RIS (RIS#1) 1104, a second RIS (RIS#2) 1106, a first UE (UE#1) 1108 and a second UE (UE#2) 1109, where RIS#1 1104 and RIS#2 1106 are controlled by the BS 1102 for a time diversity implementation. The signal flow diagram 1100 shows signaling that occurs subsequent to RIS discovery and BS-RIS links being identified and set up.

Signaling lines 1110, 1114, 1118, 1160 and 1165 indicate higher layer configuration information sent from BS 1102 to the UEs 1108 and 1109 that may be sent by direct link, not reflected by RISs. The signaling lines show RRC messaging from the BS 1102 to the UEs 1108 and 1109 to provide the UEs 1108 and 1109 with configuration information. This may be a direct link between the devices, as shown in FIG. 11, or reflected by the RISs 1104 and 1106, which is not shown in FIG. 11. In some embodiments, the RRC messaging uses the same path as data communication configuration for a duration of time that the data communication is performed. In some embodiments, the RRC messaging uses a separate link in the same frequency band. In some embodiments, the RRC messaging uses a separate link in a different frequency band.

Signaling lines 1120, 1125, 1155, and 1157 indicate signaling commands from the BS 1102 to the two RISs 1104 and 1106. These commands can be transmitted over the air or through a wired connection. If they occur over the air then the RISs 1104 and 1106 are assumed to have a transceiver or sensor for receiving from the BS 1102 and reflecting on the configurable elements for transmitting to the BS 1102. In some embodiments, the commands may use a standardized mechanism designed for RIS control. In some embodiments, the commands may use new or existing mechanisms such as backhaul, RRC or Xn.

Signaling lines 1130, 1170 and 1175 show the signals that are reflected by RIS#1 1104 from the BS 1102 to UE#1 1108 or from UE#1 1108 to the BS 1102 or from the BS 1102 to UE#2 1109 or from UE#2 1109 to the BS 1102.

Signaling lines 1135, 1172, and 1180 show the signals that are reflected by RIS#2 1106 from the BS 1102 to UE#2 1109 or from UE#2 1109 to the BS 1102 or from the BS 1102 to UE#1 1108 or from UE#1 1108 to the BS 1102.

Signaling lines 1150 and 1152 shows feedback information that is uplink physical layer control signaling not reflected by the RISs 1104 and 1106. However, in some embodiments, the uplink physical layer control signaling could be reflected by one or both of the RIS 1104 and 1106.

The BS 1102 sends notification messages 1110 to each of UE#1 1108 and UE#2 1109 so that the UEs know that there is going to be a multiuser MIMO diversity implementation being used.

The signaling 1114, 1118, 1120, 1125, 1130, 1135, 1150, and 1152 and UE#1 1108 and UE#2 1109 measuring 1140 and 1145 the RS from both RIS 1104 and 1106 in FIG. 11 is substantially the same as the signaling in 812, 815, 820, 825, 830, 835, and 845 and the UEs 1108 and 1109 measuring 1140 and 1145 the RS from both RIS 804 and 806 in FIG. 8A. However, since there are multiple UEs in FIG. 11, each of the UEs performs the steps.

After the BS 1102 receives the feedback information in the messages 1150 and 1152, the BS 1102 sends message 1155 to RIS#1 1104 that includes configuration information regarding one or more RIS patterns to be used by RIS#1 1104 to reflect reference signals. The BS 1102 also sends message 1157 to RIS#2 1106 that includes configuration information regarding one or more RIS patterns to be used by RIS#2 1106 to reflect reference signals. In some embodiments, these messages include information that is specific to the respective RIS to set the pattern without the respective RIS having to generate the pattern. In some embodiments, the information provided allows the respective RIS to generate the pattern. This information may be general information that identifies location information for the UEs 1108 and 1109 and CSI information to allow the RISs 1104 and 1109 to generate RIS patterns. The pattern information can be in part derived based on the measurement report 1150 received from UE#1 1108 and UE#2 1109. While messages 1150 and 1157 are shown as separate messages, it should be understood that these two messages can be combined into one signaling set.

At least one RIS can be selected for each UE per scheduling decision and notification included in DCI messages. The BS 1102 selects RIS#1 1104 to be used to redirect data to UE#2 1109. In some embodiments, the BS 1102 sends a message (not shown) to at least RIS#1 1104 confirming this, that also notifies the RIS pattern information for RIS#1 1104 to enable RIS#1 1104 to be able to redirect physical layer control information to the UE#2 1109. The BS 1102 further selects the RIS#2 1106 to be used to redirect data to UE#1 1108. In some embodiments, the BS 1102 sends a message (not shown) to at least RIS#2 1106 confirming this, that also notifies the RIS pattern information for RIS#2 1106 to enable RIS#2 1106 to be able to redirect physical layer control information to the UE#1 1108.

The physical layer control channel for UE#2 1109 is reflected by RIS#1 1104 and the physical layer control channel for UE#1 1108 is reflected by the RIS#2 1106. Message 1170 is sent by the BS 1102 to UE#2 1109 that includes physical layer control information for UE#2 1109. Message 1170 is reflected by the RIS#1 1104 using a RIS pattern generated by RIS#1 1104 based in part on message 1155. Message 1172 is sent by the BS 1102 to UE#1 1108 that includes physical layer control information for UE#1 1108. Message 1172 is reflected by RIS#2 1106 using a RIS pattern generated by RIS#2 1106 based in part on message 1157.

Data 1175 is a data transmission that occurs between the BS 1102 and the UE#2 1109 in either UL or DL directions that is reflected off RIS#1 1104. Data 1180 is a data transmission that occurs between the BS 1102 and the UE#1 1108 in either UL or DL directions that is reflected off RIS#2 1106.

Channel measurement may be performed by either of RIS#1 1104 or RIS#2 1106 sending a RS for UE#2 1109 or for UE#1 1108, respectively, to measure and UE#2 1109 and UE#1 1108 feedback measurement information to the respective RISs. In such a case, the CSI is available at the respective RISs and the respective RISs can forward the measured CSI to the BS 1102.

The example of FIG. 11 allows for the utilization of more advanced RIS panels which can share some computation burden and reduce BS-RIS command overhead.

While FIG. 11 illustrates setting up multiple RIS-assisted links between a BS and two UEs each using a RIS panel, it should be understood that multiple BSs could have multiple RIS-assisted links with one or multiple UEs via one or multiple RIS. Furthermore, the concepts described in this document could be extended to the concept of setting up an RIS-assisted link between multiple UEs using a SL connection.

FIG. 11 shows channel measurement in a downlink direction, however the channel measurement could be performed in an uplink direction by the UE being configured by the BS to send a reference signal, such as a SRS, to the BS via the RIS.

While the example of FIG. 11 is performed where the UE knows the RISs are part of the link, in other embodiments, the UE may not know that RIS is reflecting the signal and the RIS selection notification is QCL based, meaning that the UE is provided information about the direction the signal may be coming from in order to be able to detect the signal without having to know the RIS is being used.

The signaling that is performed for each of the UEs in the MU-MIMO system can use dynamic or semi static RIS selection as described in FIGS. 8A and 8B. The present disclosure further provides embodiments of multiple layer or multiple stream communications by using multiple RIS panels. A layer or stream being referred to here is a stream of space division multiplexing and the number of layers is referred to as rank.

Communication between a transmitter and receiver can be limited to a single layer as a result of certain channel related issues. For example, for line-of-sight (LoS) or poor scattering channels, communication is limited to a single layer per polarization direction.

However, by using multiple RIS panels, it is possible to increase the rank of a signal to more than one layer per polarization direction.

When using multiple panels and when the panels are not collocated with one another, data arrives and departs for the different RIS panels in different directions from the perspective of the UE.

In some embodiments, the UE experiences a multi-rank data signal with beams from different directions. The UE can receive a DCI message that incudes multiple QCL assignments for different demodulation reference signal (DMRS) ports so as to be configured to receive the signals from the different RIS panels. In some embodiments, the transmitter sends the same data packet on different beams as a form of diversity. In some embodiments, the transmitter sends different data packets on different beam.

In some embodiments, the UE experiences multiple simultaneous links each link is reflected through one RIS panel in the same frequency band. The UE may also have an additional direct link to the BS not reflected by RIS in that frequency band. The UE can receive multiple DCls, each DCI associated with a different beam.

An example of multi-layer multi-RIS communication can be described referring to FIG. 9A. FIG. 9A shows an example of a portion of a communications network 900 that includes BS 902, RIS#1 904, RIS#2 906 and UE 909. The RISs are capable of reflecting and focusing a transmission wavefront propagating between the BS 902 and the UE 909.

In FIG. 9A, only DL communication between the BS 902 and UE 909 is illustrated, but it is to be understood that UL between the BS 902 and UE 909 would be similar, but in the opposite direction. Using this type of diversity for sidelink is also considered to be within the scope of the proposed methods.

At the BS 909, a zero forcing (ZF) function, or other technique, can be used to separate the signal into the X₁ and X₂ signal components. When the signal is separated into the two signal components, the CSI should be determined for each of the two BS-RIS links.

In some embodiments, the data X₁ sent on the first radio frequency RF link 903 and the data X₂ sent on the second RF link 905 are different segments of the same coded data.

In some embodiments, the data X₁ sent on the first radio frequency RF link 903 and the data X₂ sent on the second RF link 905 belong to different data packets.

In some embodiments, the same physical control signaling is used for scheduling data for the UE.

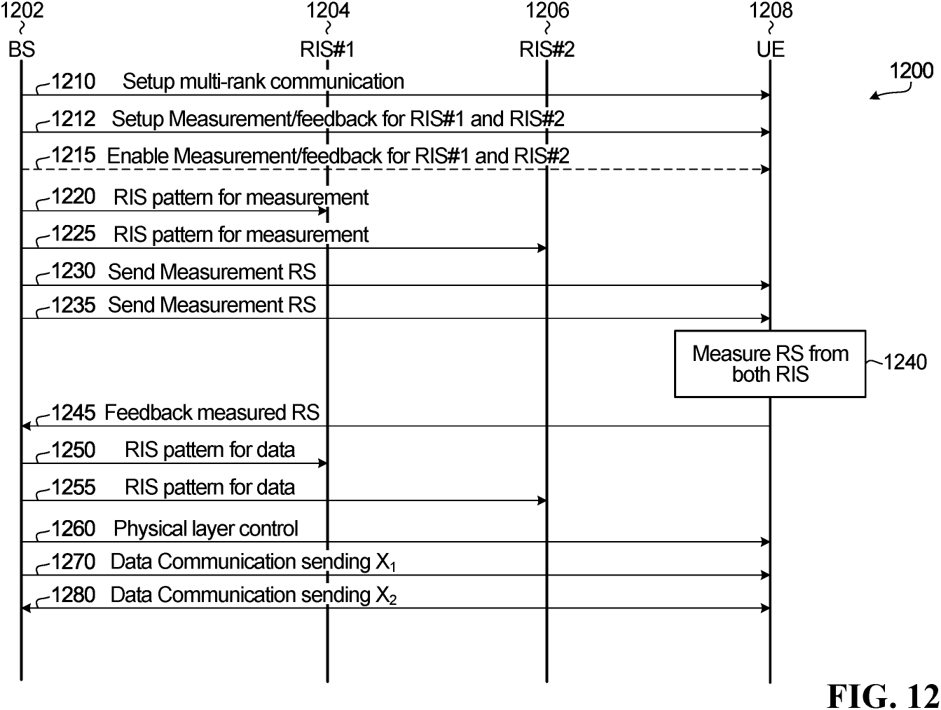

FIG. 12 is a signal flow diagram 1200 of a multi-layer communication of an embodiment that shows an example signaling diagram for signaling between a BS 1202, a first RIS (RIS#1) 1204, a second RIS (RIS#2) 1206, and a UE 1208, where RIS#1 1204 and RIS#2 1206 are controlled by the BS 1202 for a multi-RIS multi-layer implementation. The signal flow diagram 1200 shows signaling that occurs subsequent to RIS discovery and BS-RIS links being identified and set up.

Signaling lines 1210, 1212 and 1215 indicate higher layer configuration information sent from BS 1202 to the UE 1208 that may be sent by direct link, not reflected by the RISs. The signaling lines show RRC messaging from the BS 1202 to the UE 1208 to provide the UE 1208 with configuration information. This may be a direct link between the devices, as shown in FIG. 12, or reflected by the RISs 1204 and 1206, which is not shown in FIG. 12. In some embodiments, the RRC messaging uses the same path as data communication configuration for a duration of time that the data communication is performed. In some embodiments, the RRC messaging uses a separate link in the same frequency band. In some embodiments, the RRC messaging uses a separate link in a different frequency band.

Signaling lines 1220, 1225, 1250, 1255 indicate signaling commands from the BS 1202 to the two RISs 1204 and 1206. These commands can be transmitted over the air or through a wired connection. If they occur over the air then the RISs 1204 and 1206 are assumed to have a transceiver or sensor for receiving from the BS 1202 and reflecting on the configurable elements for transmitting to the BS 1202. In some embodiments, the commands may use a standardized mechanism designed for RIS control. In some embodiments, the commands may use new or existing mechanisms such as backhaul, RRC or Xn.

Signaling lines 1230, 1260, and 1270 show the signals that are reflected by RIS#1 1204 from the BS 1202 to the UE 1208 or from the UE 1208 to the BS 1202.

Signaling lines 1235 and 1275 show the signals that are reflected by RIS#2 from the BS 1202 to the UE 1208 or from the UE 1208 to the BS 1202.

Signaling line 1245 shows feedback information that is uplink physical layer control signaling not reflected by the RISs 1204 and 1206. However, in some embodiments, the uplink physical layer control signaling could be reflected by one or both of the RIS 1204 and 1206.

The BS 1202 sends a notification message 1210 to the UE 1208 so that the UE knows that there is going to be a multi-RIS multi-layer implementation being used.

The signaling 1212, 1215, 1220, 1225, 1230, 1235, and 1245, and the UE 1208 measuring 1240 the RS from both RIS 1204 and 1206 in FIG. 12 is substantially the same as the signaling in 812, 815, 820, 825, 830, 835, and 845 and the UE 808 measuring 840 the RS from both RIS 804 and 806 in FIG. 8A.

After the BS 1202 receives the feedback information in the message 1245, the BS 1202 sends message 1250 to RIS#1 1204 that includes configuration information regarding one or more RIS patterns to be used by RIS#1 1204 to reflect reference signals. The BS 1202 also sends message 1255 to RIS#2 1206 that includes configuration information regarding one or more RIS patterns to be used by the RIS#2 1206 to reflect reference signals. In some embodiments, these messages include information that is specific to the respective RIS to set the pattern without the respective RIS having to generate the pattern. In some embodiments, the information provided allows the respective RIS to generate the pattern. This information may be general information that identifies location information for the respective RIS and CSI information to allow the respective RIS to generate the RIS pattern itself. The pattern information can be in part derived based on the measurement report 1245 received from the UE 1208. While messages 1250 and 1255 are shown as separate messages, it should be understood that these two messages can be combined into one signaling set.

The physical layer control channel for the UE 1208 is reflected by RIS#1 1204. Message 1260 is sent by the BS 1202 to the UE 1208 that includes physical layer control information for the UE 1208. Message 1260 is reflected by RIS#1 1204 using a RIS pattern generated by RIS#1 1204 based in part on message 1250. In some embodiments where data streams over different UE-RIS links use different DCI messages, there is an additional control message (not shown in FIG. 12) to enable the data message 1275 that is reflected by RIS#2 1206. This control signal may be reflected by RIS#1 1204 or RIS#2 1206 or sent through a direct link.

Data 1270 is a data transmission that includes X₁ and that occurs between the BS 1202 and the UE 1208 in either UL or DL directions that is reflected off RIS#1 1204. Data 1275 is a data transmission that includes X₂ and that occurs between the BS 1202 and the UE 1208 in either UL or DL directions that is reflected off RIS#2 1206. For multi-rank communication, messages 1270 and 1275 are simultaneous. However, for data with independent DCI, these two messages may or may not use the same time/frequency resources.

Channel measurement may be performed by either of RIS#1 1204 or RIS#2 1206 sending a RS for the UE 1108 to measure and the UE 1108 then feeds back measurement information to the respective RISs. In such a case, the CSI is available at the respective RISs and the respective RISs can forward the measured CSI to the BS 1202.

The example of FIG. 12 allows for the utilization of more advanced RIS panels which can share some computation burden and reduce BS-RIS command overhead.

While FIG. 12 illustrates setting up multiple RIS-assisted links between a BS and a UE using two RIS panels, it should be understood that multiple BSs could have multiple RIS-assisted links with one or multiple UEs via two or more RIS. Furthermore, the concepts described in this document could be extended to the concept of setting up an RIS-assisted link between multiple UEs using a SL connection.

FIG. 12 show channel measurement in a downlink direction, however the channel measurement could be performed in an uplink direction by the UE being configured by the BS to send a reference signal, such as a SRS, to the BS via the RIS.

While the example of FIG. 12 is performed where the UE knows the RISs are part of the link, in other embodiments, the UE may not know that the RIS is reflecting the signal and the RIS selection notification is QCL based, meaning that the UE is provided information about the direction the signal may be coming from in order to be able to detect the signal without having to know the RIS is being used.

The present disclosure provides some embodiments of coherent multi-RIS communication. An example of a coherent multi-RIS communication can be described referring to FIG. 9A. In coherent multi-RIS communication the same data stream is sent and reflected by different RIS panels and the signal constructive add.

In FIG. 9A, only DL communication between the BS 902 and UE 909 is illustrated, but it is to be understood that UL between the BS 902 and UE 909 would be similar, but in the opposite direction. Using coherent multi-RIS communication for sidelink is also considered to be within the scope of the proposed methods.

The RIS patterns are optimized for coherent reception at the UE. In some embodiments, coherent multi-RIS communication is used for low frequency (LF) (for example, 6 GHz and below) communications where beamforming transmission and reception is not used. Coherent multi-RIS communication may be particularly applicable to very low speed scenarios.

It should be noted that coherent multi-RIS communication needs accurate CSI information to ensure the signals are coherently received.

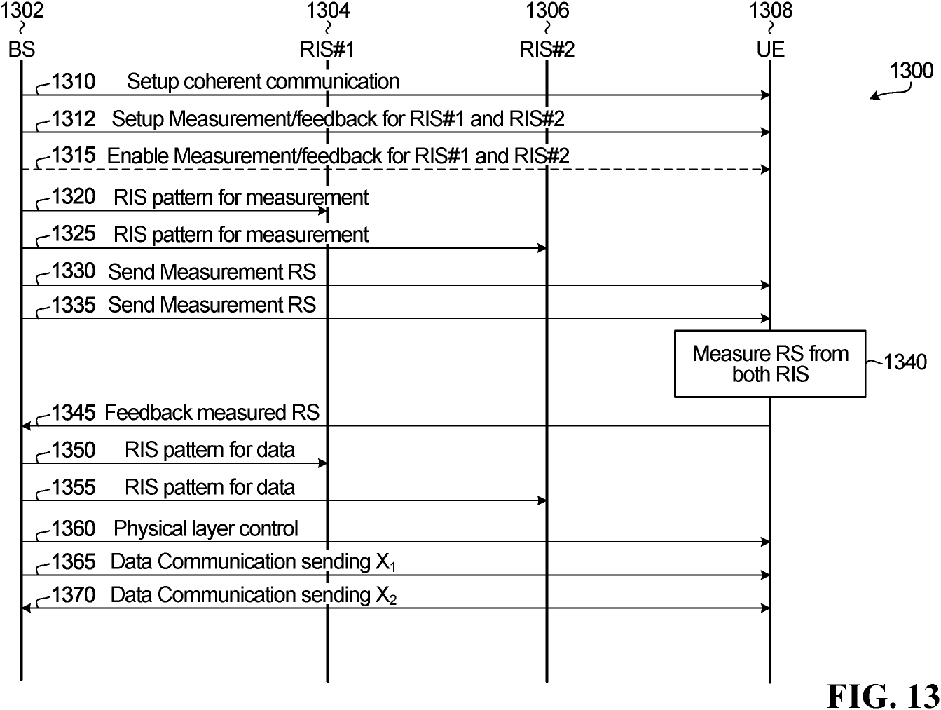

FIG. 13 is a signal flow diagram 1300 of a coherent multi-RIS communication in an embodiment that shows an example signaling diagram for signaling between a BS 1302, a first RIS (RIS#1) 1304, a second RIS (RIS#2) 1306, and a UE 1308, where RIS#1 1304 and RIS#2 1306 are controlled by the BS 1302 for a multi-RIS coherent communication implementation. The signal flow diagram 1300 shows signaling that occurs subsequent to RIS discovery and BS-RIS links being identified and set up.

Signaling lines 1310, 1312, and 1315 indicate higher layer configuration information sent from BS 1302 to the UE 1308 that may be sent be direct link, not reflected by RISs. The signaling lines show RRC messaging from the BS 1302 to the UE 1308 to provide the UE 1308 with configuration information. This may be a direct link between the devices, as shown in FIG. 13, or reflected by the RISs 1304 and 1306, which is not shown in FIG. 13. In some embodiments, the RRC messaging uses the same path as data communication configuration for a duration of time that the data communication is performed. In some embodiments, the RRC messaging uses a separate link in the same frequency band. In some embodiments, the RRC messaging uses a separate link in a different frequency band.

Signaling lines 1320, 1325, 1350 and 1355 indicate signaling commands from the BS 1303 to the two RISs 1304 and 1306. These commands can be transmitted over the air or through a wired connection. If they occur over the air then the RISs 1304 and 1306 are assumed to have a transceiver or sensor for receiving from the BS 1302 and reflecting on the configurable elements for transmitting to the BS 1302. In some embodiments, the commands may use a standardized mechanism designed for RIS control. In some embodiments, the commands may use new or existing mechanisms such as backhaul, RRC or Xn.

Signaling lines 1330, 1360 and 1365 show the signals that are reflected by RIS#1 1304 from the BS 1302 to the UE 1308 or from the UE 1308 to the BS 1302.

Signaling lines 1335 and 1370 show the signals that are reflected by RIS#2 1306 from the BS 1302 to the UE 1308 or from the UE 1308 to the BS 1302.

Signaling line 1345 shows feedback information that is uplink physical layer control signaling not reflected by the RISs 1304 and 1306. However, in some embodiments, the uplink physical layer control signaling could be reflected by one or both of the RIS 1304 and 1306.

The BS 1302 sends a notification message 1310 to the UE 1308 so that the UE 1308 knows that there is going to be a multi-RIS coherent implementation being used.

The signaling 1312, 1315, 1320, 1325, 1330, 1335, and 1345, and the UE 1308 measuring 1340 the RS from both RIS 1304 and 1306 in FIG. 13 is substantially the same as the signaling in 812, 815, 820, 825, 830, 835, and 845 and the UE 808 measuring 840 the RS from both RIS 804 and 806 in FIG. 8A.

After the BS 1302 receives the feedback information in the message 1345, the BS 1302 sends message 1350 to RIS#1 1304 that includes configuration information regarding one or more RIS patterns to be used by RIS#1 1304 to reflect reference signals. The BS 1302 also sends message 1355 to RIS#2 1306 that includes configuration information regarding one or more RIS patterns to be used by RIS#2 1306 to reflect reference signals. In some embodiments, these messages include information that is specific to the respective RIS to set the pattern without the respective RIS having to generate the pattern. In some embodiments, the information provided allows the respective RIS to generate the pattern. This information may be general information that identifies location information for the respective RIS and CSI information to allow the respective RIS to generate the RIS pattern. The pattern information can be in part derived based on the measurement report 1345 received from the UE 1308. While messages 1350 and 1355 are shown as separate messages, it should be understood that these two messages can be combined into one signaling set.

The physical layer control channel for the UE 1308 is reflected by RIS#1 1304. Message 1360 is sent by the BS 1302 to the UE 1308 that includes physical layer control information for the UE 1308. Message 1360 is reflected by RIS#1 1304 using a RIS pattern generated by RIS#1 1304 based in part on message 1350. While the physical layer control channel message is sent by UE 1302 and reflected by RIS#1 1304, it should be understood that the message could have been reflected by RIS#2 1306, if arranged in that manner.

Data 1365 is a data transmission that includes X₁, which occurs between the BS 1302 and the UE 1308 in either UL or DL directions that is reflected off RIS#1 1304. Data 1370 is a data transmission that includes also X₁, which occurs between the BS 1302 and the UE 1308 in either UL or DL directions that is reflected off RIS#2 1306. Messages 1365 and 1370 are sent in a way that arrive at the receiver constructively.

Channel measurement may be performed by either of RIS#1 1304 or RIS#2 1306 sending a RS for the UE 1308 to measure and the UE 1308 feeds back measurement information to the respective RISs. In such a case, the CSI is available at the respective RISs and the respective RISs can forward the measured CSI to the BS 1302.

The example of FIG. 13 allows for the utilization of more advanced RIS panels which can share some computation burden and reduce BS-RIS command overhead.

While FIG. 13 illustrates setting up multiple RIS-assisted links between a BS and a UE using two RIS panels, it should be understood that multiple BSs could have multiple RIS-assisted links with one or multiple UEs via two or more RIS. Furthermore, the concepts described in this document could be extended to the concept of setting up an RIS-assisted link between multiple UEs using a SL connection.

FIG. 13 show channel measurement in a downlink direction, however the channel measurement could be performed in an uplink direction by the UE being configured by the BS to send a reference signal, such as a SRS, to the BS via the RIS.

While the example of FIG. 13 is performed where the UE knows the RISs are part of the link, in other embodiments, the UE may not know that the RIS is reflecting the signal and the RIS selection notification is QCL based, meaning that the UE is provided information about the direction the signal may be coming from in order to be able to detect the signal without having to know the RIS is being used.

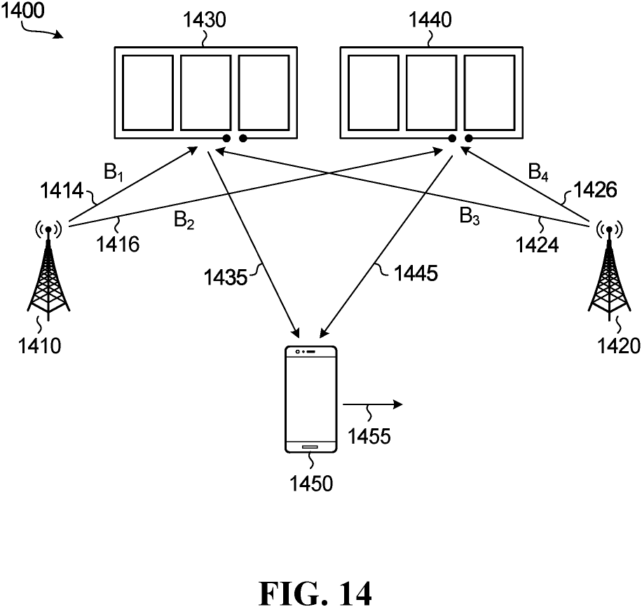

The present disclosure provides an embodiment of RIS assisted user centric and no cell (UCNC) as described referring to FIG. 14. UCNC is a radio access framework evolved from the traditional cell-centric access protocol to a user-centric protocol with hyper-cell abstraction. UCNC is expected to help reduce over-the-air protocol signaling overhead and access protocol latency, as well as increase the number of air-interface connection links.

FIG. 14 shows an example of a portion of a communications network 1400 that includes two BS (BS#1 1410 and BS#2 1420) that are each serving a localized area, two RIS (RIS#1 1430 and RIS#2 1440) and one user equipment (UE 1450). The UE 1450 is moving in a direction from BS#1 1410 to BS#2 1420, as indicated by the arrow 1455, so a handover from BS#1 1410 to BS#2 1420 will eventually occur. However, for a period of time the two BS share serving UE 1450 by the RISs reflecting beams from each of the BS 1410 and 1430. Each of RIS#1 1430 and RIS#2 1440 are capable of operating as an extension of antennas of BS#1 1410 and BS#2 1420 for the purposes of transmission or reception, or both. The RISs are capable of reflecting and focusing a transmission wavefront propagating between the BS#1 1410 and the UE 1450 and BS#2 1420 and UE 1450.

Initially UE 1450 is served by BS#1 1410 via a first radio frequency RF link 1414 between BS#1 1410 and RIS#1 1430 to transmit a first beam B₁ that is reflected on second RF link 1435 between RIS#1 1430 and the UE 1450. BS#1 may also create a third RF link 1416 to RIS#2 1440 to transmit a second beam B₂ that is reflected on a fourth RF link 1445 between RIS#2 1440 and the UE 1450.

As the UE 1450 moves in the direction toward BS#2 1420, the UE 1450 is initially served by BS#1 with beam B₁ via RIS#1 1430 and then also by BS#1 with beam B₂ via RIS#2 1440.

While RIS#1 1430 continues to reflect beam B₁ from BS#1 1410, at a certain point in time, which may be determined by the channel quality of link 1426 being better than 1416, RIS#2 1440 switches the RIS pattern on RIS#2 1440 to reflect beam B₄ from BS#2 1420 to the UE 1450. So instead of RIS#2 1440 reflecting B₂ from BS#1 1410 to UE 1450, RIS#2 1440 reflects beam B₄ from BS#2 1420 on a fifth RF link 1426 to the UE 1450 on the fourth RF link 1445. At a further point in time, which that may be determined by the channel quality of link 1424 being better than 1414, RIS#1 1430 changes the RIS pattern on RIS#1 to reflect beam B₃ from BS#2 to the UE 1450. So instead of RIS#1 1430 reflecting B₁ from BS#1 1410 to UE 1450, RIS#1 1430 reflects beam B₃ from BS#2 1420 on a sixth RF link 1424 to the UE 1450 on the third RF link 1435.

While the example described above includes two RIS, the principle of using the RIS to form an RIS assisted link is applicable to using a single RIS for RIS assisted UCNC, or more than two RIS for RIS assisted UCNC.

It should also be understood that the RIS can be activated and deactivated on a semi-static basis and a dynamic basis as described above, with reference to FIGS. 8A and 8B respectively.

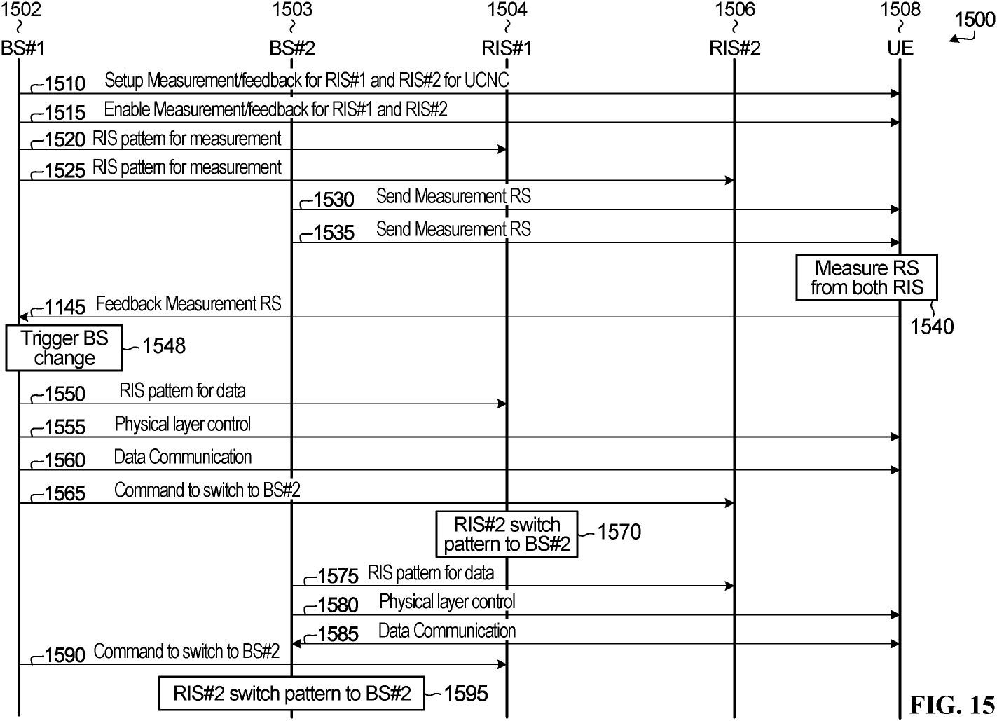

FIG. 15 is a signal flow diagram 1500 of a RIS UCNC in an embodiment that shows an example signaling diagram for signaling between a first BS (BS#1) 1502, a second BS (BS#2) 1503, a first RIS (RIS#1) 1504, a second RIS (RIS#2) 1506, and a UE 1508, where RIS#1 1504 and RIS#2 1506 are controlled by BS#1 1502 and BS#2 1503 for a RIS assisted UCNC implementation. The signal flow diagram 1500 shows signaling that occurs subsequent to RIS discovery and BS-RIS links being identified and set up.

Signaling lines 1510 and 1515 indicate higher layer configuration information sent from BS 1502 to the UE 1508 that may be sent be direct link, not reflected by RISs. The dark green lines show RRC messaging from the BS 1502 to the UE 1508 to provide the UE 1508 with configuration information. This may be a direct link between the devices, as shown in FIG. 15, or reflected by the RISs 1504 and 1506, which is not shown in FIG. 15. In some embodiments, the RRC messaging uses the same path as data communication configuration for a duration of time that the data communication is performed. In some embodiments, the RRC messaging uses a separate link in the same frequency band. In some embodiments, the RRC messaging uses a separate link in a different frequency band.

Signaling lines 1520, 1525, 1550, 1565, 1575, 1590 indicate signaling commands from the BS 1502 to the two RISs 1504 and 1506. These commands can be transmitted over the air or through a wired connection. If they occur over the air then the RISs 1504 and 1506 are assumed to have a transceiver or sensor for receiving from the BS 1502 and reflecting on the configurable elements for transmitting to the BS 1502. In some embodiments, the commands may use a standardized mechanism designed for RIS control. In some embodiments, the commands may use new or existing mechanisms such as backhaul, RRC or Xn.

Signaling lines 1530, 1555, 1560, show the signals that are reflected by RIS#1 1504 from BS#1 1502 to the UE 1508, or from BS#2 1503 to the UE 1508, or from the UE 1508 to BS#1 1502, or from the UE 1508 to BS#2 1503.

Signaling lines 1535, 1580, and 1585 show the signals that are reflected by RIS#2 1506 from BS# 1502 to the UE 1508, or from BS#2 1503 to the UE 1508, or from the UE 1508 to BS#1 1502, or from the UE 1508 to BS#2 1503.

Signaling line 1545 shows feedback information that is uplink physical layer control signaling not reflected by the RISs 1504 and 1506. However, in some embodiments, the uplink physical layer control signaling could be reflected by one or both of the RIS 1504 and 1506.

BS#1 1502 sends a notification message 1510 to UE 1508 to set up channel measurement and feedback for links including RIS#1 1504 and RIS#2 1506 for UCNC.

The signaling 1515, 1520, 1525, 1530, 1535, 1145, and the UE 1508 measuring 1540 the RS from both RIS 1504 and 1506 in FIG. 15 is substantially the same as the signaling in 815, 820, 825, 830, 835, 845, and the UE 808 measuring 840 the RS from both RIS 804 and 806 in FIG. 8A. However, BS#2 1503 is transmitting the RS in signaling steps 1530 and 1535 in FIG. 15, as the channel needs to be measured with respect to BS#2 1503 as this is a possible handover target BS that needs to be known, and because the channel measurements have been previously performed for BS#1 1502. The feedback message sent by the UE 1508 is sent to BS#1 1502 as it is BS#1 1502 that needs to make the decision to handover to BS#2 1503 when it is deemed appropriate, i.e. when the channel link is better from BS#2 1503 than from BS#1 1502.

After BS#1 1502 receives the feedback information in the message 1545 and BS#1 1502 determines that BS#1 1502 is going to handover using UCNC, BS#1 1502 triggers the start of the handover to BS#2 1503. BS#1 1502 sends a message 1550 to RIS#1 1504 that includes configuration information regarding one or more RIS patterns to be used by RIS#1 1504 to reflect reference signals.

BS#1 1502 has also sent messages to RIS#1 1504 and RIS#2 1506 that includes configuration information regarding one or more RIS patterns to be used by the RISs to reflect reference signals. In some embodiments, these messages include information that is specific to the respective RIS to set the pattern without the respective RIS having to generate the pattern. In some embodiments, the information provided allows the respective RIS to generate the pattern. This information may be general information that identifies location information for the UE 1508 and CSI information to allow the RISs 1504 and 1506 to generate the RIS pattern itself. The pattern information can be in part derived based on the measurement report 1545 received from the UE 1508.

The physical layer control channel for the UE 1508 from BS#1 1502 is reflected by RIS#1 1504. Message 1555 is sent by the BS 1502 to the UE 1508 that includes physical layer control information for the UE 1508. Message 1555 is reflected by the RIS#1 1504 using a RIS pattern generated by the RIS#1 1504 based in part on message 1550.

Data 1560 is a data transmission that occurs between BS#1 1502 in either UL or DL directions that is reflected off RIS#1 1504.

Based on the decision to trigger 1548 a handover from BS#1 1502 to BS#2 1503, BS#1 1502 sends a message 1565 to RIS#2 1506 that notifies the RIS#2 1506 to switch the RIS pattern on RIS#2 1506 to communicate with BS#2 1503. At 1570, RIS#2 1506 switches the RIS pattern to communicate with BS#2 1503.

The physical layer control channel for the UE 1508 from BS#2 1503 is reflected by RIS#2 1506. Message 1580 is sent by BS#2 1503 to the UE 1508 that includes physical layer control information for the UE 1508. Message 1580 is reflected by the RIS#2 1506 using a RIS pattern generated by the RIS#2 1504 based in part on message 1575.

Data 1585 is a data transmission that occurs between BS#2 1503 in either UL or DL directions that is reflected off RIS#2 1506.

To complete the handover from BS#1 1502 to BS#2 1503, BS#1 1502 sends a message 1590 to notify RIS#1 1504 to switch the RIS pattern on RIS#1 1504 to communicate with BS#2 1503. At 1595, RIS#1 1504 switches the RIS pattern to communicate with BS#2 1503.

Channel measurement may be performed by either of RIS#1 1504 or RIS#2 1506 sending a RS for the UE 1508 to measure. In such a case, the CSI is available at the respective RISs and the respective RISs can forward the measured CSI to either BS#1 1502 or BS#2 1503, when appropriate.

The example of FIG. 15 allows for the utilization of more advanced RIS panels which can share some computation burden and reduce BS-RIS command overhead.

While FIG. 15 illustrates setting up multiple RIS-assisted links between a first BS and a UE each using a RIS panel and then handing off to a second BS, it should be understood that the BSs could have multiple RIS-assisted links with one or multiple UEs via one or multiple RIS. Furthermore, the concepts described in this document could be extended to the concept of setting up an RIS-assisted link between multiple UEs using a SL connection.

FIG. 15 show channel measurement in a downlink direction, however the channel measurement could be performed in an uplink direction by the UE being configured by the BS to send a reference signal, such as a SRS, to the BS via the RIS.

While the examples of FIG. 15 is performed where the UE knows the RISs are part of the link, in other embodiments, the UE may not know that RIS is reflecting the signal and the RIS selection notification is QCL based, meaning that the UE is provided information about the direction the signal may be coming from in order to be able to detect the signal without having to know the RIS is being used.

While FIG. 15 describes a method of RIS assisted UCNC for which there are multiple RIS, it is also possible to have a single RIS instead of multiple RIS.

In some embodiments, the single RIS is responsible for changing the RIS pattern from a first BS to a second BS, when notified to do so, but the UE does not have to change a receiving beam at the UE because the UE is always receiving from the single RIS.

The signaling to the UE and/or the RIS (if RIS or is in a link between the BS and UE) may include information pertaining to the direction of the beam that is transmitted, received or reflected for any of the links. The beam direction can be for any signal or physical channel such as data, reference or synchronization signals or control information. The beam direction for each signal may be independently signaled or combined in one signaling message. Multiple signals and channels may utilize the same beam or different beams.

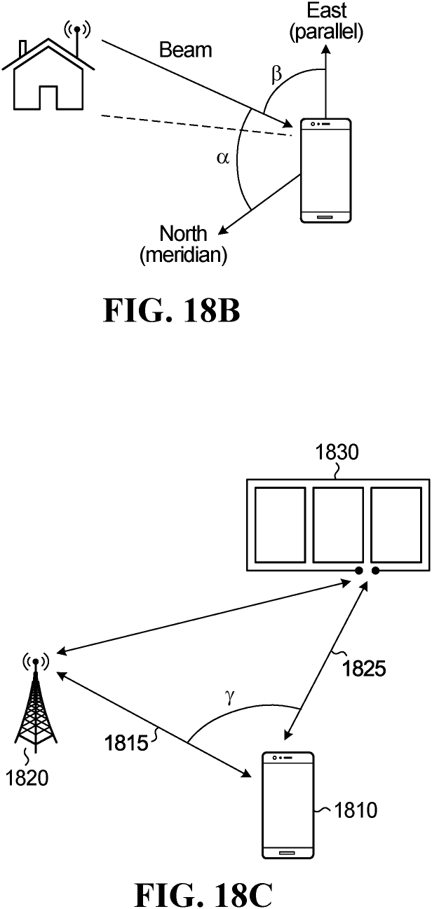

In some embodiments, the signaling to the UE includes information pertaining to the beam direction for a signal (such as SSB, CSI-RS, SRS) or a physical channel (such as PDCCH, PDSCH, PUSCH, PUCCH, PRACH) in any of the directions (for example UL, DL, SL) from the UE perspective. In some embodiments, the beam direction may be expressed in an absolute direction with respect to earth coordinates (azimuth with respect to true or magnetic north, and elevation or inclination with respect to zenith) in a spherical presentation. An example of absolute direction with respect to earth coordinates is shown in FIG. 18A. The dashed line in FIG. 18A is a projection of the beam on the horizontal plane. In some embodiments, the direction may be expressed as inclination with respect to two coordinates such as the meridian and parallel coordinates. In some embodiments, such as for rural terrestrial deployment, the angle with respect to north is signaled and the elevation or inclination angle with respect to zenith is not signaled. In some embodiments, the angular direction is expressed with respect to an orientation of the UE or a direction in which the UE is moving. An example of absolute direction with respect to an orientation of the UE or a direction in which the UE is moving (in this case parallel to an East direction) is shown in FIG. 18B. The dashed line in FIG. 18A is a projection of the beam on the horizontal plane.

In some embodiments, the beam direction at a RIS, with respect to a transmitter and/or a receiver, can be expressed in terms of the absolute angular direction, where the transmitter and the receiver can be any of UEs, terrestrial or non-terrestrial BS, and relays. The direction signaling may be expressed in the form of azimuth/elevation coordinates (or equivalents) or in the form of inclination with respect to two coordinates or with reference to the RIS orientation.

In some embodiments, the beam direction of a signal or channel (here referred to as target direction) may be signaled relative to a reference beam (here referred to as reference direction). The reference beam may be optimized using beam refinement. Therefore, any refinement to the reference beam is also applied to the target beam direction. The reference beam may be the direction of any other signal or channel or with respect to other RF or non-RF beams used for other purposes such as sensing. Examples of a sensing direction is a direction of an infra-red link or a direction of emission or reception of a sensing signal.

FIG. 18C illustrates an example of when a UE 1810 knows the direction of a DL control channel beam 1815 from a BS 1820 and can then express a DL and UL data channel beam 1825 as being α degrees to the right of the DL control channel beam 1815 coming from RIS 1830 after reflection.

The reference direction may utilize a non-UE specific broadcast signal or a multicast signal, or a UE specific (or UE group specific) signal such as CSI-RS, or SRS.

Expressing the beam direction relative to a reference beam direction may use any of the following modes of signaling:
a target beam direction that is the same as a reference direction;
explicit signaling of an angular difference between the target direction projected on the azimuth and/or elevation coordinates, or any other coordinates;
explicit signaling of an absolute angular difference between the target direction and one or more reference directions; or
implicit signaling of a weighted combination of two or more reference directions.

When there is more than one link between a transmitter and a receiver, such as when the UE experiences multiple links through a direct link and/or via different RIS panels, the beam indication for data/control may use differential indications between the beams of different channels.

Each data channel or control channel or RS channel from any of the links may be associated with a reference direction where the reference direction can be any of the above mentioned mechanisms, or with reference to another beam direction for data or control or RS of the same, or any other link.

For example, when the UE is served by two RIS panels (RIS#1 and RIS#2), DL control signaling may only be reflected by RIS#1 and the beam direction, from the perspective of the UE, for DL data received via the RIS#1 uses the same beam direction as that of DL control channel. When it is known that the azimuth angle between the RIS#1 UE-RIS link and the RIS#2 UE-RIS link is 50 degrees, the data known to be coming from RIS#2 may use a beam direction that is 50 to the right in the azimuth direction from the DL control channel. Also, if RIS#2 is used for UL data reflection, the signaling will indicate that for UL data, the beam direction may use the same as the DL data for RIS#2.

A similar approach can be used for the RIS reflecting beams between DL/UL control channels or DL/UL data channels or DL/UL RS channels of a same UE or between links to different UEs, or a BS-RIS link and a RIS-UE link.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising
receiving first configuration information, the first configuration information comprising identification of a plurality of beams for transmitting or receiving signals, each beam having an associated direction; and
receiving second configuration information, the second configuration information comprising a message to enable a selected subset of beams of the plurality of beams from the plurality of beams for transmitting or receiving signals.

2. The method of claim 1, wherein a signal transmitted or received on at least one beam of the selected subset of beams is transmitted or received via at least one reflective intelligent surface (RIS).

3. The method of claim 1, wherein each one of a plurality of signals are transmitted or received on a corresponding beam of the selected subset of beams via a respective RIS.

4. The method of claim 1, wherein a signal transmitted or received on at least one beam of the selected subset of beams is transmitted to, or received from, a base station (BS) over a direct link with the BS.

5. The method of claim 1, wherein the second configuration information includes identification of beam direction and at least one of time or frequency resources of a signal on at least one beam of the selected subset of beams.

6. The method of claim 5, further comprising: receiving data and control information within the at least one of time or frequency resources of the at least one beam of the selected subset of beams.

7. A method comprising
transmitting first configuration information to a user equipment (UE), the first configuration information comprising identification of a plurality of beams for transmitting or receiving signals at the UE, each beam having an associated direction; and
transmitting second configuration information, the second configuration information comprising a message to enable a selected subset of beams of the plurality of beams for transmitting or receiving signals at the UE.

8. The method of claim 7, further comprising:
transmitting a signal to be received at the UE on at least one beam of the selected subset of beams at the UE; or
receiving a signal transmitted by the UE on at least one beam of the selected subset of beams at the UE.

9. The method of claim 8, wherein:
transmitting a signal to be received at the UE on at least one beam of the selected subset of beams at the UE comprises: transmitting at least two signals to be received at the UE on respective beams of the selected subset of beams at the UE, each signal reflected by reflective intelligent surface (RIS); or
receiving a signal transmitted by the UE on at least one beam of the selected subset of beams at the UE comprises: receiving at least two signals from the UE on respective beams of the selected subset of beams, each signal reflected by reflective intelligent surface (RIS).

10. The method of claim 7, further comprising:
transmitting a signal to be received at the UE on at least one beam of the selected subset of beams at the UE over a direct link with the UE; or
receiving a signal transmitted by the UE on at least one beam of the selected subset of beams at the UE over a direct link with the UE.

11. The method of claim 7, wherein the second configuration information includes identification of a beam direction and time-frequency resources of a signal on at least one beam of the selected subset of beams.

12. A method comprising:
a reflective intelligent surface (RIS) reflecting a signal in the direction of a user equipment (UE) on at least one of a selected subset of beams of a plurality of beams known to the UE; or
a RIS reflecting a signal in the direction of a base station (BS) that is received from a UE that transmitted the signal on at least one of a selected subset of beams of a plurality of beams known to the UE.

13. An apparatus comprising:
a non-transitory computer readable storage medium storing programming including instructions; and
a processor configured to execute the instructions to cause the apparatus to:
receive first configuration information, the first configuration information comprising identification of a plurality of beams for transmitting or receiving signals, each beam having an associated direction; and
receive second configuration information, the second configuration information comprising a message to enable a selected subset of beams of the plurality of beams from the plurality of beams for transmitting or receiving signals.

14. The apparatus of claim 13, wherein a signal transmitted or received on at least one beam of the selected subset of beams is transmitted or received via at least one reflective intelligent surface (RIS).

15. The apparatus of claim 13, wherein each one of a plurality of signals are transmitted or received on a corresponding beam of the selected subset of beams via a respective RIS.

16. The apparatus of claim 13, wherein a signal transmitted or received on at least one beam of the selected subset of beams is transmitted to, or received from, a base station (BS) over a direct link with the BS.

17. The apparatus of claim 13, wherein the second configuration information includes identification of beam direction and at least one of time or frequency resources of a signal on at least one beam of the selected subset of beams.

18. An apparatus comprising:
a non-transitory computer readable storage medium storing programming including instructions; and
a processor configured to execute the instructions to cause the apparatus to:
transmit first configuration information to a user equipment (UE), the first configuration information comprising identification of a plurality of beams for transmitting or receiving signals at the UE, each beam having an associated direction; and
transmit second configuration information, the second configuration information comprising a message to enable a selected subset of beams of the plurality of beams for transmitting or receiving signals at the UE.

19. The apparatus of claim 18, the processor further configured to execute the instructions to cause the apparatus to:
transmit a signal to be received at the UE on at least one beam of the selected subset of beams at the UE; or
receive a signal transmitted by the UE on at least one beam of the selected subset of beams at the UE.

20. The apparatus of claim 19, wherein the transmit a signal to be received at the UE on at least one beam of the selected subset of beams at the UE comprises: transmit at least two signals to be received at the UE on respective beams of the selected subset of beams at the UE, each signal reflected by reflective intelligent surface (RIS); or
the receive a signal transmitted by the UE on at least one beam of the selected subset of beams at the UE comprises: receive at least two signals from the UE on respective beams of the selected subset of beams, each signal reflected by reflective intelligent surface (RIS).
